(19) United States
(12) Patent Application Publication
(10) Pub. No.: US 2021/0094850 A1
(43) Pub. Date: Apr. 1, 2021

(54) Bubble-Generating Electrochemical Reactors and Systems for Manufacturing a Sanitizing, a Disinfecting, and/or a Cleaning Solution

(71) Applicant: ionogen Inc., Knoxville, TN (US)

(72) Inventors: John Patrick Shanahan, Knoxville, TN (US); Joel Kent Reed, Knoxville, TN (US)

(73) Assignee: ionogen Inc., Knoxville, TN (US)

(21) Appl. No.: 17/038,184

(22) Filed: Sep. 30, 2020

Related U.S. Application Data
(60) Provisional application No. 62/908,003, filed on Sep. 30, 2019.

(51) Int. Cl. C02F 1/78; C02F 1/461; C02F 1/66

(52) U.S. Cl. CPC C02F 1/78; C02F 2303/04; C02F 1/66; C02F 1/46109

(57) ABSTRACT

Disclosed herein are bubble-generating electrochemical reactors, as well as a reservoir system that comprises the same, used in a process for preparing a liquid agent medium comprising an oxidant effective for sanitizing, disinfecting, and/or cleaning an object.

### CROSS-REFERENCE TO RELATED APPLICATION

This application claims priority to U.S. Provisional Patent Application No. 62/908,003, filed on Sep. 30, 2019, the entire contents of which are incorporated herein by reference.

### FIELD

Disclosed herein are bubble-generating electrochemical reactors, as well as a reservoir system that comprises the same, used in a process for preparing a liquid agent medium comprising an oxidant effective for sanitizing, disinfecting, and/or cleaning an object.

### BACKGROUND

Harmful pathogens including viruses (e.g., SARS-CoV-2), bacterial, spores, and fungus have become more aggressive in the world than ever before. Traditional disinfectants and sanitizers are only minimally effective and some products that contain quaternary ammonium compounds (or quats) may be linked to reproductive and developmental problems in animals. See, e.g., Lim, Howes, Hrubec, and Zheng. Chlorinated products including bleach and other mixed oxidants degrade in a short period or are insufficient to eliminate effectively harmful pathogens. Prior processes that involve electrolysis of an aqueous brine solution have relied largely on flat alloy plates with a “flow through” design through a closed cell. See, e.g., U.S. Patent Nos. 5,938,916; 6,059,941; 6,296,744; 7,922,890; 8,211,288; and 9,309,601. While the process will provide a “flow batch” of hypochlorous acid (HOCl) and in some cases sodium hypochlorite (e.g., NaClO or bleach) these solutions decompose rapidly and lose efficacy. Previous systems include a closed-electrode cell arrangement where a pump operating at a constant flow rate is used to introduce a brine solution into an electrode system having a constant voltage applied across the cathode/anode plates having a constant dwell time. Prior processes that use, for example, flat alloy plates, generally are unable to generate oxidant species above about 200 ppm because of insufficient contact (or dwell) time between the electrically activated plates and the aqueous brine solution. Additionally, prior approaches that utilize, for example, a split stream, are unable to achieve the necessary stabilization due to the presence of a membrane that prohibits energizing the solution after it has left the energizing plates.

Using expanded metal alloys coupled with a liquid medium (e.g., a brine solution), optionally comprising a surfactant, and a constant current electrochemical reactor (“ECR”), a liquid agent medium may be developed and the sustained until the solution is used completely. This is accomplished with an electrochemical reactor disclosed herein that always remains in contact with the solution. This technology coupled with a specific use of power curve management and a consistent pulsing of the solution to maintain the liquid agent medium until consumed by the user.

### SUMMARY

A process for preparing a liquid agent medium, which comprises: contacting a liquid medium in a liquid medium reservoir comprising water and at least one redox active reagent with an electrochemical reactor running a first constant current of from about 1 A to about 100 A for a period of from about 5 min to about 360 min to obtain the liquid agent medium comprising water and the least one redox-produced agent comprising at least one oxidant having a concentration that ranges from about 200 ppm to about 3600 ppm; wherein the liquid medium has a pH of about 3.6 to about 6.8.

An electrochemical reactor, comprising: an array of at least two electrodes capable of being partially or fully immersed in a liquid medium having a controlled current applied to the at least two electrodes; wherein the array of at least two electrodes comprises an arrangement where a liquid medium flow velocity may be generated and maintained through the array by electrochemically formed bubbles in the array of the at least two electrodes; wherein the electrochemical reactor has (i) an adjacent inter-electrode distance that ranges from about 0.5 mm to about 5 mm, (ii) a total surface area for each electrode ranges from about 2,000 mm² to about 350,000 mm², and (iii) a flow path distance that ranges from about 1 mm to about 40 mm; and wherein the liquid medium flow velocity ranges from about 0.5 mm/sec to about 80 mm/sec.

### BRIEF DESCRIPTION OF THE DRAWINGS

The foregoing and other objects, features and advantages of the reactors, systems, processes, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1A represents a perspective view of a first electrochemical reactor.

FIG. 1B represents the transparent, perspective view of the first ECR of FIG. 1A.

FIG. 1C represents a top plan view of the first ECR of FIG. 1A.

FIG. 1D represents a cross-sectional view of the first ECR of FIG. 1A along plane A-A′ shown in FIG. 1C.

FIG. 2A represents a perspective view of a second ECR.

FIG. 2B represents a top plan view of the second ECR of FIG. 2A.

FIG. 2C represents a cross-sectional view of the second ECR of FIG. 2A along plane B-B′ shown in FIG. 2B.

FIG. 2D represents a perspective view of the second ECR of FIG. 2A during operation.

FIG. 3 represents side views of alternatively shaped ECRs.

FIG. 4A represents a perspective view of a third ECR.

FIG. 4B represents a side plan view of the third ECR of FIG. 4A.

FIG. 4C represents a cross-sectional view of the third ECR of FIG. 4A along plane D-D′ shown in FIG. 4B.

FIG. 4D represents a side plan view of the third ECR of FIG. 4A in operation.

FIG. 5A represents a perspective view of a fourth ECR.

FIG. 5B represents a perspective view of a fifth ECR.

FIG. 6A represents a plan view of a first reservoir system.

FIG. 6B represents a perspective view of a second reservoir system.

FIG. 6C represents a plan view of a third reservoir system.

FIG. 6D represents a plan view of a fourth reservoir system.

FIG. 7 represents a plan view of an on-site generation system.

FIG. 8A represents a perspective view of a fourth ECR.

FIG. 8B represents a first exploded view of the fourth ECR of FIG. 8A.

FIG. 8C represents a second exploded view of the fourth ECR of FIG. 8A.

FIG. 8D represents a perspective view of the fourth ECR with a fastening arrangement.

FIG. 8E represents an exploded view of the fourth ECR with a fastening arrangement, as shown in FIG. 8D.

FIG. 8F represents a cross-sectional view of the fourth ECR with a fastening arrangement along plane E-E′, as shown in FIG. 8D.

FIG. 8G represents a perspective view of the fourth ECR with a partial depiction of the fastening arrangement, as shown in FIG. 8D.

FIG. 8H represents a cross-sectional view of the fourth ECR with a partial depiction of the fastening arrangement along plane F-F′, as shown in FIG. 8G.

FIG. 81 represents a perspective view of a set of the fourth ECRs in a reservoir.

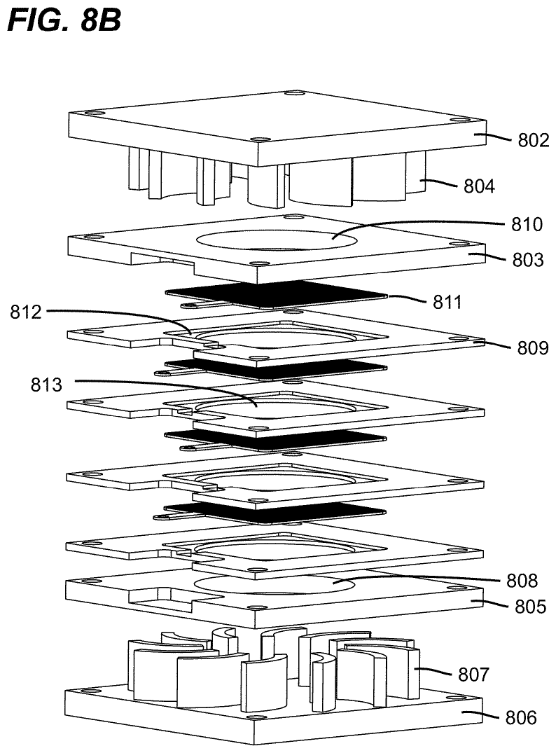

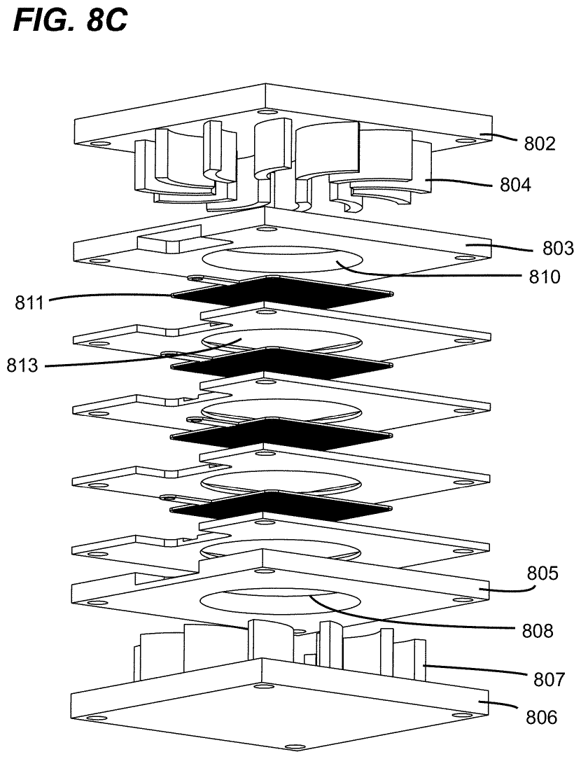

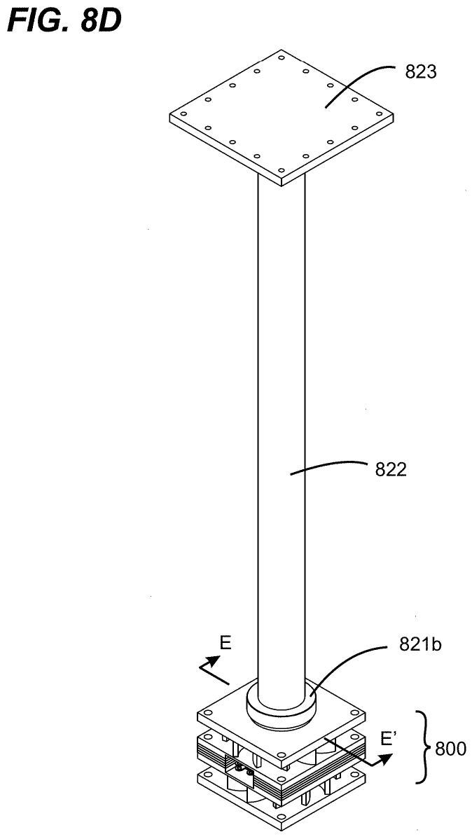

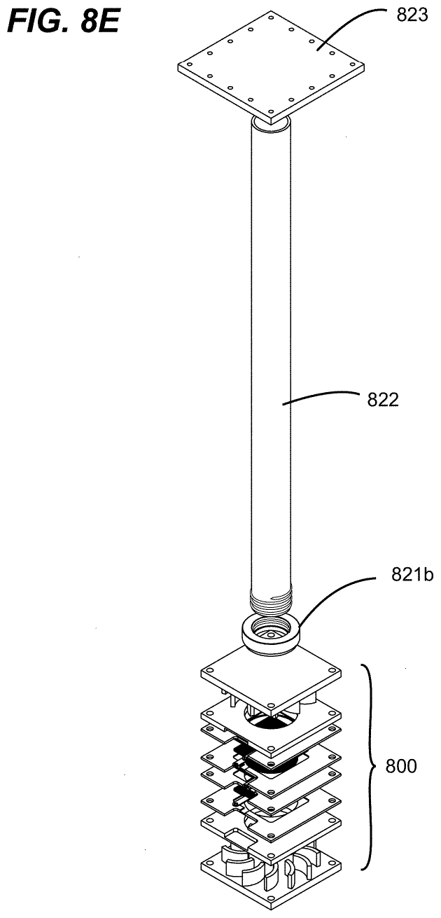

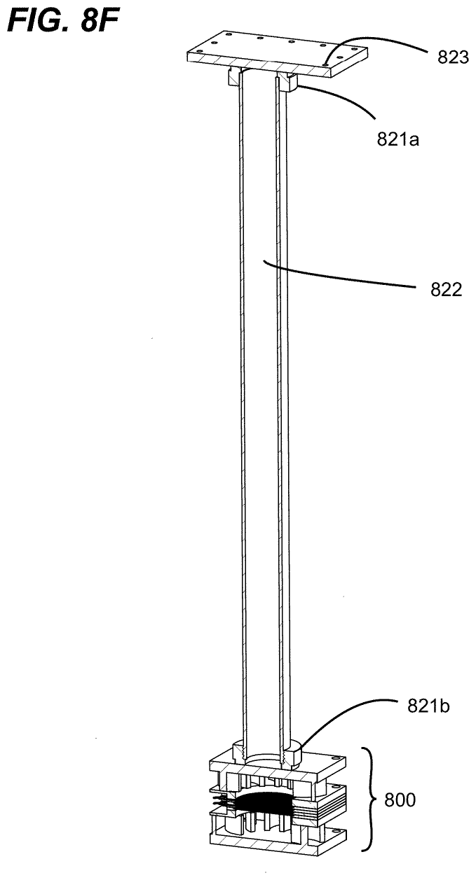

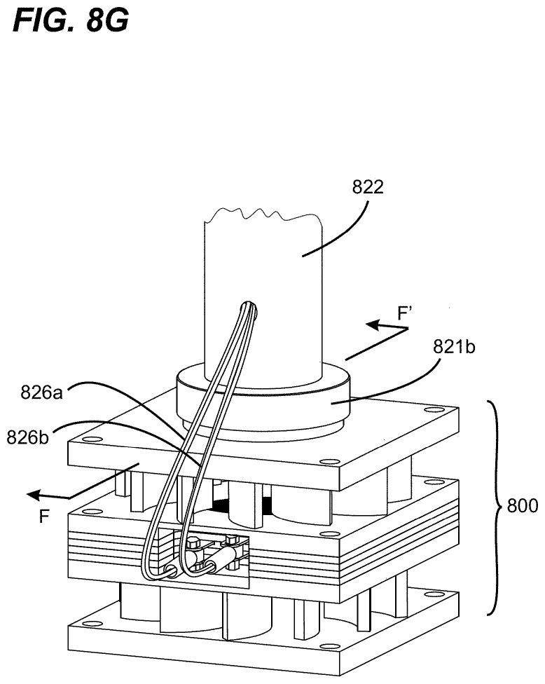

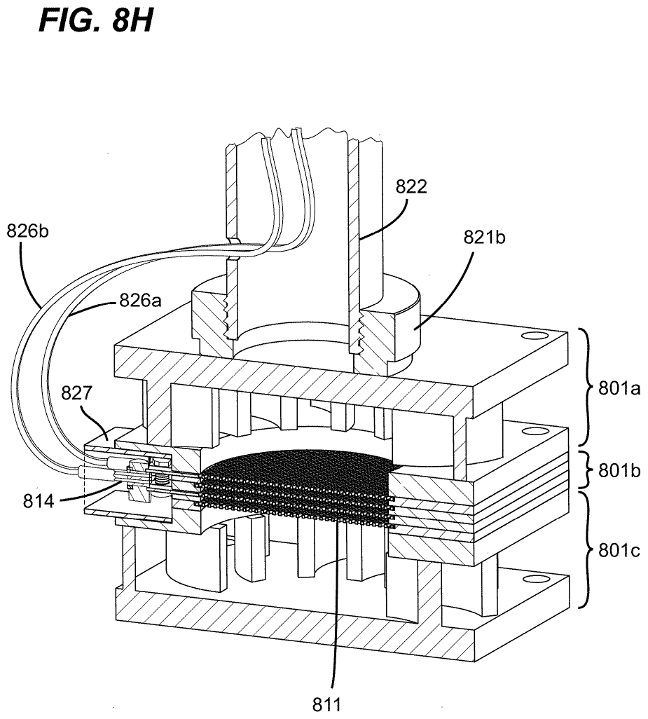

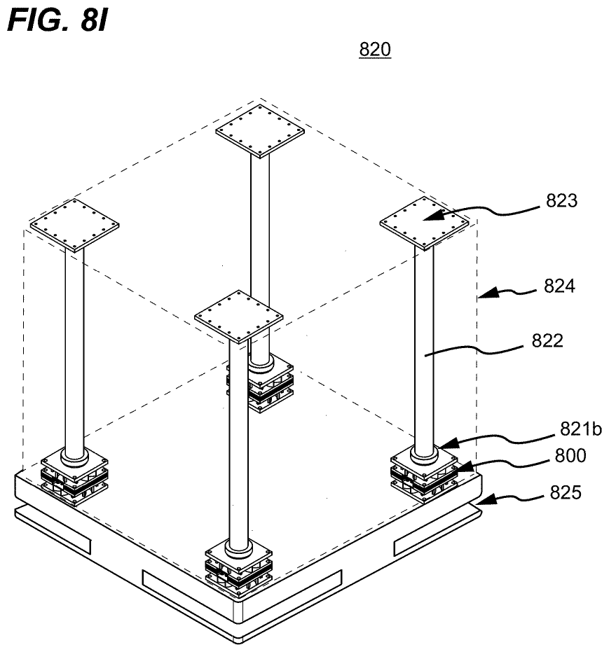

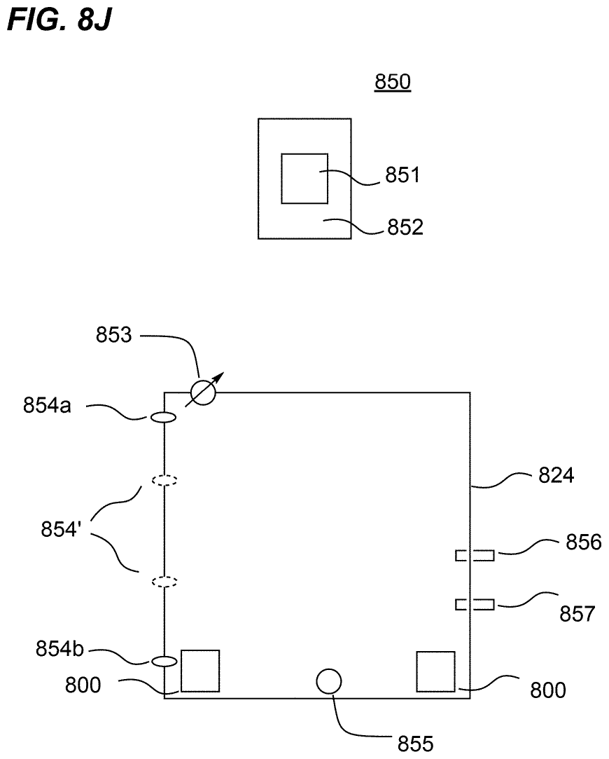

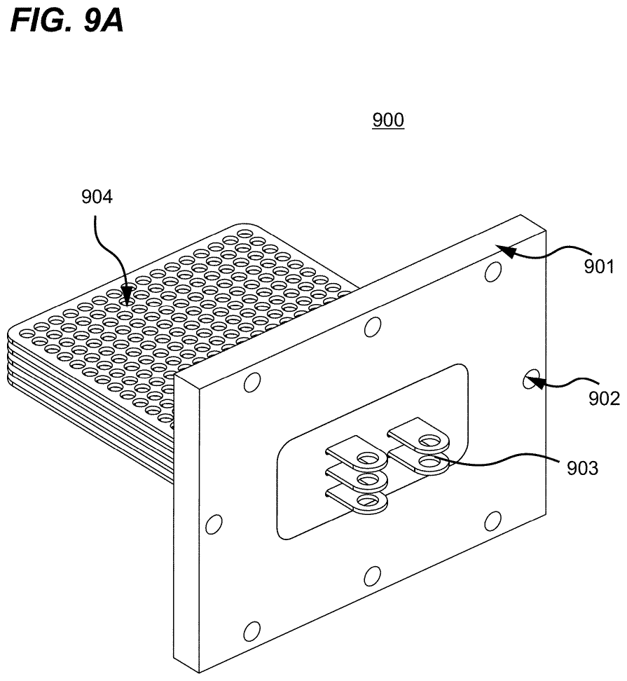

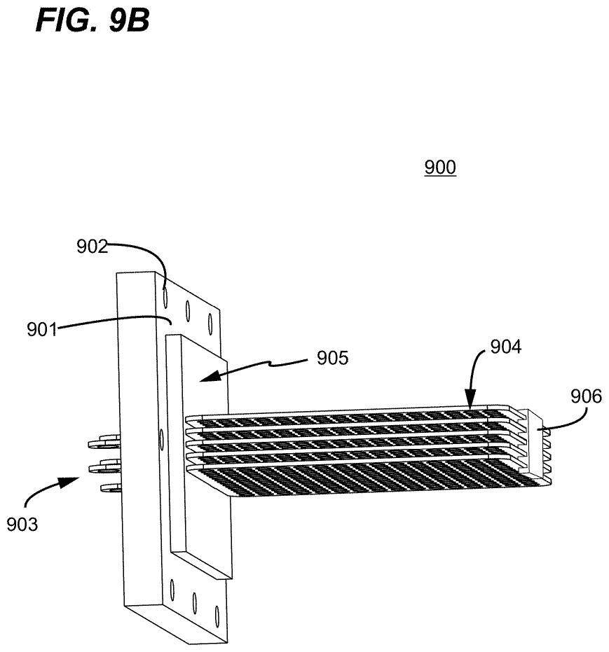

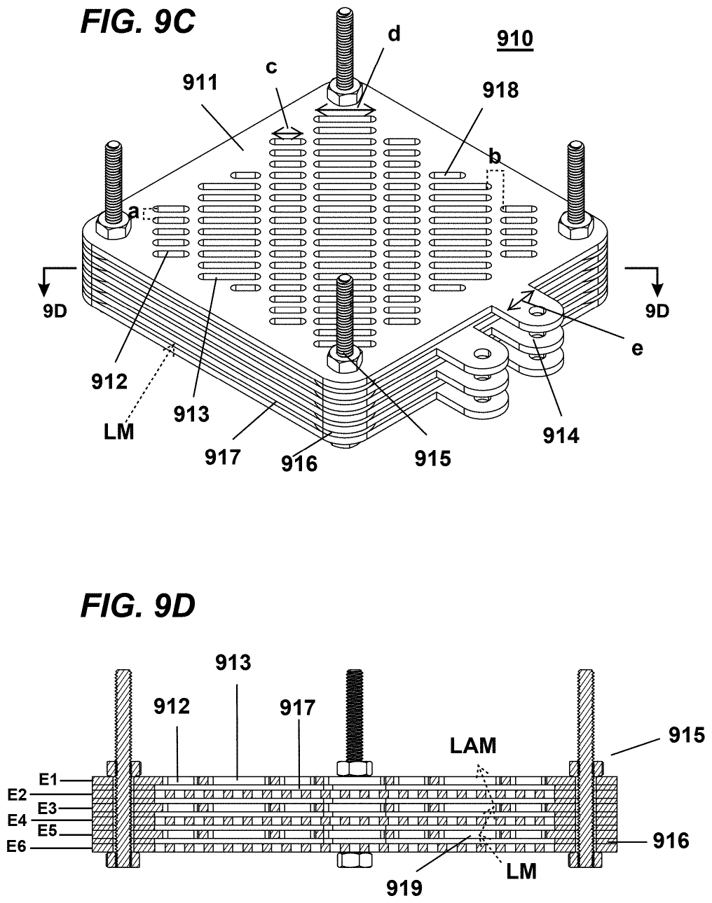

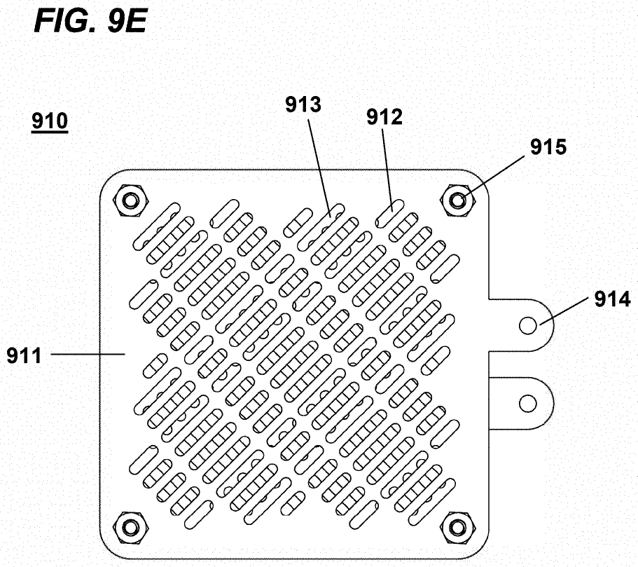

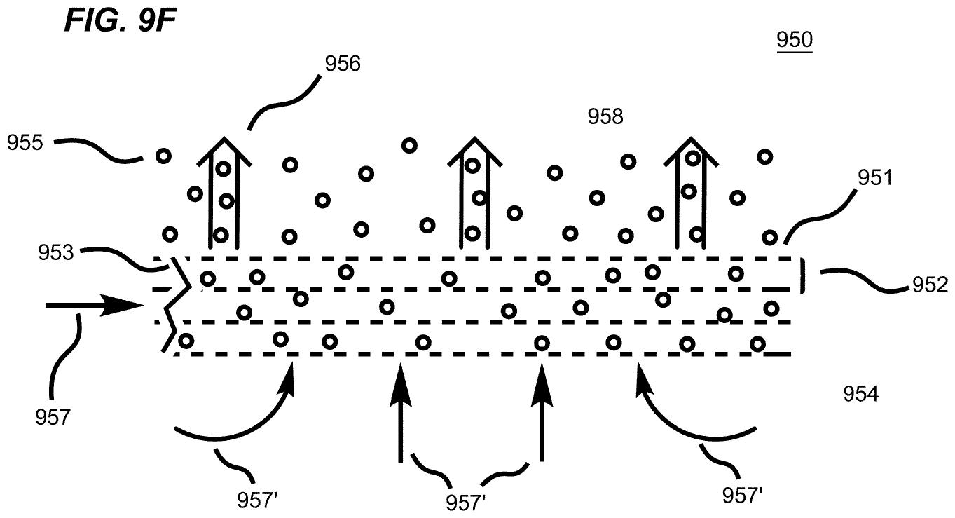

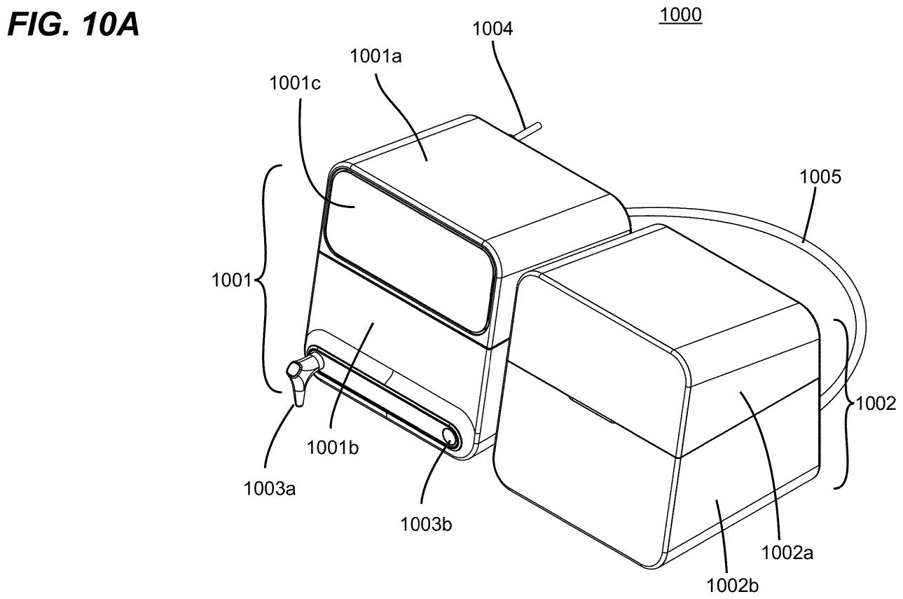

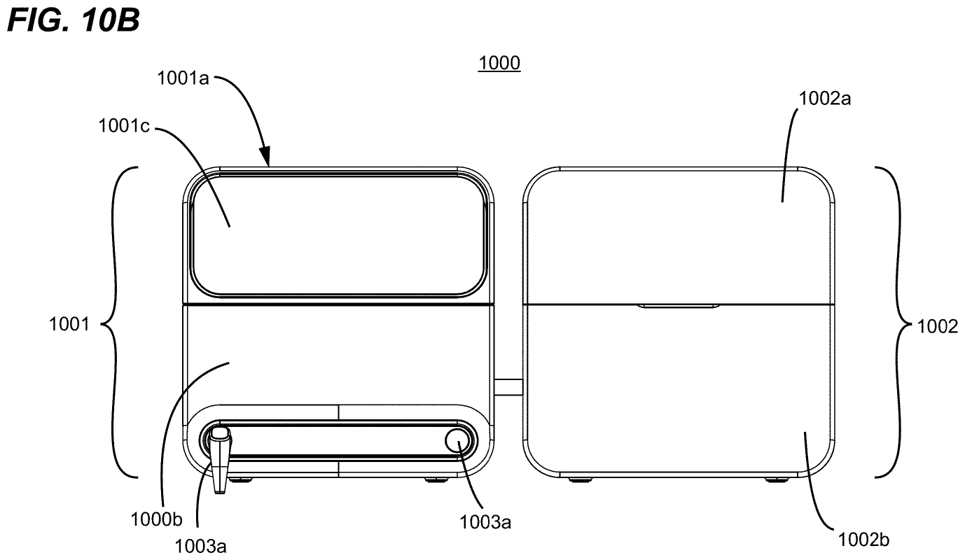

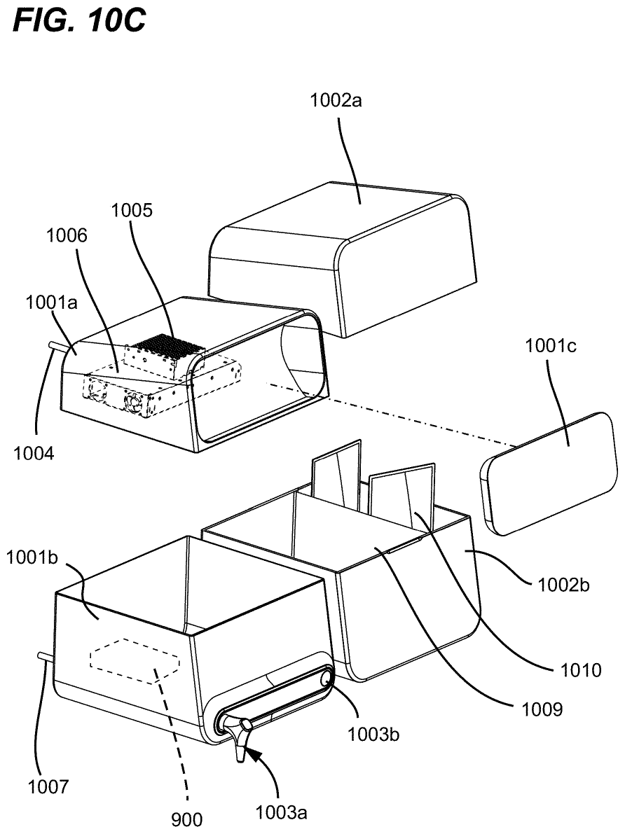

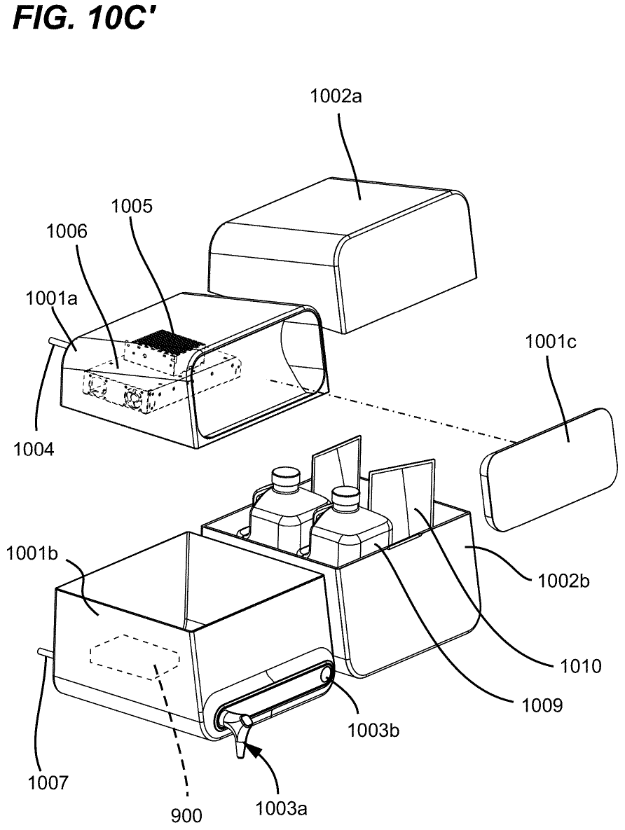

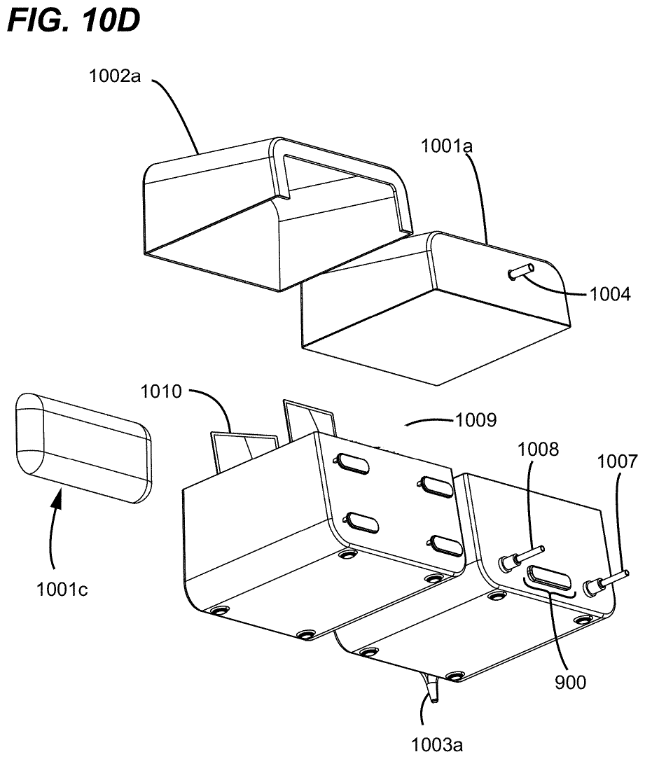

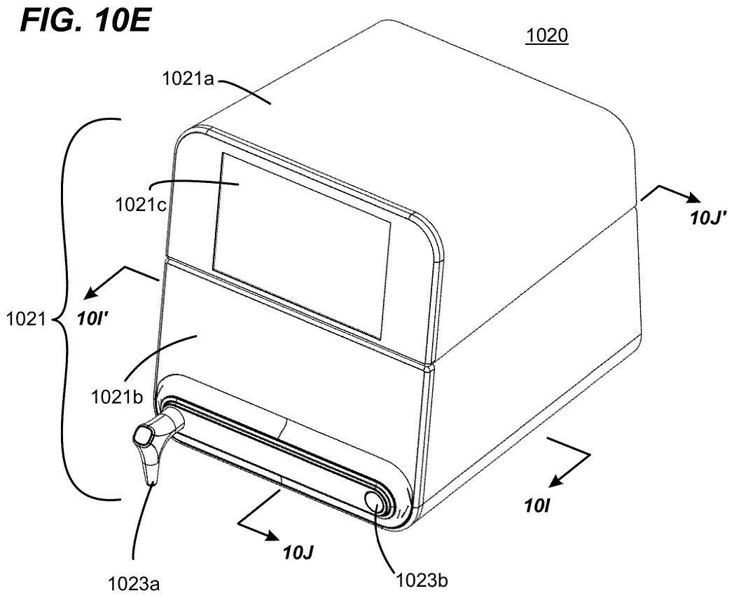

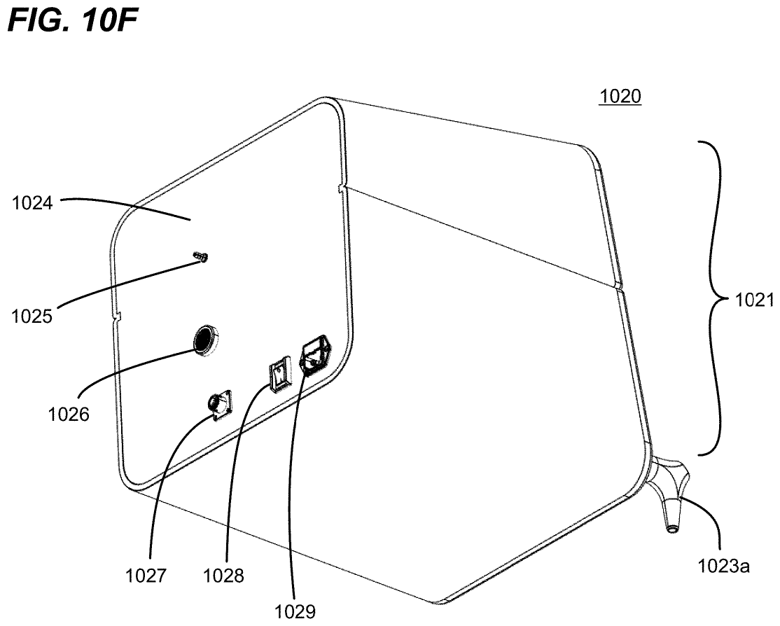

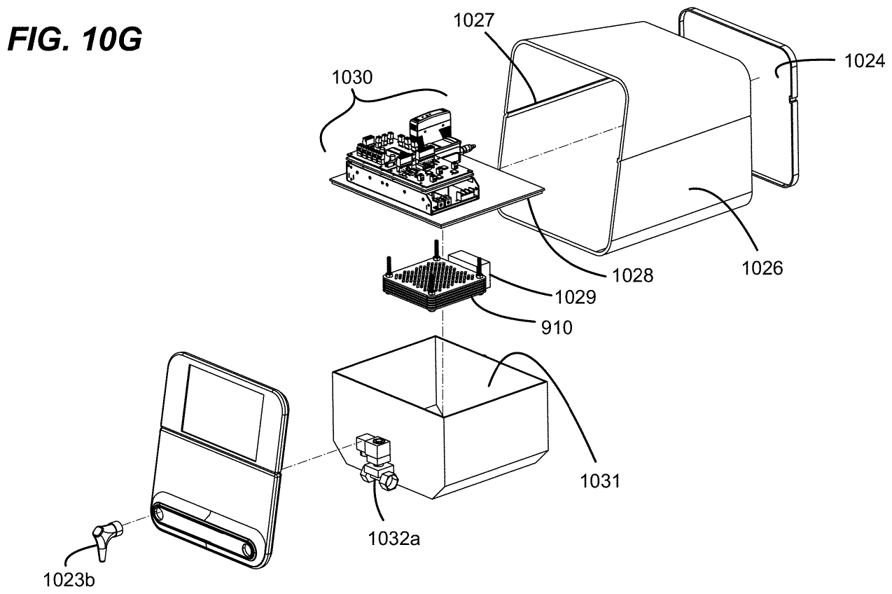

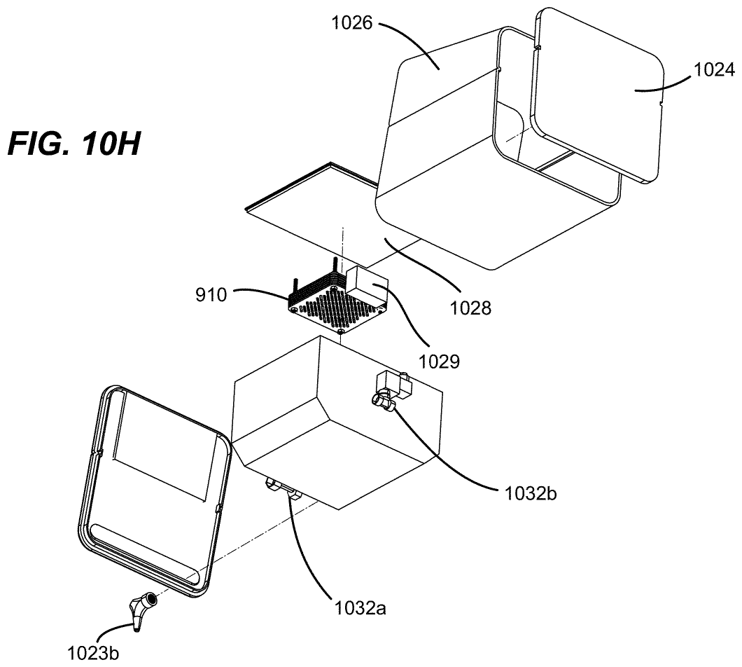

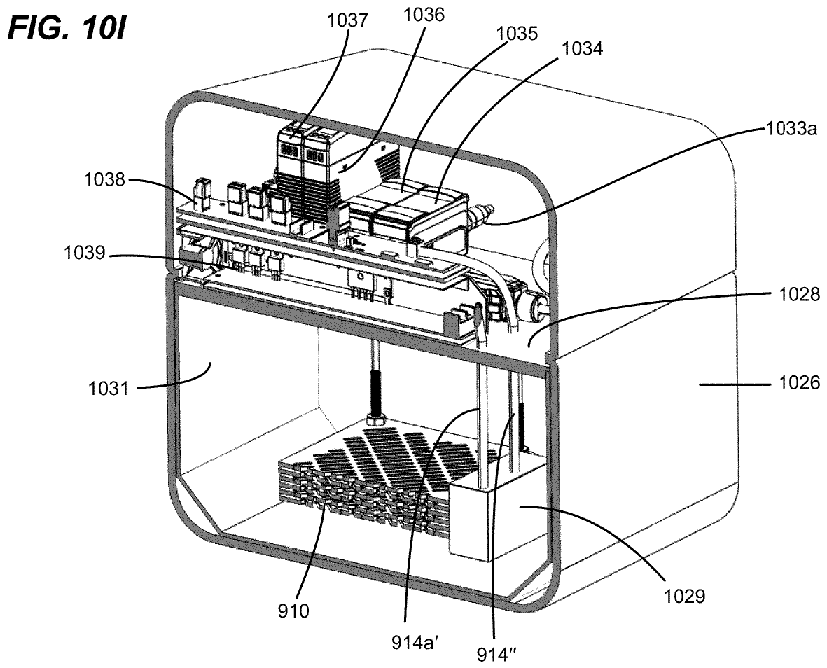

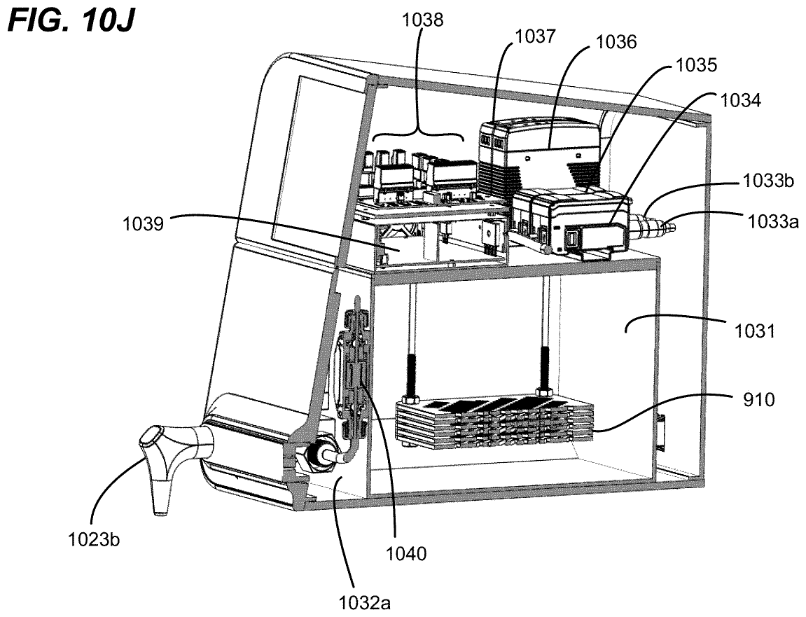

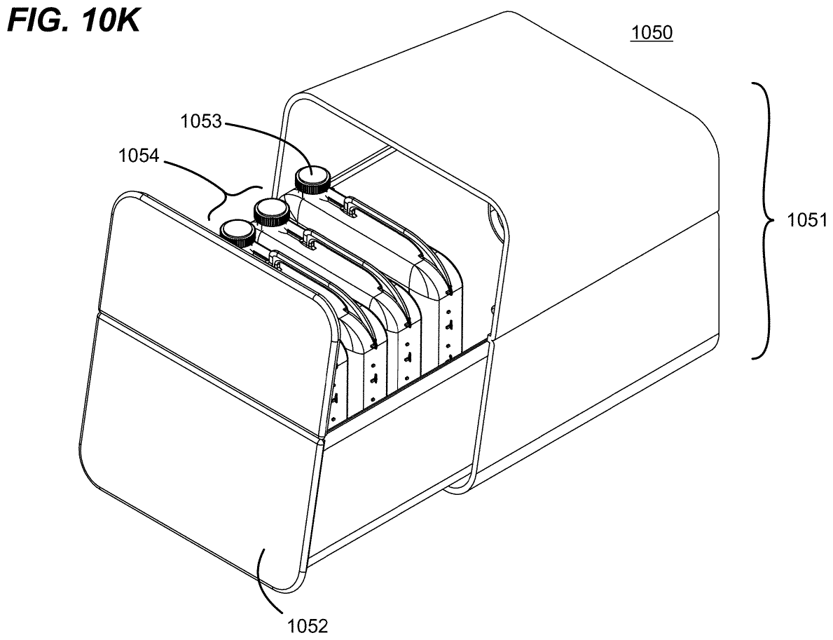

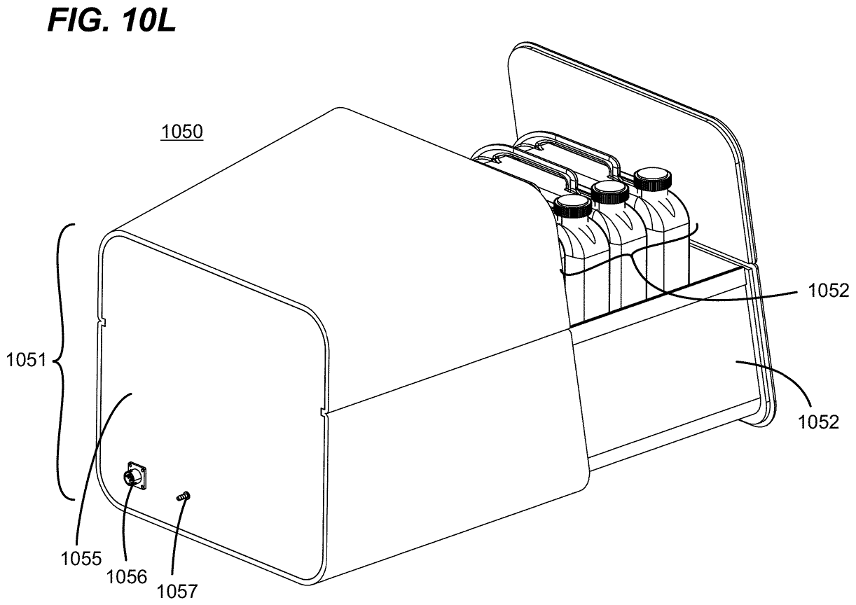

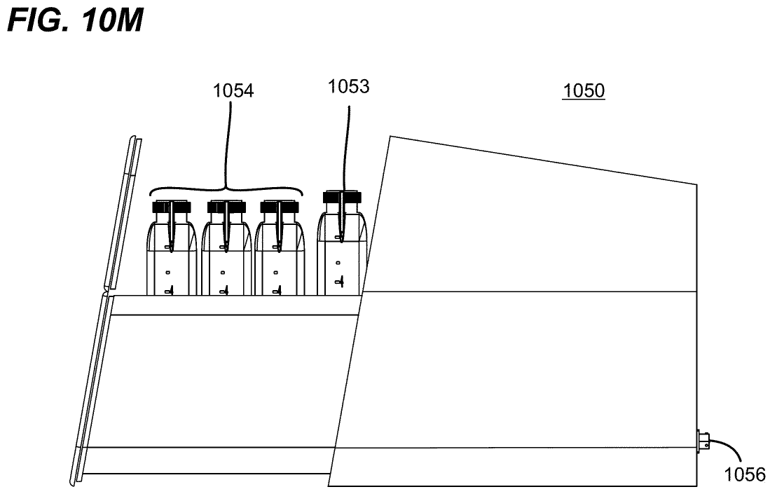

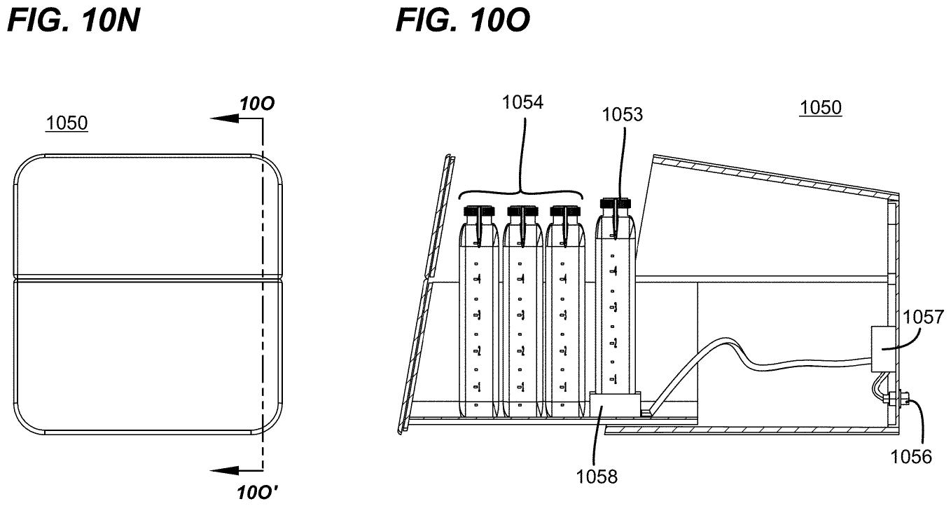

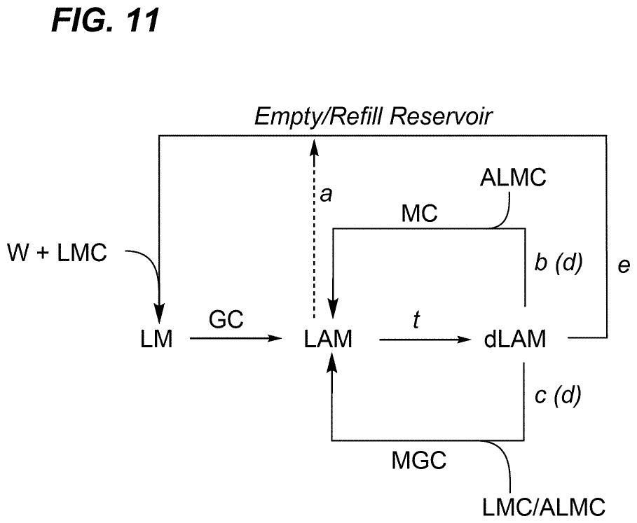

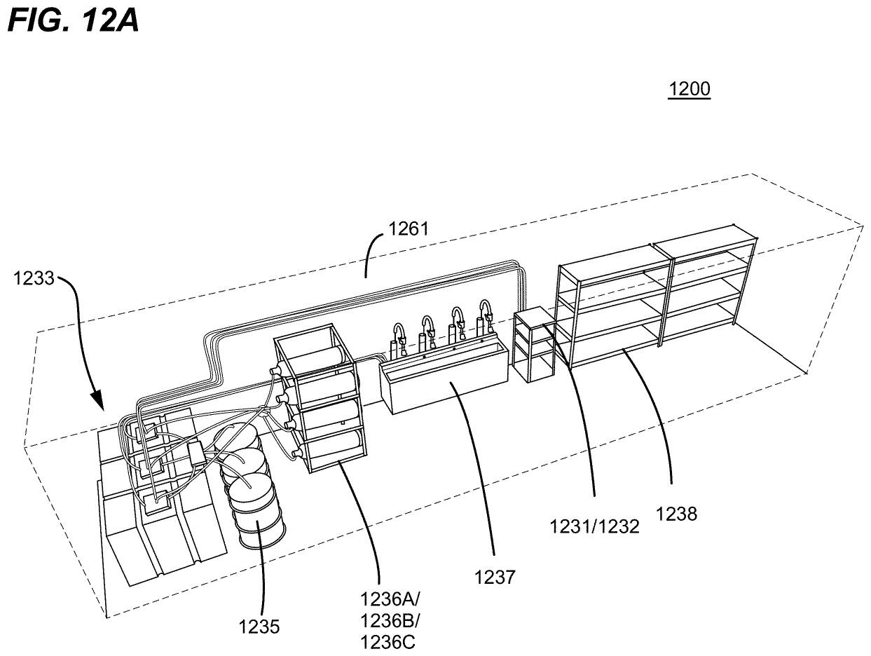

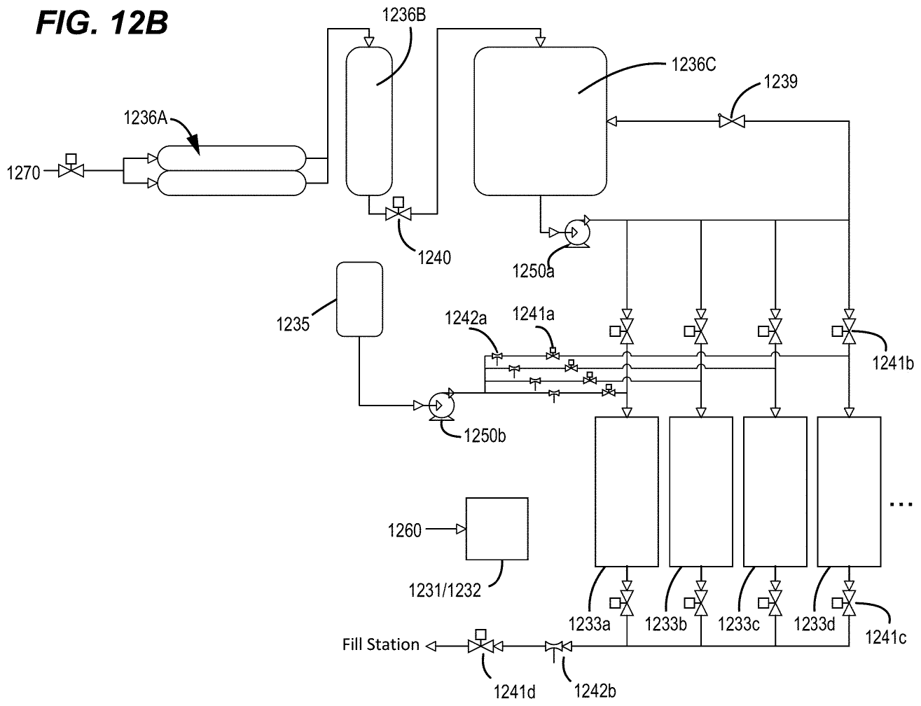

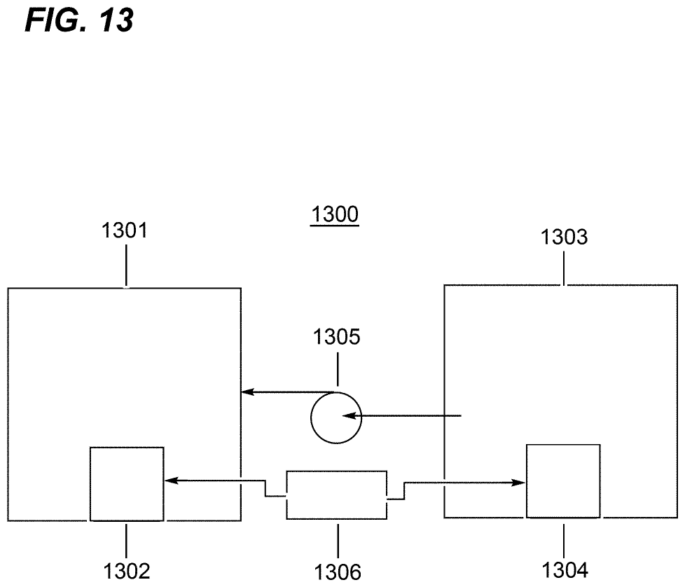

FIG. 8J represents a plan view of an on-site generation system.

FIG. 9A represents a perspective view of a fifth ECR.

FIG. 9B represents a side perspective view of the fifth ECR of FIG. 9A.

FIG. 9C represents a perspective view of a sixth ECR.

FIG. 9D represents a cross-sectional of the sixth ECR along plane 9D, as shown in FIG. 9C.

FIG. 9E represents a plan view of the sixth ECR of FIG. 9C.

FIG. 9F illustrates generally an operating principle associated with an ECR and process for preparing a liquid agent medium.

FIG. 10A represents a perspective view of a sanitizing/disinfecting system.

FIG. 10B represents a plan view of the sanitizing/disinfecting system of FIG. 10A.

FIG. 10C represents a first exploded view of the sanitizing/disinfecting system of FIG. 10A.

FIG. 10C′ represents a first exploded view of an alternative sanitizing/disinfecting system of FIG. 10A.

FIG. 10D represents a second exploded view of the sanitizing/disinfecting system of FIG. 10A.

FIG. 10E represents a front-side perspective view of a sanitizing/disinfecting system.

FIG. 10F represents a rear-side perspective view of the sanitizing/disinfecting system of FIG. 10E.

FIG. 10G represents a first exploded view of the sanitizing/disinfecting system of FIG. 10E.

FIG. 10H represents a second exploded view of the sanitizing/disinfecting system of FIG. 10E.

FIG. 101 represents a first cross-sectional view of the sanitizing/disinfecting system of FIG. 10E.

FIG. 10J represents a second cross-sectional view of the sanitizing/disinfecting system of FIG. 10E.

FIG. 10K represents a front-side perspective view of a partially open reservoir system.

FIG. 10L represents a rear-side perspective view of the partially open reservoir system. of FIG. 10K.

FIG. 10M represents a side plan view of the partially open reservoir system. of FIG. 10K.

FIG. 10N represents a front plan view of the partially open reservoir system. of FIG. 10K.

FIG. 100 represents a cross-sectional view of the partially open reservoir system of FIG. 10K, along plane 10O-10O′ as shown in FIG. 10N.

FIG. 11 represents a schematic illustrating features of a process for preparing a liquid active medium.

FIG. 12A represents a perspective view of a factory-in-a-box.

FIG. 12B represents a schematic view of a factory-in-a-box.

FIG. 13 represents a self-generating vaporizer system.

### DETAILED DESCRIPTION

The information that follows describes embodiments with reference to the accompanying figures, in which preferred embodiments may be shown. The foregoing may, however, be embodied in many different forms and should not be construed as limited to the illustrated embodiments set forth herein.

The phrase “a” or “an” entity as used herein refers to one or more of that entity. For example, an agent refers to one or more agents or at least one agent. As such, the terms “a” (or “an”), “one or more”, and “at least one” can be used interchangeably herein. The use of the definite article (“the”) to refer to “an entity” refers to one or more of that entity. For example, when the expression “the agent” refers to the previously recitation of “an agent” it is understood that the expression “the agent” refers to one or more agents, unless context indicates otherwise.

The terms “optional,” “optionally,” “if applicable,” or “if present” as used herein means that a subsequently described element, event, or circumstance may but need not occur, and that the description includes instances where the event or circumstance occurs and instances in which it does not.

References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, unless otherwise indicated or made clear from the context, the term “or” should generally be understood to mean “and/or” and, similarly, the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein.

It may be appreciated that a numerical value recited herein may be associated with a standard variation, such as ±5%, ±1%, or ±0.2%. The words “about,” “approximately,” or the like (e.g., ≈), when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the embodiments.

In the following description, it is understood that terms such as “first,” “second,” “third,” “above,” “upper,” “lower,” “below,” “lateral,” “vertical,” and the like, are words of convenience and are not to be construed as implying a positional or chronological order or otherwise limiting any corresponding element unless expressly state otherwise.

An embodiment disclosed herein relates to an electrochemical reactor, comprising: an array of at least two electrodes capable of being partially or fully immersed in a liquid medium having a controlled current applied to the at least two electrodes; wherein the array of at least two electrodes comprises an arrangement where a liquid medium flow velocity may be generated and maintained through the array by electrochemically formed bubbles in the array of the at least two electrodes; wherein the electrochemical reactor has (i) an adjacent inter-electrode distance that ranges from about 0.5 mm to about 5 mm, (ii) a total surface area for each electrode ranges from about 2,000 mm² to about 350,000 mm², and (iii) a flow path distance that ranges from about 1 mm to about 40 mm; and wherein the liquid medium flow velocity ranges from about 0.5 mm/sec to about 80 mm/sec.

Another embodiment disclosed herein relates to a process for preparing a liquid agent medium, which comprises: contacting a liquid medium in a liquid medium reservoir comprising water and at least one redox active reagent with an electrochemical reactor running a first constant current of from about 1 A to about 100 A for a period of from about 5 min to about 360 min to obtain the liquid agent medium comprising water and the least one redox-produced agent comprising at least one oxidant having a concentration that ranges from about 200 ppm to about 3600 ppm; wherein the liquid medium has a pH of about 3.6 to about 6.8.

Not to be limited by way of the following explanation, FIG. 9F illustrates generally an operating principle 950 associated with an ECR and process for preparing a liquid agent medium 958 from a liquid medium 954 by way of an electrochemical reactor disclosed herein. For instance, an array of at least two electrodes 951 (e.g., at least one anode and at least one cathode) partially or fully immersed in a liquid medium 954 may be energized with a constant current (e.g., of from about 1 A to about 100 A) for a time period (e.g., of from about 5 min to about 360 min) whereby electrochemically formed bubbles 955 escape the electrochemical reactor in a direction 956 (e.g., towards a headspace) that generates a liquid medium flow velocity 957/957′ (e.g., of from about 0.5 mm/sec to about 80 mm/sec). It may be appreciated that an array of at least two electrodes have an adjacent inter-electrode distance 952 (e.g., about 0.5 mm to about 2 mm) and a flow path distance 953 (e.g., from about 1 mm to about 40 mm) through the array of at least two electrodes. As shown, the flow of liquid medium 957/957′ may proceed from any available direction. In one aspect, an electrochemical reactor may be configured to restrict liquid flow from one or more directions (e.g., restricting flow from a lateral direction) thereby permitting flow in a vertical direction (e.g., 975′).

The controlled current applied to the ECR may range from about 1 A to about 100 A, and all values in between, including for example about 2 A, about 3 A, about 4 A, about 5 A, about 6 A, about 7 A, about 8 A, about 9 A, about 10 A, about 11 A, about 12 A, about 13 A, about 14 A, about 15 A, about 16 A, about 17 A, about 18 A, about 19 A, about 20 A, about 21, about 22 A, about 23 A, about 24 A, about 25 A, about 26 A, about 27 A, about 28 A, about 29 A, about 30 A, about 31, about 32 A, about 33 A, about 34 A, about 35 A, about 36 A, about 37 A, about 38 A, about 39 A, about 40 A, about 41, about 42 A, about 43 A, about 44 A, about 45 A, about 46 A, about 47 A, about 48 A, about 49 A, about 50 A, about 51, about 52 A, about 53 A, about 54 A, about 55 A, about 56 A, about 57 A, about 58 A, about 59 A, about 60 A, about 61, about 62 A, about 63 A, about 64 A, about 65 A, about 66 A, about 67 A, about 68 A, about 69 A, about 70 A, about 71, about 72 A, about 73 A, about 74 A, about 75 A, about 76 A, about 77 A, about 78 A, about 79 A, about 80 A, about 81, about 82 A, about 83 A, about 84 A, about 85 A, about 86 A, about 87 A, about 88 A, about 89 A, about 90 A, about 91, about 92 A, about 93 A, about 94 A, about 95 A, about 96 A, about 97 A, about 98 A, and about 99 A.

The adjacent inter-electrode distance for an ECR ranges from about 0.5 mm to about 5 mm, and all values in between, such as for example, about 0.6 mm, about 0.7 mm, about 0.8 mm, about 0.9 mm, about 1 mm, about 1.2 mm, about 1.3 mm, about 1.4 mm, about 1.5 mm, about 1.6 mm, about 1.7 mm, about 1.8 mm, about 1.9 mm, about 2 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm..., and about 4.9 mm.

The total surface area for each electrode ranges from about 2,000 mm² to about 350,000 mm² and all values in between, such as for example about 2,000 mm², about 3,000 mm², about 4,000 mm², about 4,000 mm², about 6,000 mm², about 7,000 mm², about 8,000 mm², about 9,000 mm², about 10,000 mm², about 20,000 mm², about 30,000 mm², about 40,000 mm², about 50,000 mm², about 60,000 mm², about 70,000 mm², about 80,000 mm², about 90,000 mm², about 100,000 mm², about 110,000 mm², about 20,000 mm², about 130,000 mm², about 140,000 mm², about 150,000 mm², about 160,000 mm², about 170,000 mm², about 180,000 mm², about 190,000 mm², about 200,000 mm², about 210,000 mm², about 220,000 mm², about 230,000 mm², about 240,000 mm², about 250,000 mm², about 260,000 mm², about 270,000 mm², about 280,000 mm², about 290,000 mm², about 300,000 mm², about 310,000 mm², about 320,000 mm², about 330,000 mm², and about 340,000 mm².

The total surface area for all electrodes depends on the surface area for each electrode and the number of electrodes. In view of the information provided above, it may be appreciated that the total surface area for an ECR comprising two electrodes ranges from about 4,000 mm² to about 700,000 mm²; the total surface area for an ECR comprising five electrodes ranges from about 10,000 mm² to about 1,750,000 mm²; and the total surface area for an ECR comprising ten electrodes ranges from about 20,000 mm² to about 3,500,000 mm².

A flow path distance for the ECR ranges from about 1 mm to about 40 mm and all values in between, such as for example, about 2 mm, about 3 mm, about 4 mm, about 5 mm, about 6 mm, about 7 mm, about 8 mm, about 9 mm, about 10 mm, about 21 mm, about 22 mm, about 23 mm, about 24 mm, about 25 mm, about 26 mm, about 27 mm, about 28 mm, about 29 mm, about 30 mm, about 31 mm, about 32 mm, about 33 mm, about 34 mm, about 35 mm, about 36 mm, about 37 mm, about 38 mm, and about 39 mm.

A. Electrochemical Reactor

Generally, an electrochemical reactor (“ECR”) may be configured to be mounted on a reservoir, configured to be submersible in a reservoir, and the like, with the aim that the electrochemical reactor may be partially or fully immersed in a liquid medium. Information that follows illustrate various embodiments of the ECRs, which may be referred to herein as a “bubble-generating reactor” (or BGR), a vortex-generating reactor (or VGR), an internal external reactor (or “NER”), an internal-submersible reactor (or “ISR”). It may be understood that all of the ECRs disclosed herein are capable of forming electrochemically generated bubbles when the ECR comprising a constant current contacts a liquid medium comprising at least one redox active reagent. In certain embodiments, a specific ECR may be recited; however, one will appreciate that an alternative ECR may be employed instead.

A first embodiment relates to a electrochemical reactor (ECR or bubble-generating reactor (“BGR”)) comprising a plenum comprising a surface having two vents and an array of from two to ten electrodes each capable of receiving an electrical current, wherein said bubble-generating reactor may be coupled to a reservoir containing a liquid medium.

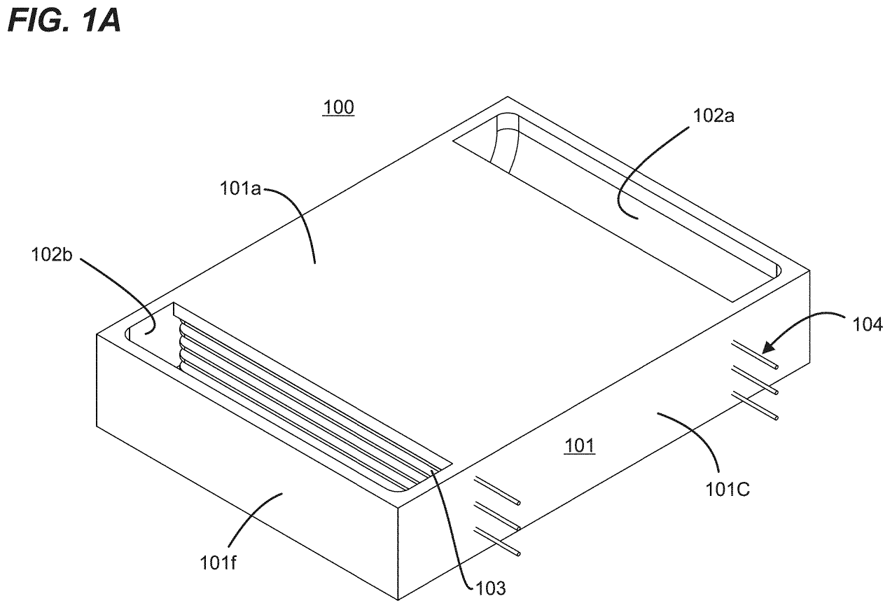

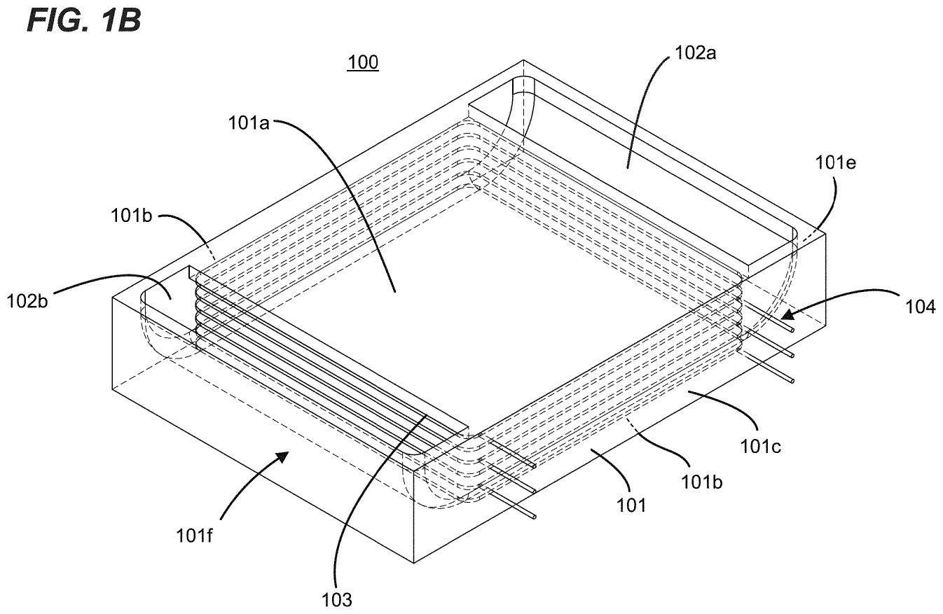

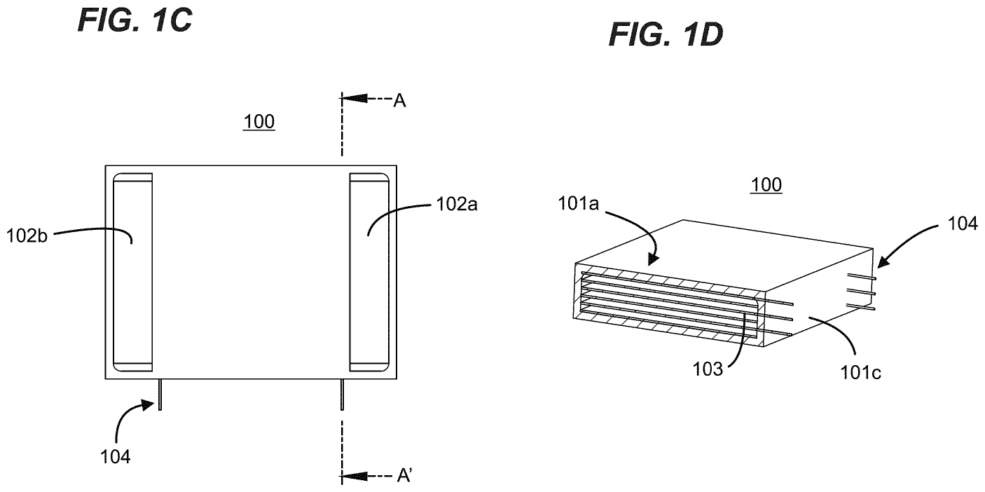

As seen from FIG. 1A, the bubble-generating reactor (“BGR”) 100 comprises a plenum 101 having six faces. Disposed within the BGR is an array comprising six electrodes 103 each having an electrical contact 104. Also as seen from FIG. 1A, the proximal face of the plenum 101 comprises a proximal surface 101a, an upper vent 102a, and a lower vent 102b. The BGR 100 includes a void volume that permits introduction of a liquid medium.

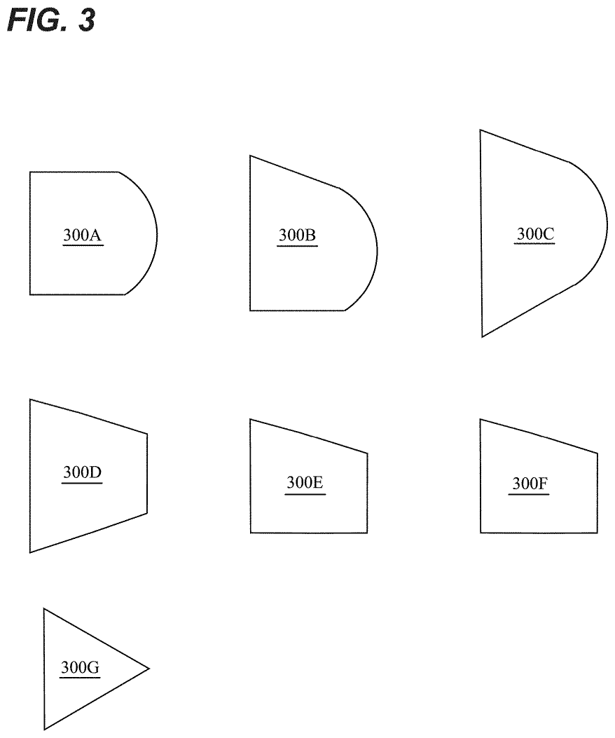

Generally, the plenum may comprise at least five faces (or surfaces) where one face includes at least two vents. The plenums may be configured in any suitable design that permit housing of the electrodes and a sufficient void volume to accommodate the liquid medium. FIG. 3 depicts several alternative side views of possible BGRs (e.g., 300A-300G). The plenum design is not restricted to the designs disclosed herein. Any suitable plenum design may be satisfactory for operation of the BGR. For example, during the application of electrical current to the BGR a volume of gas is formed, and thus, a suitable plenum design permits for the release of said gas from the plenum.

Generally, the plenum face having at least two vents has an upper vent and a lower vent. For example, an upper vent may be situated towards the topmost region of the face, while a lower vent may be situated towards the bottommost region of the face (e.g., bottom vent). As shown in FIGS. 1A and 1C, the upper and lower vents are unitary constructions. It may be contemplated that any suitable vent may be adapted for use in the BGR. For example, a vent may comprise a plurality of rectilinear openings separated by dividers (e.g., a grill-like configuration) or a vent may comprise a plurality of apertures (e.g., a configuration having circular or hexagonal apertures). Flow transfer through the BGR may be achieved by having a total vent surface area of from about 10% to about 80% of the total surface area of the plenum face comprising said vents, with the understanding that the “surface area” of a vent relates to the width and the height of the vent opening(s). It has been determined that a total vent surface area of from about 20% to about 30% of the total surface area of the plenum face comprising said vents provides a suitable flow of both liquid medium and emerging liquid agent medium.

The plenum comprises any suitable chemically resistant material. Examples of a suitable chemically resistant material include, but are not limited to, a metallic alloy, a ceramic, and a plastic. Examples of a metallic alloy include, but are not limited to, an alloy of iron with chromium (e.g., stainless steel), an alloy comprising one or more of titanium, zirconium, molybdenum, and tantalum, and the like. Examples of a ceramic include, but are not limited to, a silicon/silicon carbide composite, a tungsten carbide, an aluminum oxide, a silicon carbide, and the like. Examples of a plastic include, but are not limited to, a polyethylene, such as ultrahigh molecular weight (UHMW) polyethylene, high density polyethylene (HDPE), a fluorinated polymer, such as, polytetrafluoroethylene (PTFE, e.g., Teflon), polyvinylidene fluoride (PVDF), a chlorinated polymer, such as, chlorinated polyvinyl chloride (CPVC) or polyvinyl chloride (PVC), a polypropylene, a polyethylene copolymer, a polypropylene copolymer, and other polymers, such as polydicyclopentadiene (pDCPD), an acrylonitrile butadiene styrene (“ABS”), a polyetherether ketone (“PEEK”).

As seen from FIG. 1B, the electrodes 103 (e.g., comprised of at least one anodic electrode and at least one cathodic electrode) may be situated in the interior of the plenum. Also as seen from FIGS. 1B and 1D, the electrodes are generally planar, each of which are separated from one another by a fixed distance, e.g., from about 0.5 to about 5 mm and all distances in between, such as for example, about 0.6 mm, about 0.7 mm, about 0.8 mm, about 0.9 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm, about 3.1 mm, about 3.2 mm, about 3.3 mm, about 3.4 mm, about 3.5 mm, about 3.6 mm, about 3.7 mm, about 3.8 mm, about 3.9 mm, about 3.0 mm, about 4.1 mm, about 4.2 mm, about 4.3 mm, about 4.4 mm, about 4.5 mm, about 4.6 mm, about 4.7 mm, about 4.8 mm, and about 4.9 mm. In this regard, the plenum may include a ridge or track for each electrode, such that the inter-planar distance between each electrode may be fixed (e.g., from about 0.5 mm to about 5 mm). The electrical contacts 104 may be in the form of a tab, a wire, a pin or another suitable connector that permits connection to a wire for the introduction of an electrical current. The electrical contacts permit the introduction of an electrical current from an electrical source to each electrode. The electrical contact 104 may span through the wall of the plenum by way of an aperture, which may be sealed to prevent liquid medium egress. As explained herein, the electrical contact may have a length of about 10% to about 50% the length of the electrode.

The electrode comprises any suitable material. Examples include, but are not limited to, aluminum, a ceramic (e.g., zirconia-based, hafnia-based, chromite-based, carbide-based, carbon-based (e.g., graphite, graphene, and the like) alumina-based, ceria-based, or disilicon-molydenum-based), chromium or oxide thereof, cobalt or alloy thereof, copper or alloy thereof, gold, hafnium or oxide thereof, iridium or oxide thereof, iron or alloy thereof (e.g., a stainless steel), lanthanum, lead, manganese, molybdenum, nickel or alloy thereof, niobium or alloy thereof, osmium or alloy thereof, palladium, platinum, rhenium or oxide thereof, rhodium or alloy thereof, ruthenium or alloy or oxide thereof, selenium, silver, tantalum or alloy thereof, titanium or alloy thereof, tungsten or alloy thereof, vanadium or alloy thereof, yttrium or alloy thereof, zinc or alloy thereof, zirconium or alloy thereof, or a combination thereof. Depending on the application, the material may exhibit a high degree of chemical resistance and/or may exhibit a high degree of electrical conductivity. The electrode may comprise a substrate having a suitable thickness, wherein one or more materials are disposed on or within said substrate. The amounts of one or more materials disposed on or within said substrate depends on the application. For instance, an electrode may comprise a separately layered structure of a Group 8 metal (e.g., ruthenium and/or osmium) and a Group 9 metal (e.g., rhodium and/or iridium) disposed on substrate comprised or a Group 4 (e.g., titanium, zirconium, and/or hafnium) and/or Group 5 (e.g., vanadium, niobium, and/or tantalum) having a thickness of about 0.4 μm to about 0.8 μm, and all values in between, such as, about 0.5 μm, about 0.6 μm, and about 0.7 μm.

The electrode may be of any suitable size depending on the application. For example, in one aspect, an electrode may be dimensioned to have a length of about 50 mm, a width of about 50 mm, and a height of about 1 mm (or about 50 mm× about 50 mm× about 1 mm). Alternatively, in another aspect an electrode may be dimensioned to have a length of about 300 mm, a width of about 300 mm, and a height of about 1 mm (or 300 mm×300 mm×1 mm). As shown in FIGS. 1A-1B, the electrodes are situated behind the distal face of the plenum 101a. In view of foregoing, therefore, it is contemplated that each of the electrode length and width independently may be about 20 mm to about 500 mm, and all distances in between, such as, for example about 25 mm, about 30 mm, about 35 mm, about 40 mm, . . . about 480 mm, about 485 mm, about 490 mm, and about 495 mm, where the ellipsis indicates all distances from about 45 mm to about 475 mm in 5 mm increments. It is contemplated further that the electrode height ranges from about 0.5 mm to about 5 mm, and all distances in between, such as, for example about 1 mm, about 1.5 mm, about 2 mm, and the like.

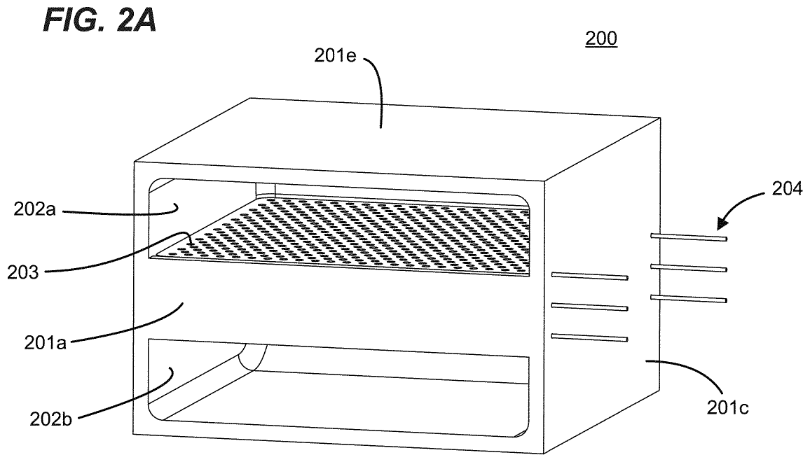

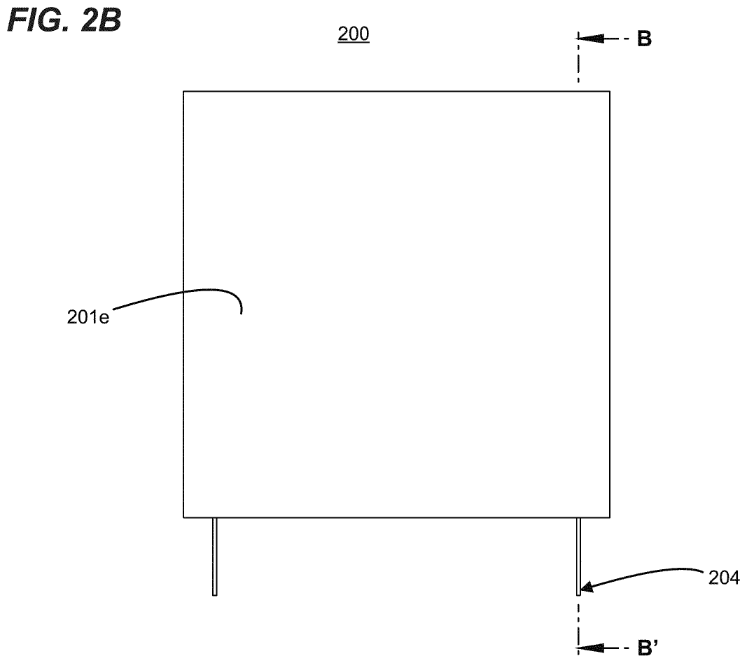

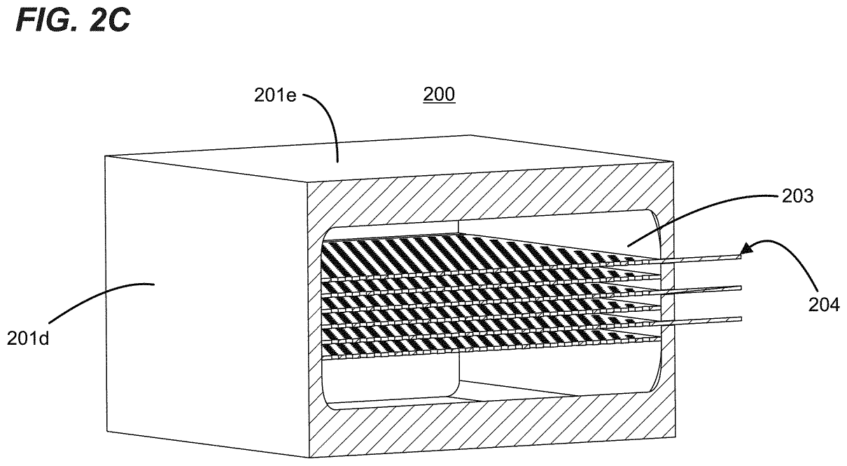

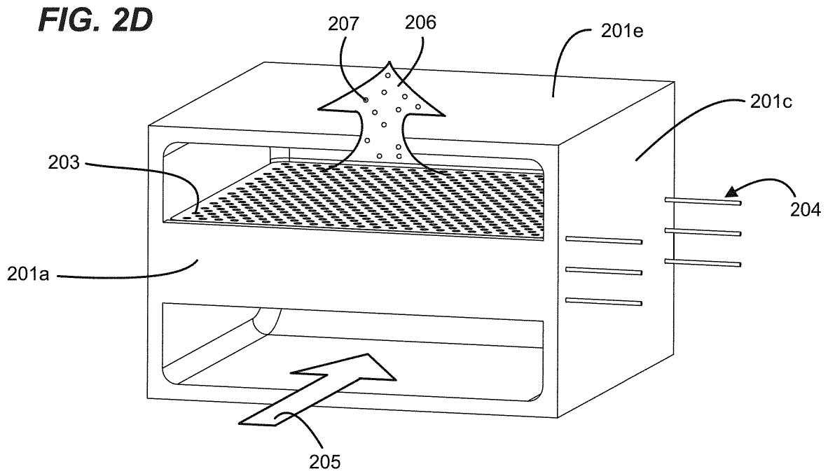

The electrode may be a solid optionally comprising apertures, a perforated solid, a mesh material, or a porous material. FIG. 2A depicts another aspect of the BGR (or ECR), where the electrodes 203 (e.g., comprised of at least one anodic electrode and at least one cathodic electrode) disposed therein comprise regularly spaced apertures.

As stated herein, a BGR may comprise from two to ten electrodes. In theory, one may envision that the number of electrodes may be increased to eleven or more. In practice, however, the maximum number of electrodes may be governed by the void coefficient of reactivity due to, for example, the generated bubbles. Accordingly, a BGR contemplated herein comprises two to seven electrodes, or two to five electrodes.

With reference to FIG. 2A, one will appreciate that a proximal plenum face comprises a surface 201a, an upper vent 202a, and a lower vent 202b. The plenum proximal surface 201a has an area that may approximate the electrode length, the electrode height, and the inter-electrode distance. For example, the plenum proximal surface 201a has length that may be slightly larger than the electrode length (e.g., of about 50 mm) with the understanding that the plenum proximal surface 201a may be dimensioned to have a length to accommodate the plenum void volume and the outer casing. Further, the plenum surface 201a height may be dictated by the number of electrodes disposed therein. For instance, a BGR comprised of two electrodes, each having a height of about 1 mm and an inter-electrode distance of from about 1 mm to about 8 mm (and all values in between, for example about 2 mm, about 3 mm, and the like), may result in plenum proximal surface 201a height of about 3 mm to about 12 mm. Further a BGR comprised of six electrodes may result in a plenum proximal surface 201a height of about 11 mm to about 46 mm. In one aspect related to a BGR comprising six electrodes, the plenum proximal surface 201a has a surface area of about 550 mm² to about 2300 mm², and the total vent surface area ranges from about 100 mm² to about 700 mm² when the total vent surface area ranges from about 20% to about 30% of the total surface area of the plenum face.

A second embodiment relates to a bubble-generating reactor comprising a plenum at least two vents and from two to ten electrodes each capable of receiving an electrical current, wherein said bubble-generating reactor may be submerged within a reservoir containing a liquid medium.

In one aspect, the BGR of the second embodiment may comprise two to seven electrodes, or two to five electrodes.

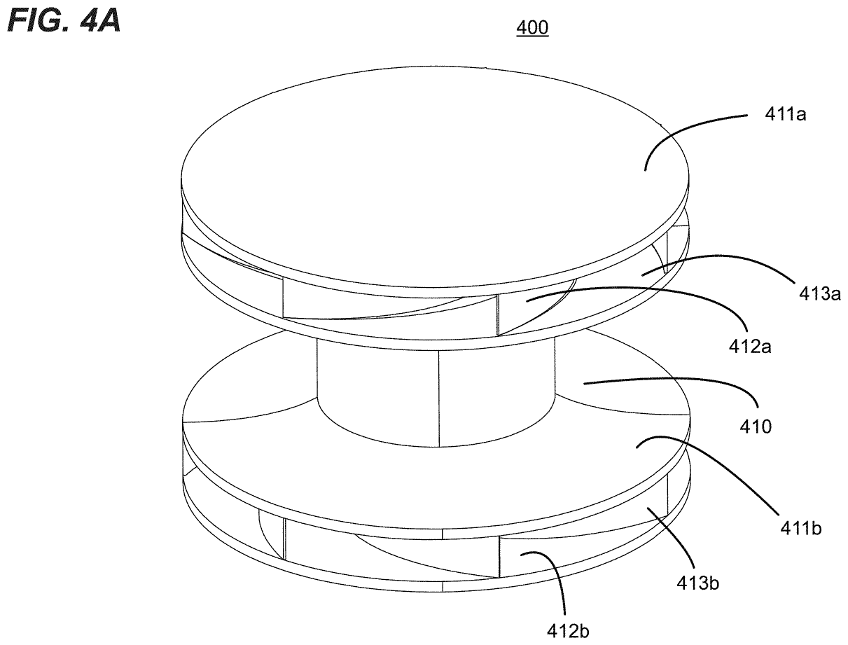

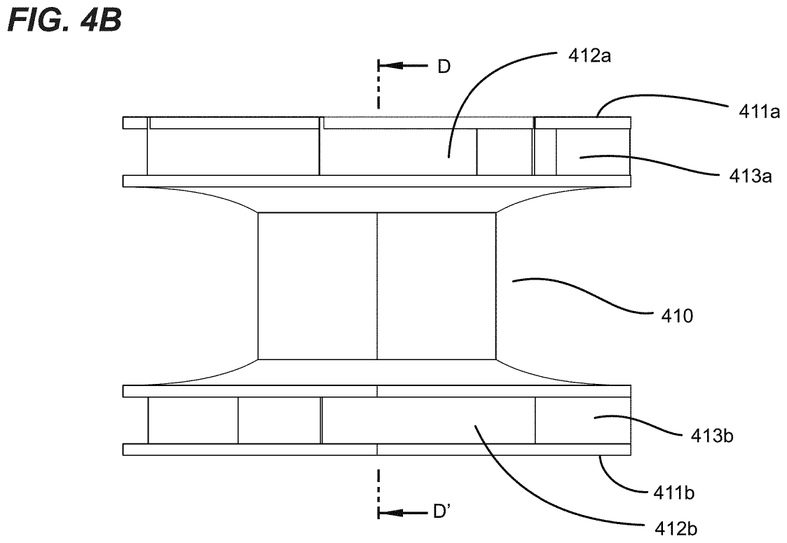

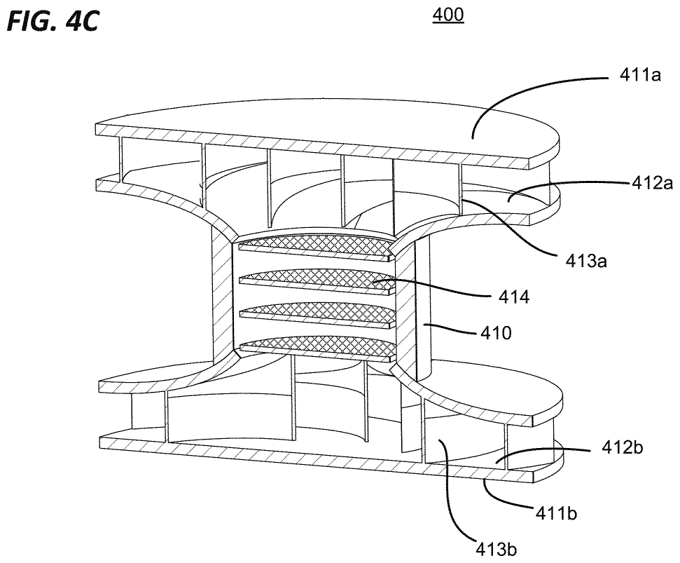

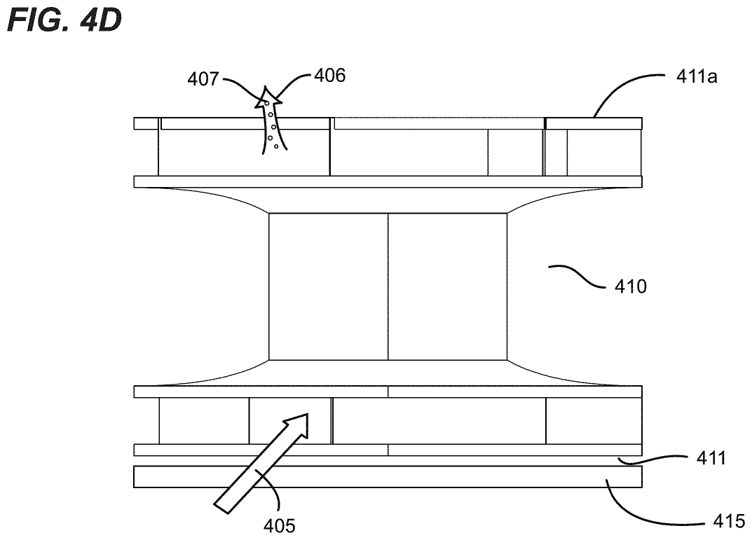

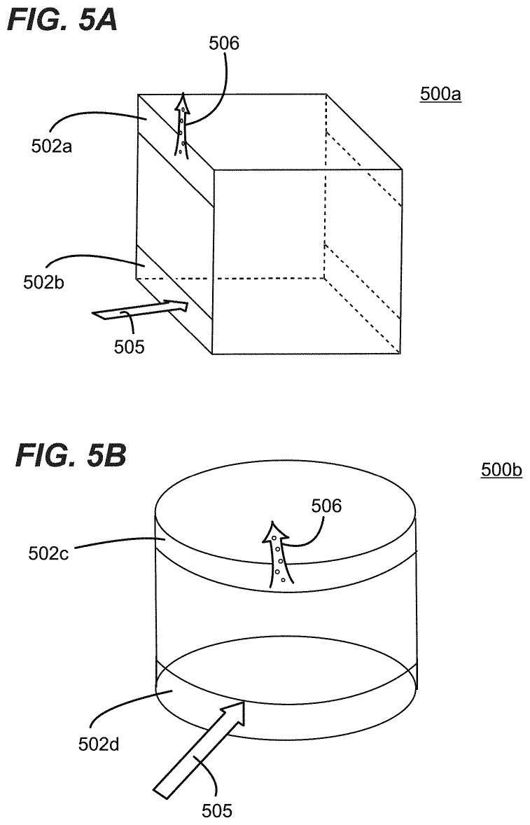

FIGS. 4-5 depict a bubble-generating reactor (BGR) of the second embodiment, which may be referred to as a “submersible” or “submerged” BGR.

FIGS. 4A-4C depict various views of a submersible BGR 400. The submersible BGR 400 comprises a plenum comprised of an upper part 411a, a middle part 410, and a lower part 411b. The upper part 411a and lower part 411b may be substantially cylindrical. Each of the upper part 411a and the lower part 411b comprise a plurality of vents (e.g., 412a and 412b). Each of the upper part 411a and the lower part 411b comprise a plurality of vanes (e.g., 413a and 413b). As seen from FIG. 4B, the upper part 411a, a middle part 410, and a lower part 411b of the submersible BGR 400 has a generally continuous hyperbolic surface.

The middle part 410 may be substantially cylindrical, where said middle part 410 comprises from two to ten electrodes 414 each capable of receiving an electrical current. It is contemplated that current may be supplied to each of the electrodes by an external electrical source. Alternatively, it is contemplated that current may be supplied to each of the electrodes by an inductively coupled charger (e.g., by resonant inductive coupling).

In one aspect, the amperage delivered to each electrode ranges from about 1 A to about 100 A (and all values in between). Thus, one may contemplate amperages of about 1 A to about 5 A, and the like, e.g., about 5 A to about 10 A, about 10 A to about 20 A, about 30 A to about 40 A, about 40 A to about 50 A, about 50 A to about 60 A, about 60 A to about 70 A, about 70 A to about 80 A, about 80 A to about 90 A, and about 90 A to about 100 A.

FIG. 4C represents a cross-sectional view of the third BGR of FIG. 4A along plane D-D′ shown in FIG. 4B. Therein, it may be seen that the lower part is comprised of a vent that comprises a vane (e.g., a circular vane) that permits flow of a liquid medium from a reservoir into the plenum cavity to contact the electrodes 414. As shown, the electrodes comprise a meshed material. However, it will be appreciated that the electrodes may be a solid optionally comprising an aperture, a perforated solid, a mesh material, or a porous material. Flow of a liquid medium into the plenum cavity permits contact with the electrodes disposed therein. FIG. 4D represents a side plan view of the third BGR of FIG. 4A in operation. For instance, activation of the inductively coupled charger 415 results in the generation of a current to one or more electrodes in the submerged BGR 400. The liquid medium 405 present in the submerged BGR 400 results in the formation of the liquid agent medium 406 comprising a redox-produced agent (e.g., an agent produced by an oxidation-reduction reaction), which includes bubbles 407. It may be appreciated that conversion of a liquid medium 405 to a liquid agent medium 406 may not occur completely after first passage of the liquid medium 405 through the electrode array. Accordingly, a certain amount of liquid medium 405 may escape from the ECR upper vent (e.g., 412a). An attractive feature of the ECRs disclosed herein results in the constant contact with the medium of a given system, such that unreacted liquid medium 405 may be further reacted to form liquid agent medium 406 by recirculation through the ECR.

FIGS. 5A-5B show alternative designs of the submersible BGR without showing electrodes disposed therein. For instance, FIG. 5A shows a submersible BGR 500a that is substantially cuboidal, while FIG. 5B shows a submersible BGR that is substantially cylindrical 500b. In addition to the substantially cuboidal and cylindrical shapes, other configurations may be contemplated, including, for example, a conical frustum, a square frustum, a pentagonal frustum, a hexagonal frustum, a rectangular cuboid, and the like. The submersible BGR 500a depicted in FIG. 5A comprises four vents including a top vent 502a (on opposing sides) and a bottom vent 502b (on opposing sides). It is contemplated that the submersible BGR 500a may have up to eight vents, or more depending on the shape and/or configuration of the submersible BGR. The submersible BGRs, e.g., 500a and 500b, may optionally comprise one or more vane like structures to facilitate water flow from a lower vent to an upper vent. Alternatively, the submersible BGRs, e.g., 500a and 500b, may include a top surface that comprises one or more apertures.

A third embodiment relates to a bubble-generating reactor that also generates a vortex (hereafter vortex-generating reactor (or VGR)) comprising: an upper part comprised of a top plate, a cover base plate having an opening disposed therein, and a plurality of upper vanes disposed between the top plate and the cover base plate, where the plurality of upper vanes have an arrangement around the periphery of the cover base plate opening thereby forming a plurality of upper vents; a middle part comprised of a plurality of electrodes and disposed between the electrodes a plurality of electrode plates each electrode plate comprising an electrode-shaped recessed area having an opening disposed therein, where each electrode is capable of receiving an electrical current and each electrode comprises a plurality of openings; and a lower part comprised of a top cover plate having an opening disposed therein, a base plate, and a plurality of lower vanes disposed between the top cover plate and the base plate, where the plurality of lower vanes has an arrangement around the periphery of the base plate opening thereby forming a plurality of lower vents; wherein the upper, middle, and lower parts are secured together such that the openings of each of the cover base plate, the electrode plates, and the top cover plate form a substantially continuous opening permitting fluid flow through each of the parts; and wherein said vortex-generating reactor may be submerged within a reservoir containing a liquid medium.

FIGS. 8A-8C depict a vortex-generating reactor (VGR) of the third embodiment, which may be referred to as a “submersible” or “submerged” VGR.

FIGS. 8A-8C depict various views of a submersible VGR 800 of the third embodiment. The submersible VGR 800 comprises an upper part 801a, a middle part 801b, and a lower part 801c. The upper part 801a comprises a top plate 802, a cover base plate 803 having an opening 810 disposed therein, and a plurality of upper vanes 804 disposed between the top plate 802 and the cover base plate 803, where the plurality of upper vanes have an arrangement around the periphery of the cover base plate opening thereby forming a plurality of upper vents between the upper vanes 804, which may be manufactured using a suitable injection mold system.

The submersible VGR 800 comprises a middle part 801b comprised of a plurality of electrodes 811 and disposed between the electrodes a plurality of electrode plates 809 each electrode plate comprising an electrode-shaped recessed area 812 having an opening 813 disposed therein.

The submersible VGR 800 comprises a lower part 801c comprised of a top cover plate 805 having an opening 808 disposed therein, a base plate 806, and a plurality of lower vanes 807 disposed between the top cover plate and the base plate, where the plurality of lower vanes 807 has an arrangement around the periphery of the base plate opening 808 thereby forming a plurality of lower vents.

With reference to the submersible VGR 800, it may be appreciated that the upper vanes 804 may an integral part of the top plate 802, while the lower vanes 807 may be an integral part of the base plate 806. For instance, a solid material may be machined to form the vanes as an integral part of the plate. Alternatively, the vanes may be adhered (or welded) to the plate in any suitable configuration thereby permitting the formation of vents. In one aspect, the system may be manufactured by injection molding. With reference to the exploded view (e.g., FIG. 8B) of the submersible VGR 800, it may be seen that there are twelve lower vanes 807 situated on the base plate 806 with an approximate angle of separation of about 30° between each vane. With reference to FIG. 8C, it may be seen that there are twelve upper vanes 804 situated on the top plate 802 with an approximate angle of separation of about 30° between each vane. Also with reference to the vanes of the submersible VGR 800, it may be appreciated that the vanes (e.g., 804 and/or 807) may have generally the shape of a circular arc. One may appreciate that the vanes may have generally the shape of a semi-circle or may be without curvature.

In view of the foregoing, the VGR 800 may comprise a variable number of upper and lower vanes, such as six to twelve upper vanes and six to twelve lower vanes.

The upper 801a, middle 801b, and lower 801c parts may be secured (or fastened) together such that the openings of each of the cover base plate 810, the electrode plates 813, and the top cover plate 808 form a substantially continuous opening permitting fluid flow through each of the parts; and wherein said VGR may be submerged within a reservoir containing a liquid medium. As shown in FIG. 8A, each of the parts comprise aligned openings (viz., 816a, 816b, 816c) that accommodate a fastener for securing the plates together, said fastener may include a nut-tightened all thread rod, a nut-tightened hex bolt, a nut-tightened machine screw, a cable tie, and the like so that once secured (or fastened) the cover base plate, electrode plates, and top cover plate are substantially sealed such that fluid flow may be limited through lower vents, openings (viz., 808, 813, and 810), and upper vents. It may be appreciated that the fasteners may be comprised of a chemically resistant material described herein, including, e.g., Teflon, ABS, PEEK, PVC, titanium, and the like.

The submersible VGR 800 comprises a plurality of electrodes each having plurality of openings, as described herein. The adjacent inter-electrode distance for the submersible VGR 800 ranges from about 0.5 mm to about 5 mm, and all values in between, such as for example, about 0.6 mm, about 0.7 mm, about 0.8 mm, about 0.9 mm, about 1 mm, about 1.2 mm, about 1.3 mm, about 1.4 mm, about 1.5 mm, about 1.6 mm, about 1.7 mm, about 1.8 mm, about 1.9 mm, about 2 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm . . . , and about 4.9 mm.

It may be appreciated that an electrode having a plurality of openings refers generally to an electrode comprising apertures, a perforated solid, a mesh material, or a porous material. It may be appreciated that the plurality of electrodes of the VGR 800 comprise at least one anodic electrode and at least one cathodic electrode, wherein each electrode comprises regularly (or irregularly) spaced apertures. The VGR 800, as shown, comprises four electrodes, two of which may be anodic electrodes and the other two may be cathodic electrodes. In an alternative embodiment, the submersible VGR 800 may comprise two to ten electrodes. As stated above, one may envision theoretically that the number of electrodes may be increased to eleven or more. In practice, however, the maximum number of electrodes may be governed by the void coefficient of reactivity due to, for example, the generated bubbles. Accordingly, a submersible VGR 800 contemplated herein comprises two to eight electrodes, or four to eight electrodes.

With reference to FIG. 8B, it may be appreciated that the submersible VGR 800 comprises electrode plates 809 including an electrode-shaped recessed area 812 having an opening 813 disposed therein whereby the electrode may be seated within the recessed area 812. Once seated within the recessed area, the electrode 811 and electrode plate 809 form a substantially planar surface whereby the plurality of faces of each electrode are substantially parallel to each other. One may appreciate that the depth of the recessed area 812 may be at least the thickness of the electrode 811. With this configuration, the adjacent electrode plates of the middle part 801b form a substantially sealed arrangement such that fluid flow may be limited through lower vents, openings (viz., 808, 813, and 810), and upper vents. In one aspect, the electrode 811 thickness may be about 1 mm, which may be accommodated by a recessed area depth of about 1 mm. With an electrode plate 809 thickness of about 3 mm, it may be appreciated that the inter-planar electrode-to-electrode distance may be about 2 mm. Further, with an electrode plate 809 thickness of about 2 mm, it may be appreciated that the inter-planar electrode-to-electrode distance may be about 1 mm. It will be appreciated that the inter-planar electrode-to-electrode distance may depend on the electrode thickness, as well as the concentration of the at least one redox active reagent in the liquid medium. The inter-planar electrode-to-electrode distance may be configured to prevent arcing between the electrodes. For instance, in certain instances, a voltage of about 5 V may result in an arc between the electrodes.

Electrodes contemplated herein include an upper face, a lower face, and at least one edge, where the electrode faces comprise regularly (or irregularly) spaced apertures and electrode connector 814 forms a part of the at least one electrode edge. The electrode faces, e.g., determined by the length and width of an electrode, have an area that ranges from about 900 mm² to about 90,000 mm² and all values in between, for example, about 1000 mm², about 1500 mm², about 2000 mm², about 2500 mm², about 3000, . . . 90,000 mm². It will be appreciated that each electrode comprises regularly (or irregularly) spaced apertures, and thus, the area of the electrode face refers generally to the electrode shape, and does not account for the overall (or total) surface area when one contemplates the regularly (or irregularly) spaced apertures. Accordingly, each electrode 811 of the VGR 800 (see FIG. 8H) has a plurality of openings and an area of about 7056 mm² (e.g., each edge having a length of 84 mm). Electrodes having smaller (e.g., about 900 mm²) and larger (e.g., about 90,000 mm²) areas may be accommodated by a suitably sized submersible VGR 800. Many electrode shapes (e.g., square, rectangular, circular, elliptical, etc.) may be utilized with the submersible VGR 800. For practical considerations, one may elect a shape that minimizes waste, such as an electrode having sides of about 150 mm×150 mm or about 300 mm× about 300 mm. As explained above, it may be appreciated, however, that the total surface area for a single electrode may range from about 2,000 mm² to about 350,000 mm² and the total surface area of all of the electrodes may range from about 4,000 mm² to about 350,000,000 mm².

The submersible VGR 800 may further comprise a plurality of electrode connectors 814 set in an external recessed area 815 formed by the cover base plate 803, electrode plates 809, and top cover plate 805.

It is contemplated that current may be supplied to each of the electrodes 811/electrode connectors 814 by a power supply. Alternatively, it is contemplated that current may be supplied to each of the electrodes by an inductively coupled charger (e.g., by resonant inductive coupling).

In one aspect, the amperage delivered to each electrode ranges from about 1 A to about 100 A (and all values in between). Thus, one may contemplate amperages of about 1 A to about 5 A, and the like, as explained herein. It may be appreciated that the electrode design permits automatic removal of electrochemical deposition, if present, by reversing the polarity to the respective electrodes.

The submersible VGR 800 may be utilized in a reservoir described herein whereby the VGR 800 may be positioned at the bottommost surface of the reservoir. Alternatively, the submersible VGR 800 may be positioned in other areas of the reservoir. The positioning may occur due to the weight of the submersible VGR 800 or due to presence of an external weight. In one embodiment, the submersible VGR 800 may be fastened to the reservoir directly or indirectly.

FIGS. 8D-8H provide various views of the submersible VGR 800 and the fastening arrangement. The fastening arrangement comprises a riser object 822, a fastening plate 823 (optionally comprising an opening disposed on the surface thereof), an upper coupling member 821a and a lower coupling member 821b.

As shown, the riser object 822 may have a cylindrical cross-section, but other cross-sectional arrangements may be contemplated, such as square, rectangular, elliptical, and the like. The terminus of the riser object 822 may comprise a threaded portion (e.g., NPT male threads).

The riser object 822 having a threaded portion may be coupled to the coupling members (viz., 821a and 821b) via complementary a thread portion (e.g., NPT female threads).

Alternatively, the terminus of the riser object 822 may comprise a smooth portion. The riser object 822 having a smooth portion may be coupled to the coupling members (viz., 821a and 821b) using a suitable adhesive.

One may appreciate that the rising object 822 may be a PVC pipe coupled to a half-coupling NPT (e.g., 821a and 821b), which may be secured (e.g., welded, adhered, etc.) to the upper part top plate 802, as well as the lower part of the fastening plate 823.

As shown in FIGS. 8G-8H, the rising object 822 may comprise a plurality of wires (e.g., 826a and 826b) that may exit an opening of the rising object and that may be fastened to electrode connectors 814 set in an external recessed area 815 formed by the cover base plate 803, electrode plates 809, and top cover plate 805. In this regard, the submersible BGR 800 may comprise an insert 827 complimentary to the external recessed area 815. In practice, the wires (e.g., 826a and 826b) may be connected to the electrode connectors 814 within the confines of the insert 827, which may be filled with a suitable material that may protect the wire 826 from a chemically corrosive liquid agent medium. The wires (e.g., 826a and 826b) may be separate, as shown in FIG. 8H, or may be encased in a chemically resistant covering.

In practice, the application of a suitable electrical current to the VGR 800 submerged in a liquid medium (FIG. 8H) and at least one redox active reagent results in the formation of a liquid agent medium comprised of a redox-produced agent. The liquid medium may be any one of the liquid media obtained from any one of liquid media concentrates, each described herein. As shown in FIG. 8H, ingress of liquid medium 828 into the lower vents results in the contact of liquid medium with electrified electrodes 811, which results in the formation of a liquid agent medium comprising bubbles 828′. The so-formed liquid agent medium and bubbles escape the VGR 800 by way of the upper vents 828′. The bubbles may be released from the reservoir 824 by way of one or more vents. One may appreciate that an attractive feature of the VGR 800 is that the VGR creates a counter-clockwise current that may generate a vortex, which when coupled with the release of bubbles into the reservoir facilitates mixing of the reservoir liquid, thereby creating a homogenously mixed solution, and thus, minimizing and/or eliminating the need for an external stirring device. With homogeneous mixing, one may appreciate that a continued application of a suitable electrical current to the VGR 800 that results in the formation of the liquid agent medium 828′ may be recycled through the VGR 800 vent system as a mixture of liquid medium and liquid agent medium 828/828′.

A fourth embodiment relates to an internal-external (“NE”) reactor (or collectively an “NER”) comprising a plurality of electrodes and a mounting plate.

As seen from FIGS. 9A-9B, an NE reactor 900 comprises a mounting plate 901; optionally having a sealing member 905, and a plurality of fastener openings 902, a plurality of electrodes 904 having a plurality of electrode connectors 903, and optionally, at least one dampener 906 attached to the plurality of electrodes; wherein the plurality of electrodes are substantially parallel to each other; and wherein each electrode is substantially perpendicular to an inner face of the mounting plate, or if present, each electrode is substantially perpendicular to the sealing member.

As seen from FIGS. 9A-9B, the mounting plate 901 has an external face and an internal face. The electrode connectors 903 may be accessible from the external face of the mounting plate 901. An electrode edge comprising the electrode connector 903 may abut against the internal face of the mounting plate 901. If present, an electrode edge comprising the electrode connector 814 may abut against the internal face a sealing member 905. The sealing member 905 may be an integral part of the mounting plate 901. Alternatively, the sealing member may be a gasket or other material (e.g., sealant material, caulking material, and the like) that may be applied to the in inner face of the mounting plate.

It may be appreciated that the plurality of electrodes may be separated from each other by a distance that ranges from about 0.5 mm to about 5 mm, and all values in between, such as for example, about 0.6 mm, about 0.7 mm, about 0.8 mm, about 0.9 mm, about 1 mm, about 1.2 mm, about 1.3 mm, about 1.4 mm, about 1.5 mm, about 1.6 mm, about 1.7 mm, about 1.8 mm, about 1.9 mm, about 2 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm..., and about 4.9 mm.

As seen from FIGS. 9A-9B, the NER may comprise five electrodes. Contemplated herein is an NER that comprises two to ten electrodes and all numbers in between, including for example, three electrodes, four electrodes, six electrodes, seven electrodes, eight electrodes, and nine electrodes.

The mounting plate 901 may be manufactured using a three-dimensional printer or by a suitable injection molding process.

The submersible NE reactor 900 comprises a plurality of electrodes each having plurality of openings, as described herein. It may be appreciated that an electrode having a plurality of openings refers generally to an electrode comprising apertures, a perforated solid, a mesh material, or a porous material. It may be appreciated that the plurality of electrodes of the NE reactor 900 comprise at least one anodic electrode and at least one cathodic electrode, wherein each electrode comprises regularly spaced apertures. The NE reactor 900, as shown, comprises five electrodes, two of which may be anodic electrodes and two of which may be cathodic electrodes, while the fifth electrodes may be anodic or cathodic. It may be appreciated that an electrochemical by-product may be deposited on the surface of the electrode. One may remove the electrochemically deposited by-product by reversing the polarity of the electrodes.

In an alternative embodiment, the NER 900 may comprise two to ten electrodes. As stated above, one may envision theoretically that the number of electrodes may be increased to eleven or more. In practice, however, the maximum number of electrodes may be governed by the void coefficient of reactivity due to, for example, the generated bubbles. Accordingly, a submersible NER 900 contemplated herein comprises two to eight electrodes, or four to eight electrodes.

The NER electrodes 904 contemplated herein include an upper face, a lower face, and at least one edge, where the electrode faces comprise regularly (or irregularly) spaced apertures and the electrode connector 903 forms a part of the at least one electrode edge. As seen from FIG. 9B, one electrode edge comprising the electrode connector 903 abuts against either the inner face of the mounting plate 901 or abuts against the sealing member 905. The electrode faces have an area that ranges from about 900 mm² to about 90,000 mm² and all values in between, for example, about 1000 mm², about 1500 mm², about 2000 mm², about 2500 mm², about 3000 mm², . . . 90,000 mm² with electrode edges having distances of about 30 mm to about 300 mm It will be appreciated that each electrode comprises regularly (or irregularly) spaced apertures, and thus, the area of the electrode face refers generally to the electrode shape, and does not account for the overall surface area when one contemplates the regularly (or irregularly) spaced apertures. Accordingly, each electrode 904 of the NE reactor 900 (see FIG. 9B) has a plurality of openings and an electrode face area of about 7056 mm² (e.g., each edge having a length of 84 mm). As explained above, it may be appreciated, however, that the total surface area for a single electrode may range from about 2,000 mm² to about 350,000 mm² and the total surface area of all of the electrodes may range from about 4,000 mm² to about 350,000,000 mm².

The NE reactor inter-electrode distance of an adjacent electrode ranges from about 0.5 mm to about 5 mm, and all values in between, such as for example, about 0.6 mm, about 0.7 mm, about 0.8 mm, about 0.9 mm, about 1 mm, about 1.2 mm, about 1.3 mm, about 1.4 mm, about 1.5 mm, about 1.6 mm, about 1.7 mm, about 1.8 mm, about 1.9 mm, about 2 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm . . . , and about 4.9 mm.

As explained herein, the plurality of electrodes may be configured to be completely submerged in a liquid medium. In practice, application of a constant current to the plurality of electrodes when submerged in a liquid medium results in the formation of a liquid agent medium and bubbles. The generated bubbles seeking to escape the liquid medium may result in an electrode translational motion, which may result in a shortage if the electrodes contact one another. Accordingly, the NE Reactor comprises at least one dampener (e.g., 906), which may be suitably configured to minimize (or prevent) bubble-generated electrode translational motion. As shown in FIG. 9B, the dampener comprises an outward part and an inward part having a number of projections mateable with the separated electrodes. It may be appreciated that the distance between each projection may be substantially the same as the thickness of each electrodes. As shown in FIG. 9B, the dampener 906 may be situated at an electrode edge furthest removed from the mounting plate 901, or optionally, the sealing member 905. Alternatively, the dampener 906 may be situated at an electrode edge sufficient to prevent bubble-generated electrode translational motion. Further, in certain instances the electrode the NE reactor 900 may comprise one or more additional dampeners 906 located at various locations around the periphery of the electrodes, which may be useful for an NE reactor having electrodes with larger dimensions.

As shown herein (e.g., FIG. 10C), the NE reactor 900 may be fixed to a suitable reservoir system (e.g., 1000). Alternatively, it may be possible to join two NE reactors in a back-to-back configuration where the mounting plate 901 a first NE reactor is substantially parallel and separated by a suitable distance from the mounting plate 901 of a second NE reactor 900.

A fifth embodiment relates to an internal-submersible (“IS”) reactor (or collectively as “ISR”) comprising: a plurality of substantially parallel electrodes spatially separated by an electrode spacer and securedly attached to each other by a fastener; each electrode comprising an array of alternatively sized apertures and, wherein the array of alternatively sized apertures of alternating electrodes have the same or different orientations (e.g., mutually perpendicular), and wherein each electrode comprises an electrode connector.

As seen from FIGS. 9C-9E, an IS reactor 910 comprises a plurality of substantially parallel electrodes 911 spatially 917 separated by an electrode spacer 916 and securedly attached to each other by a suitable fastener 915; each electrode comprising an array of alternatively sized apertures 912 and 913, wherein the array of alternatively sized apertures of alternating electrodes have the same or different orientations (e.g., mutually perpendicular), and wherein each electrode comprises an electrode connector 914.

As seen from FIGS. 9C-9E, the IS reactor may comprise six electrodes. Contemplated herein is an IS reactor that comprises two to ten electrodes and all numbers in between, including for example, three electrodes, four electrodes, six electrodes, seven electrodes, eight electrodes, and nine electrodes.

It may be appreciated that the plurality of electrodes of the IS reactor 910 comprise at least one anodic electrode and at least one cathodic electrode. The IS reactor 910, as shown, comprises six electrodes, two of which may be anodic electrodes and two of which may be cathodic electrodes, whereby the fifth and sixth electrodes may be anodic or cathodic. It may be appreciated that an electrochemical by-product may be deposited on the surface of the electrode. One may remove the electrochemically deposited by-product by reversing the polarity of the electrodes.

As shown in FIGS. 9C-9E, each electrode of the IS reactor may approximate a square-like shape having comparable lengths and widths, e.g., about 30 mm× about 30 mm, about 150 mm× about 150 mm, or about 300 mm× about 300 mm, and a height of about 1/16″ (about 1.6 mm) to about ¼″ (about 6.4 mm), and all values in between, including for example about ⅛″ (about 3.2 mm). The electrodes may be in the form of other shapes, e.g., circular, triangular, or rectangular. For practical considerations, one may elect a shape that minimizes waste.

As explained herein, an ECR has a total surface area, wherein the total surface area for each electrode ranges from about 2,000 mm² to about 350,000 mm². Also as explained herein, the total ECR depends on the number of electrodes. The ISR 910 may have a total surface area of, for example, about 47,000 mm².

It may be appreciated that the plurality of electrodes 911 may be spatially 917 separated from each by an electrode spacer 916, whereby the inter-electrode distance of an adjacent electrode ranges from about 0.5 mm to about 5 mm, and all values in between, such as for example, about 0.6 mm, about 0.7 mm, about 0.8 mm, about 0.9 mm, about 1 mm, about 1.2 mm, about 1.3 mm, about 1.4 mm, about 1.5 mm, about 1.6 mm, about 1.7 mm, about 1.8 mm, about 1.9 mm, about 2 mm, about 2.1 mm, about 2.2 mm, about 2.3 mm, about 2.4 mm, about 2.5 mm, about 2.6 mm, about 2.7 mm, about 2.8 mm, about 2.9 mm..., and about 4.9 mm. It also may be appreciated that obtaining an inter-electrode distance between adjacent electrodes may be realized by using an electrode spacer 916 having a thickness corresponding approximately to the inter-electrode distance.

As shown in FIGS. 9C-9E, a fastener may comprise a suitably dimensioned nut-tightened all thread rod. Alternative fasters include, but are not limited to, a nut-tightened hex bolt, a nut-tightened machine screw, a cable tie, and the like so that once secured (or fastened) the plurality of electrodes may be maintained substantially fixed to one another. It may be appreciated that the spacers and the fasteners may be comprised of a chemically resistant material described herein, including, e.g., Teflon, ABS, PEEK, PVC, titanium, and the like.

As shown in FIGS. 9C-9E, each electrode of an IS reactor comprises an array of alternatively sized apertures 912 and 913. The apertures may be in the form of a slot, as shown, where a first aperture (e.g., 912) has a length c of about 10 mm, while a second aperture (e.g., 913) has a length d of about 20 mm. The array may comprise a third aperture (e.g., 918) that has an internal length of about 10 mm. The array of apertures comprises an alternative arrangement of first and second apertures. As shown in FIG. 9C, the IS reactor comprises four rows of first apertures 912 each row being separated by a row of second apertures 913, wherein the row of second apertures may comprise a third aperture 918. The aperture spacing may be selected to provide an adequate flow of liquid medium (“LM”) through the plurality of electrodes to produce liquid agent medium (“LAM”). The apertures may be separated from one another by a constant distance or a variable distance. In one aspect, a first inter-aperture distance (e.g., in the same row, e.g., a) may be a constant distance (e.g., about 7.5 mm). In another aspect, a second inter-aperture distance (e.g., apertures in a different row, e.g., b) may be about 7.5 mm. As shown, the electrical connector 914 has a length of about 15% of the length of the electrode 911. Contemplated herein for this embodiment, as well as all embodiments herein, are electrode connectors (e.g., 914) having a length of about 10% to about 50% of the length of the electrode (e.g., 911).

As seen in FIGS. 9D-9E, the array of alternatively sized apertures of alternating electrodes may be mutually perpendicular. For instance, reference is made to the cross-sectional view of the IS reactor depicted in FIG. 9C along line 9D, as shown in FIG. 9D. Therein, it may be appreciated that each of electrode 1 (“E1”), electrode 3 (“E3”), and electrode 5 (“E5”) comprise an array of apertures aligned in a first orientation, while it also may be appreciated that each of electrode 2 (“E2”), electrode 4 (“E4”), and electrode 6 (“E6”) comprise an array of apertures aligned in a second orientation. One may appreciate that the first and second orientations may be the same or different. Inspection of FIGS. 9D and 9E reveal that the first orientation of apertures may be orthogonal to the second orientation of apertures on an adjacent electrode. In one aspect, the first and second orientations may range from about 0° (the same orientation) to about 90° (orthogonal orientation), and all values in between. Alternatively, one may envision an arrangement whereby one electrode (e.g., E1) has a first orientation, a second electrode (e.g., E2) has a second orientation, and a third electrode (e.g., E3) has a third orientation, wherein each orientation is the same or different. For instance, the E1 aperture orientation may be aligned along an axis defined by opposing fasteners, where the E2, E3, E4, E5, E6 orientations may range from about 0° (the same orientation) to about 90° (orthogonal direction), and alternatively, for example, 30°, 45°, and 60°, and the like.

The differing alignment of alternating electrode apertures may facilitate the transport of liquid medium through the ECR (e.g., ISR) upon the application of a suitable current. This principle may be appreciated by recognizing that liquid medium (“LM”) may enter the ECR (e.g., ISR) by way of any opening available to water, e.g., a spatial separation 917 between the electrodes or by way of the top or bottom of the IS reactor. As depicted in FIG. 9D, for example, LM may enter the IS reactor “cavity” by a suitable opening, an upon application of a suitable current, a liquid active medium (“LAM”) may be formed. As a point of reference, a liquid active medium may also be referred to as a mixed oxidant solution. The application of current generates bubbles comprising gaseous agents and the differing alignment of alternating electrode apertures provide for a multi-directional liquid flow. A potential flow path distance 919 for the flow of the liquid medium (“LM”) through the array of electrodes represents an example of a flow path distance contemplated herein. With the application of a constant current, the LM in contact with an electrode may react to form bubbles, which may create a local mixing effect. As the liquid medium comprises water, the process of mixing may be considered self-controlling because the liquid medium seeks to fill the void created by generated bubbles.

B. Liquid Media

Liquid media described herein relate generally to pre-sanitizing, pre-disinfecting, and pre-cleaning media, as well as sanitizing, disinfecting, and cleaning media. Generally, a liquid active medium (or “LAM”) may be obtained from a liquid medium (or “LM”) using an ECR and a process described herein.

The liquid medium may comprise water and at least one redox active reagent. The expression “redox active reagent” refers to a chemical compound that may be capable of undergoing either reduction when contacted with the cathode or oxidation when contacted with the anode.

In one embodiment, the liquid medium may comprise water, at least one redox active reagent, and an adjuvant selected from a surfactant, an acid, or a combination thereof.

The water may be common tap water or a purified water, e.g., a deionized water obtained by distillation (e.g., distilled water) and/or reverse osmosis. In one aspect, the at least one redox active reagent comprises a Group 1 metal halide (e.g., sodium chloride, potassium chloride, sodium bromide, potassium bromide, sodium iodide, potassium iodide, and the like). In another aspect, the at least one redox active reagent comprises a purified Group 1 metal chloride having a purity of at least 99.9% by mass, 99.99% by mass, or 99.999% by mass.

In one aspect, the liquid medium further comprises an acid and/or a surfactant. Examples of an acid include, but are not limited to, acetic acid, benzoic acid, boric acid, butyric acid, citric acid, chlorosulfonic acid, cyanuric acid or a salt thereof (e.g., dichlor or trichlor), formic acid, hydrobromic acid, hydrochloric acid, hydroiodic acid, lactic acid, maleic acid, malic acid, malonic acid, nitric acid, oxalic acid, phosphoric acid, phthalic acid, propionic acid, salicylic acid, tartaric acid, trifluoroacetic acid, uric acid, or a combination thereof. Examples of a surfactant include, but are not limited to, docusate sodium, emulsifying wax, glyceryl monooleate, magnesium laureth sulfate, phospholipid, sodium dodecyl sulfate, sodium dodecylbenzenesulfonate, sodium laureth sulfate, sodium lauroyl sarcosinate, sodium lauryl sulfate, sodium myreth sulfate, sodium pareth sulfate, or a combination thereof.

In another aspect, the liquid medium may comprise water, a redox active reagent, and at least one clarifying agent.

In one aspect, the at least one redox active reagent comprises a Group 1 or Group 2 metal carbonate (e.g., sodium carbonate, potassium carbonate, magnesium carbonate, and the like) and at least one clarifying agent. In another aspect, the at least one redox active reagent comprises a purified Group 1 or Group 2 metal carbonate having a purity of at least 99.9% by mass, 99.99% by mass, or 99.999% by mass. Examples of at least one clarifying agent include, but are not limited to, alum, aluminum chlorohydrate, aluminum sulfate, boric acid, borax, calcium oxide, calcium hydroxide, ferrous sulfate, ferric chloride, ferric sulfate, polyacrylamide, polydiallyldimethylammonium chloride (polyDADMAC, sodium aluminate, sodium metaphosphate, sodium silicate, trisodium phosphate, or combinations thereof

For example, a liquid medium concentrate for a reservoir system comprises water and at least one redox active reagent comprising a Group 1 metal halide (e.g., a purified Group 1 metal halide) and optionally a surfactant. The concentrations of the Group 1 metal halide may be sufficient, when diluted, to produce a redox-produced agent, as described herein. For instance, a liquid medium concentrate may comprise a Group 1 metal halide in an amount that ranges from about 10% w/v to about 30% w/v, and all values in between, e.g., about 11% w/v, about 12% w/v, about 13% w/v, about 14% w/v, about 15% w/v, about 16% w/v, about 17% w/v, about 18% w/v, about 19% w/v, about 20% w/v, about 21% w/v, about 22% w/v, about 23% w/v, about 24% w/v, about 25% w/v, about 26% w/v, about 27% w/v , about 28% w/v, and about 29% w/v. A surfactant in the liquid medium concentrate may range in an amount that ranges from about 0.005% w/v to about 0.025% w/v and all values in between, such as, for example, about 0.01% w/v, about 0.015% w/v, and about 0.020% w/v.

Optionally, an adjuvant liquid supply reservoir comprising an adjuvant liquid medium concentrate (ALMC) comprises (i) water and (ii) an acid, a surfactant, or a combination thereof, as described herein. The amount of the acid (e.g., organic acid) in the ALMC may range from about 0.5% w/v to about 4.0% w/v and all values in between, e.g., about 0.6% w/v, about 0.7% w/v, about 0.8% w/v, about 0.9% w/v, about 1.0% w/v, about 1.1% w/v, about 1.2% w/v, about 1.3% w/v, about 1.4% w/v, about 1.5% w/v, about 1.6% w/v, about 1.7% w/v, about 1.8% w/v, about 1.9% w/v, about 2.0% w/v, about 2.1% w/v, about 2.2% w/v, about 2.3% w/v, about 2.4% w/v, about 2.5% w/v, about 2.6% w/v, about 2.7% w/v, about 2.8% w/v, about 2.9% w/v, about 3.0% w/v, about 3.1% w/v, about 3.2% w/v, about 3.3% w/v, about 3.4% w/v, about 3.5% w/v, about 3.6% w/v, about 3.7% w/v, about 3.8% w/v, and about 3.9% w/v.

Alternatively, the liquid medium concentrate may comprise, water, at least one redox active reagent comprising a Group 1 metal halide (e.g., a purified Group 1 metal halide), an organic acid, and optionally a surfactant. For instance, a Group 1 metal halide concentration in a liquid medium concentrate may range from about 10% w/v to about 30% w/v, and all values in between, e.g., about 11% w/v, about 12% w/v, about 13% w/v, about 14% w/v, about 15% w/v, about 16% w/v, about 17% w/v, about 18% w/v, about 19% w/v, about 20% w/v, about 21% w/v, about 22% w/v, about 23% w/v, about 24% w/v, about 25% w/v, about 26% w/v, about 2% w/v 7, about 28% w/v, and about 29% w/v. An organic acid in the liquid medium concentrate may range from about 0.5% w/v to about 4% w/v, and all values in between, e.g., about 0.6% w/v, about 0.7% w/v, about 0.8% w/v, about 0.9% w/v, about 1.0% w/v, about 1.1% w/v, about 1.2% w/v, about 1.3% w/v, about 1.4% w/v, about 1.5% w/v, about 1.6% w/v, about 1.7% w/v, about 1.8% w/v, about 1.9% w/v, about 2.0% w/v, about 2.1% w/v, about 2.2% w/v, about 2.3% w/v, about 2.4% w/v, about 2.5% w/v, about 2.6% w/v, about 2.7% w/v, about 2.8% w/v, about 2.9% w/v, about 3.0% w/v, about 3.1% w/v, about 3.2% w/v, about 3.3% w/v, about 3.4% w/v, about 3.5% w/v, about 3.6% w/v, about 3.7% w/v, about 3.8% w/v, and about 3.9% w/v. A surfactant in the liquid medium concentrate may range from about 0.005% w/v to about 0.025% w/v and all values in between, such as, for example, about 0.01% w/v, about 0.015% w/v, and about 0.020% w/v.

In one aspect, the a liquid medium may be obtained by adding a suitable amount of the liquid medium concentrate to water and/or a depleted liquid active medium (dLAM, infra) by a dilution factor (“DF”) of about 20 to about 50 and all values in between, such as, for example, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, and about 49. For example, about 3.3 fl. oz. (about 97 mL) of liquid medium concentrate may be combined with about 115.5 fl. oz. (about 3,416 mL, DF of about 36) to about 149 fl. oz. (4,406 mL, DF of about 46) of water, e.g., tap water, soft water, distilled water, deionized water, and the like, to obtain the liquid medium. Alternatively, about 16,9 fl. oz. (about 500 mL) of liquid medium concentrate may be combined with about 4 gal (about 512 fl. oz. or about 15,131 mL) to obtain the liquid medium by way of a dilution factor of about 31.

Examples of a Group 1 metal halide include, e.g., sodium chloride, potassium chloride, sodium bromide, potassium bromide, sodium iodide, potassium iodide, and the like. In one aspect, the at least one redox active reagent comprises a purified Group 1 metal chloride having a purity of at least 99.9% by mass, 99.99% by mass, or 99.999% by mass.

Examples of an organic acid include, but are not limited to, formic acid, acetic acid, propionic acid, butyric acid, citric acid, lactic acid, maleic acid, malic acid, malonic acid, oxalic acid, tartaric acid, trifluoroacetic acid, or a combination thereof.

Examples of a surfactant include, but are not limited to, docusate sodium, emulsifying wax, glyceryl monooleate, magnesium laureth sulfate, phospholipid, sodium dodecyl sulfate, sodium dodecylbenzenesulfonate, sodium laureth sulfate, sodium lauroyl sarcosinate, sodium lauryl sulfate, sodium myreth sulfate, sodium pareth sulfate, or a combination thereof.

By way of example, one may consider that a liquid medium concentrate comprises water (e.g., soft water, deionized water, distilled water, or water obtained by reverse-osmosis and/or deionization), a Group 1 metal halide (e.g., a purified sodium chloride) concentration from about 10% w/v to about 30% w/v, an acid (e.g., an organic acid, e.g., acetic acid) concentration from about 0.5% w/v to about 4.0% w/v, and optionally a surfactant (e.g., sodium laureth sulfate) concentration of from about 0.005% w/v to about 0.025% w/v.

Diluting the liquid medium concentrate in water (e.g., soft water, deionized water, distilled water, or water obtained by reverse-osmosis and/or deionization) by a factor of about 20 to about 50 to form a liquid medium comprising a Group 1 metal halide (e.g., a purified sodium chloride) concentration from about 0.2% w/v to about 1.5% w/v, an organic acid (e.g., acetic acid) concentration from about 0.01% w/v to about 0.2% w/v, and optionally a surfactant (e.g., sodium laureth sulfate) concentration of from about 0.0001% w/v to about 0.001% w/v. As explained herein, a liquid active medium, optionally comprising a surfactant, obtained from the first liquid medium concentrate using a process described herein may be used, for example, as a sanitizer, a continuous positive airway pressure (“CPAP”) cleanser, a produce (e.g., lettuce, blueberries, and the like) wash, an air sanitizer, a cab and car sanitizer, a skin and hand sanitizer, a first disinfectant, and a second disinfectant.

Alternatively, a liquid medium concentrate for an alternative reservoir system comprises water and at least one redox active reagent comprising a Group 1 or Group 2 metal carbonate (e.g., a purified Group 1 or Group 2 metal carbonate), a surfactant, and optionally a dye (e.g., a green dye) and at least one clarifying agent. The resultant product (e.g., liquid active medium) may be used as a degreaser for use on a variety of substrates and/or materials (e.g., a stovetop, a floor, an oven, a grill, a range hood, a refrigerator, and the like).

Further, a liquid medium concentrate for a further reservoir system comprises water and at least one redox active reagent comprising a Group 1 or Group 2 metal carbonate (e.g., a purified Group 1 or Group 2 metal carbonate), and optionally a dye (e.g., a blue dye) and at least one clarifying agent. The resultant product (e.g., liquid active medium) may be used as a general-purpose cleaner for use on a variety of substrates and/or materials (e.g., a countertop, a window, a mirror, and the like).

The amount of Group 1 or Group 2 metal carbonate in a reservoir may range from about 10% w/v to about 30% w/v, and all values in between, e.g., about 11% w/v, about 12% w/v, . . . about 19% w/v, about 20% w/v, . . . about 28% w/v, about 29% w/v.

The amount of at least one clarifying agent may range from about 0.5% w/v to about 5.0% w/v and all values in between, such as, for example, about 1.0% w/v, about 1.5% w/v, . . . about 3% w/v, about 3.5% w/v, about 4.0% w/v, and the like.

The amount of dye present in a reservoir may be present in an amount sufficient to impart a desired color to the liquid agent medium, such as, for example, an amount that ranges from about 0.0001% w/v to about 0.1% w/v, and all values in between, such as, for example, 0.001% w/v, 0.01% w/v, and the like.

One may determine the amount of Group 1 metal halide (e.g., sodium chloride) or Group ½ metal carbonate (e.g., potassium carbonate) in the liquid medium and the liquid medium concentrate based on the desired end-use. For instance, 10 g of sodium chloride in 1 L of water has the capacity, in theory, to produce up to about 6,100 ppm of Cl₂, but in practice, an amount of produced chlorine may generally range from about 1800 to about 3600 ppm.

C. Process for Preparing a Liquid Agent Medium

A sixth embodiment relates to a process for preparing a liquid agent medium, which comprises: contacting a liquid medium in a liquid medium reservoir comprising water and at least one redox active reagent with an electrochemical reactor running a first constant current of from about 1 A to about 100 A for a period of from about 5 min to about 360 min to obtain the liquid agent medium comprising water and the least one redox-produced agent comprising at least one oxidant having a concentration that ranges from about 200 ppm to about 3600 ppm; wherein the liquid medium has a pH of about 3.6 to about 6.8.

FIG. 11 references selected aspects of the process according to the sixth embodiment, where the following abbreviations/conditions are used: W (water), LMC (liquid medium concentrate), LM (liquid medium), GC (generating current), LAM (liquid active medium), t (time), dLAM (depleted liquid active medium), MC (maintenance current), MGC (modified generating current), ALMC (adjuvant liquid medium concentrate), a (end-user empties reservoir), b (reservoir contains sufficient “fuel,” infra), c (reservoir does not contain sufficient “fuel”), d (pH 6.8), and e (adjuvant salt content too high). With respect to FIG. 11, the process comprises contacting a liquid medium (LM) with any one of the ECRs (e.g., BGRs, VGRs, and NE reactor) described herein with a generating current (GC) to obtain liquid agent medium (LAM).

As explained herein, the liquid medium may comprise water and (i) a Group 1 metal halide, (ii) a Group 1 metal halide and an organic acid, (iii) a Group 1 metal halide, an organic acid, and a surfactant, (iv) a Group 1 metal carbonate, at least one clarifying agent, optionally a surfactant, and optionally a dye, or (v) a Group 2 metal carbonate, at least one clarifying agent, optionally a surfactant, and optionally a dye.

The process comprises obtaining the liquid medium (LM) by diluting the liquid medium concentrate (LMC) with water (W). For instance, diluting the liquid medium concentrate (LMC) in water (W) by a factor of about 20 to about 50 to form a liquid medium (LM) comprising a Group 1 metal halide (e.g., a purified sodium chloride) concentration from about 0.2% w/v to about 1.5% w/v, an acid (e.g., an organic acid, such as acetic acid) concentration from about 0.01% w/v to about 0.2% w/v, and optionally a surfactant (e.g., sodium laureth sulfate) concentration of from about 0.0001% w/v to about 0.001% w/v. In one aspect, the liquid medium having a pH of about 3.6 to about 6.8 comprises purified water, a purified sodium chloride in an amount of from about 0.4% w/v to about 1% w/v, acetic acid in an amount of about 0.02% w/v to about 0.05% w/v, and optionally sodium laureth sulfate in an amount of 0.0002% w/v to about 0.0005% w/v.

Accordingly, an aspect of the process of the sixth embodiment further comprises diluting a liquid medium concentrate with water by a factor of about 20 to about 50 to form a liquid medium.

A sufficient amount of generating current (GC) of about 1 A to about 100 A (e.g., about 60 A) applied to the reactor system for a suitable time period produces the liquid active medium (LAM). An end-user may dispense the contents of LAM into a suitable container, and if the end-user empties the reservoir contents, then a system described herein refills the reservoir and initiates the process for preparing another batch of LAM. In certain instances, the end-user may not empty the reservoir, thereby leaving LAM in the reservoir. Tests show that the half-life of the LAM mixed oxidant(s) may be from about 30 min to about 45 min thereby resulting in the formation of a depleted liquid active medium (dLAM). For instance, an initially prepared LAM may comprise a mixed oxidant(s) content of about 200 ppm, which may be reduced to 100 ppm after about 30 min to about 45 min. Accordingly, initial production of the liquid agent medium (LAM) may be followed by a maintenance production. In the instance where the dLAM has a sufficient amount of redox active reagent (e.g., NaCl or “fuel”) (see condition b of FIG. 11), then the process comprises introducing a maintenance current (MC, e.g., about 60 A) to the reactor(s) for a suitable time period, for example a time period of about 30 seconds to about 600 seconds, or for example about 300 second (or 5 minutes), where the maintenance current and time period depends on one or more factors, e.g., LM volume, temperature, amount of redox active reagent, and the like. One may use one more sensors to determine the maintenance current to be applied in this situation. Alternatively, a system may include a pre-set programmable feature that relies on an empirically determined dataset for a given reservoir system.

In an aspect of the sixth embodiment, the process further comprises applying a maintaining current (e.g., about 1 to about 100 A, e.g., about 60 A) for about 30 second to about 600 seconds after initial production of the liquid agent medium. As stated above, the maintaining current may be applied for a period (e.g., from about 30 min to about 90 min) after initial production of the liquid agent medium (LAM). In an alternative aspect of the sixth embodiment, the process further comprises applying a maintaining current (e.g., about 1 A to about 60 A) for a period of about 5 min to about 180 min. In yet another alternative aspect of the sixth embodiment, the process further comprises applying a maintaining current of about 60 A for a period of about 5 min.

In the instance where the dLAM does not have a sufficient amount of redox active reagent (e.g., NaCl or “fuel”) (see condition c of FIG. 11), then it may be desirable to add a sufficient amount of liquid medium concentrate (LMC) and apply a modified generating current (MGC) to the reactor(s) for a period of time sufficient to achieve the desired mixed oxidant(s) concentration (e.g., 200 ppm or 2000 ppm).

In one aspect, a process of the sixth embodiment further comprises determining a concentration of at least one oxidant, adding to the reservoir a liquid medium concentrate and optionally an adjuvant liquid medium concentrate, and applying a second constant current of from about 1 A to about 100 A for a period of from about 5 min to about 360 min. In yet another aspect, a process of the sixth embodiment further comprises comprising determining a concentration of at least one oxidant, adding to the reservoir a liquid medium and optionally an adjuvant liquid medium concentrate, and applying a second constant current of from about 1 A to about 60 A for a period of from about 5 min to about 10 min.

In an aspect of the sixth embodiment, the process further comprises adding a sufficient amount of liquid medium concentrate (LMC) and applying a modified generating current (MGC) to the reactor(s) for a time period sufficient to achieve the desired mixed oxidant(s) concentration (e.g., about 200 ppm, about 600 ppm, about 2000 ppm, or about 2200 ppm).

An advantage of the process is that the end-user may have continuous access to a ready supply of liquid active medium (e.g., a sanitizing or disinfecting solution) throughout the working day. Accordingly, the process described herein may be characterized as a semi-continuous batch process for preparing a suitable liquid active medium. This should be contrasted to previous systems where a brine solution is contacted with one or more electrodes on a single pass through a reactor cell using an externally driven pump.

In an aspect of the sixth embodiment, the liquid medium comprises water, a purified sodium chloride, an organic acid, and, optionally, a surfactant, wherein the pH of the liquid medium ranges from about 3.6 to about 6.8. One may appreciate that the application of a suitable amount of current results in the formation of a liquid agent medium comprising at least one redox-produced agent that comprises chlorine (Cl₂), hypochlorous acid (HOCl), chlorine dioxide (Cl₂O), among others. A by-product of the process may be the formation of sodium hydroxide, which may increase the pH of the medium. One will appreciate that the pKa of hypochlorous acid is about 7.5. Thus, maintaining the pH of the liquid medium serves to suppress the formation of sodium hypochlorite (e.g., bleach) from the so formed hypochlorous acid. With the application of a maintenance current (MC) and/or modified generating current (MGC), the pH of the liquid medium may increase with time. Accordingly, it may be necessary to add a liquid comprising a suitable amount of organic acid (e.g., water and acetic acid) to the medium to maintain the pH of the liquid agent medium from about 3.6 to about 6.8 and all values in between, such as about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, and about 6.7. In one aspect, the pH of the liquid medium ranges from about 5.5 to about 6.8.

Returning to FIG. 11, it may be seen that condition (d) may depend on the pH of the medium. For instance, if the medium pH is less than about 5.0, then no pH-adjustment may be necessary and the application of the maintenance current (MC) or modified generating current (MGC) may proceed to form LAM. As a point of reference, the amperages applied by the MC and the MGC may be the same or different. However, if the medium pH is more than about 6.8, then it may be desirable to add a sufficient amount of an adjuvant liquid medium concentrate (ALMC), which comprises water and an organic acid, such as, acetic acid, as explained above.

An aspect of the sixth embodiment further comprises adding an amount of adjuvant liquid medium concentrate to the medium to maintain the pH of the liquid medium and or the liquid agent medium from about 3.6 to about 6.8. The amount of organic acid in the adjuvant liquid medium concentrate may range from about 0.5% w/v to about 4.0% w/v and all values in between, such as, for example, about 0.6% w/v, about 0.7% w/v, about 0.8% w/v, about 0.9% w/v, about 1.0% w/v, about 1.5% w/v, . . . about 3% w/v, and about 3.5% w/v. The amount of added adjuvant liquid medium concentrate sufficient to maintain the pH of the liquid agent medium from about 3.6 to about 6.8 may be an amount consistent with the dilution factor identified herein.

Returning to FIG. 11, it may be seen that the medium may comprise a depleted liquid active medium (e.g., dLAM), whereby the amount of adjuvant salt content too high (see condition e). In that situation, it may be desirable to empty the contents of the reservoir, and refill with an amount of water (W) and liquid medium concentrate (LMC) to obtain a liquid medium (LM). One may appreciate that the adjuvant salt content may be measured using a suitable conductivity probe. Indeed, one may appreciate that a system adapted to perform the process of the sixth embodiment may comprise one or more sensors to detect water level, conductivity (e.g., salt content), pH, and the like. Alternatively, a system adapted to perform the process of the sixth embodiment may comprise a programming function that utilizes empirical data for evaluating one or more conditions of said process, e.g., b (reservoir contains sufficient “fuel,” infra), c (reservoir does not contain sufficient “fuel”), d (pH value), ALMC (adjuvant liquid medium concentrate), and e (adjuvant salt content too high).

An aspect of the sixth embodiment further comprises determining a concentration of at least one oxidant, adding to the reservoir a liquid medium concentrate and optionally an adjuvant liquid medium concentrate, and applying a second constant current of from about 1 A to about 100 A for a period of from about 5 min to about 360 min.

Another aspect of the sixth embodiment further comprises determining a concentration of at least one oxidant, adding to the reservoir a liquid medium and optionally an adjuvant liquid medium concentrate, and applying a second constant current of from about 1 A to about 60 A for a period of from about 5 min to about 10 min.

In one aspect of the sixth embodiment, a liquid medium reservoir has a volume capacity of about 500 mL to about 3800 L. In another aspect of the sixth embodiment, a liquid medium reservoir has a volume capacity of about 7.6 L (about 2 gal) to about 19 L (about 5 gal).

In an aspect of the sixth embodiment, the ECR system comprises any one the ECRs (e.g., BGRs, VGRs, NERs, and ISRs) described herein.

In an aspect of the sixth embodiment, the at least one redox active reagent comprises a Group I metal halide.

In an aspect of the sixth embodiment, the at least one redox active reagent comprises a purified Group I metal halide.

In an aspect of the sixth embodiment, the at least one redox active reagent comprises a purified sodium chloride and the redox-produce agent comprises at least one of ozone, hydrogen peroxide, chlorine, hypochlorous acid, and chlorine dioxide.

An aspect disclosed herein relates to a liquid agent medium (e.g., a sanitizing solution) obtained by a process of the sixth embodiment comprising water, an organic acid, a salt of the organic acid, or a combination thereof, a mixed oxidant, and optionally a surfactant, wherein the organic acid (e.g., an organic acid, e.g., acetic acid, salt, or combination thereof), concentration ranges from about 0.01% w/v to about 0.2% w/v, the surfactant (e.g., sodium laureth sulfate) concentration, if present, ranges from about 0.0001% w/v to about 0.001% w/v, and the mixed oxidant concentration ranges from about 100 ppm to about 300 ppm (e.g., about 200 ppm), and wherein pH of the liquid agent medium ranges from about 3.6 to about 6.8 and all values in between, such as about 3.7, about 3.8, about 3.9, about 4.0, about 4.1, about 4.2, about 4.3, about 4.4, about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, and about 6.7; in one aspect the pH of the liquid agent medium ranges from about 5.5 to about 6.8.

An aspect disclosed herein relates to a liquid agent medium (e.g., a disinfecting solution) obtained by a process of the sixth embodiment comprising water, an organic acid, a salt of the organic acid, or a combination thereof, a mixed oxidant, and optionally a surfactant, wherein the organic acid (e.g., acetic acid, salt, or combination thereof) concentration ranges from about 0.01% w/v to about 0.2% w/v, the surfactant (e.g., sodium laureth sulfate) concentration, if present, ranges from about 0.0001% w/v to about 0.001% w/v, and the mixed oxidant concentration ranges from about 200 ppm to about 3600 ppm. One may appreciate that an organic acid may react with a base (e.g., sodium hydroxide) to form a basic salt (e.g., sodium) of the organic acid. Accordingly, one may appreciate that the liquid active medium may comprise a basic salt of the organic acid.

Specific examples of liquid agent mediums having a pH of about 5.5 to about 6.8 obtained by the process disclosed herein, include, but are not limited to, a sanitizer (with a mixed oxidant concentration (“OC”) of about 800 to about 880 ppm), a continuous positive airway pressure (“CPAP”) cleanser (OC of about 670 ppm to about 750 ppm), a pet health product (OC of about 670 to about 750 ppm), a produce wash (OC of about 300 to about 350 ppm), an air sanitizer (OC of about 500 to about 550 ppm), a cab and car sanitizer (OC of about 670 to about 750 ppm), a skin and hand sanitizer (OC of about 500 to about 550 ppm), a first disinfectant (OC of about 1200 to about 1400 ppm), and a second disinfectant (OC of about 2200 to about 2400 ppm).

A liquid agent medium obtained by a process of the sixth embodiment may be held in a container (e.g., a liquid stand-up bag/pouch) having a volume that ranges from about 20 fl. oz. to about 256 fl. oz. and all values in between. The container may include a conveniently situated capped-spout, e.g., a screw-cap spout, and the container may comprise a material (e.g., aluminum or polymeric) that reduces light transmission. A container comprising a material that reduces light transmission and a screw-cap spout may include the liquid agent medium (e.g., sanitizing or disinfecting solution described herein) having a shelf-life of from about 2-months to about 24-months, and all values in between, for example, 3-months, 4-months, 5-months, 6-months, 7-months, 8-months, 9-months, 10-months, 11-months, 12-months, 13-months, 14-months, 15- months, 16-months, 17-months, 18-months, 19-months, 20-months, 21-months, 22-months, and 23-months. For instance, a container comprising the liquid agent medium and a capped spout maintains the mixed oxidant concentration ranges from about 100 ppm to about 300 ppm from about 2-months to about 24-months. Further, a container comprising the liquid agent medium and a capped spout maintains the mixed oxidant concentration at a range of from about 300 ppm to about 3600 ppm from about 2-months to about 24-months.

The application of the produced liquid agent medium comprising at least one of ozone, hydrogen peroxide, chlorine, hypochlorous acid, and chlorine dioxide permits sanitizing or disinfecting of a substrate, an object, and the like.

Contacting the liquid medium and at least one redox active reagent results in the formation of a liquid agent medium comprised of a redox-produced agent. For example, a liquid medium comprised of water and purified sodium chloride contacted for a determined time with an array of at least two electrodes (e.g., comprised of at least one anodic electrode and at least one cathodic electrode) having a current of from 1 A to about 100 A (and all values in between) results in the formation of a liquid agent medium comprised of water and a redox-produced agent, such as, for example, ozone (O₃), hydrogen peroxide (H₂O₂), chlorine (Cl₂), hypochlorous acid (HOCl), chlorine dioxide (ClO₂), and the like. The chemical processes that occur may be deduced by evaluating standard reduction potential tables, as disclosed in, e.g., Lange's Handbook and Douglas. The determined times depend on the applied current and the desired redox-produce agent(s). For example, contacting a liquid medium comprised of water and a Group I metal halide and any one the ECRs (e.g., BGRs, VGRs, NERs, and ISRs) described herein having a current of about 30 A for a time of about 1 minute to about 6 hours (and all times in between, such as, for example, about 2 min, about 5 min, about 10 min, about 20 min, about 30 min, and the like), depending on the volume of the liquid medium, would provide a liquid agent medium comprising water and a redox-produced agent comprised of ozone, hydrogen peroxide, chlorine, hypochlorous acid, and chlorine dioxide, or a combination thereof. One may appreciate that a liquid agent medium comprising water and one or more of ozone, hydrogen peroxide, chlorine, hypochlorous acid, and chlorine dioxide may be referred to as a mixed-oxidant solution (or MOS). The liquid agent medium may further comprise, for example, sodium chloride, acetic acid, sodium acetate, and optionally a surfactant.

D. Reservoirs and Reservoir Systems for preparing a Liquid Agent Medium

In view of the information disclosed herein, one may appreciate that the ECRs may be incorporated in a suitable reservoir system.

A seventh embodiment relates to a reservoir system comprises a reservoir and at least one ECR system described herein.

A reservoir system of the seventh embodiment comprises a fluid medium reservoir (FMR) comprising at least one ECR, optionally a fluid level sensor, and optionally the liquid medium, a liquid agent medium, or a combination thereof; a fluid dispenser (FD) fluidly connected to the FMR, said FD comprising a dispenser, a FD fluid conduit, a FD valve, and optionally an FD flow sensor; said reservoir system further comprising a water source; an electrical source; a controlled current supply; at least one sensor; at least one valve; a human machine interface display; a programmable logic controller comprising a processor, a power supply, and an input-output controller; optionally at least one communication device; optionally, a drain; optionally a liquid medium reservoir (LMR) fluidly connected to the FMR, said LMR comprising an LMR fluid conduit, an LMR pump, and optionally an LMR flow sensor and an LMR valve; optionally at least one liquid medium concentrate (LMC) reservoir system comprising an LMC reservoir, an LMC fluid conduit, an LMC pump, and optionally an LMC flow sensor and an LMC valve, wherein the LMC reservoir is fluidly connected to the FMR or to the LMR; and optionally an adjuvant liquid medium concentrate (ALMC) reservoir comprising an ALMC reservoir, an ALMC fluid conduit, and an ALMC pump, wherein the ALMC reservoir is fluidly connected to the FMR or to the LM.

As explained herein an advantage of the ECRs disclosed herein relates to the ability to generate a self-regulated flow, thereby forming a partially or fully homogeneous medium by virtue of the generated bubbles and the fluid velocity generated therefrom. This aspect may be realized in a fluid medium reservoir comprising a volume of liquid (VL, in mm³) and an ECR electrode array having a total surface area (TSA (in mm²), e.g., a sum of the individual electrode surface areas), where a ratio of VL to TSA (or VL-to-TSA ratio) ranges from about 100 mm to about 3000 mm, and all values in between, for example about 200 mm, about 300 mm, about 400 mm, about 500 mm, about 600 mm, about 700 mm, about 800 mm, about 900 mm, about 1000 mm, about 1100 mm, 1200 mm, about 1300 mm, about 1400 mm, about 1500 mm, about 1600 mm, about 1700 mm, about 1800 mm, about 1900 mm, about 2000 mm, about 2100 mm, 2200 mm, about 2300 mm, about 2400 mm, about 2500 mm, about 2600 mm, about 2700 mm, about 2800 mm, and about 2900 mm.

In one aspect a reservoir system is comprised of a fluid medium reservoir comprising at least one ECR disclosed herein, at least one water source, at least one source for a liquid medium concentrate, optionally at least one source for an adjuvant liquid medium concentrate, a human machine interface display, a programmable logic controller, optionally at least one communication device, at least one fluid conduit, at least one power supply, an electrical source, at least one sensor, and at least one valve. Additional aspects of a reservoir system may be gleaned from the information that follows.

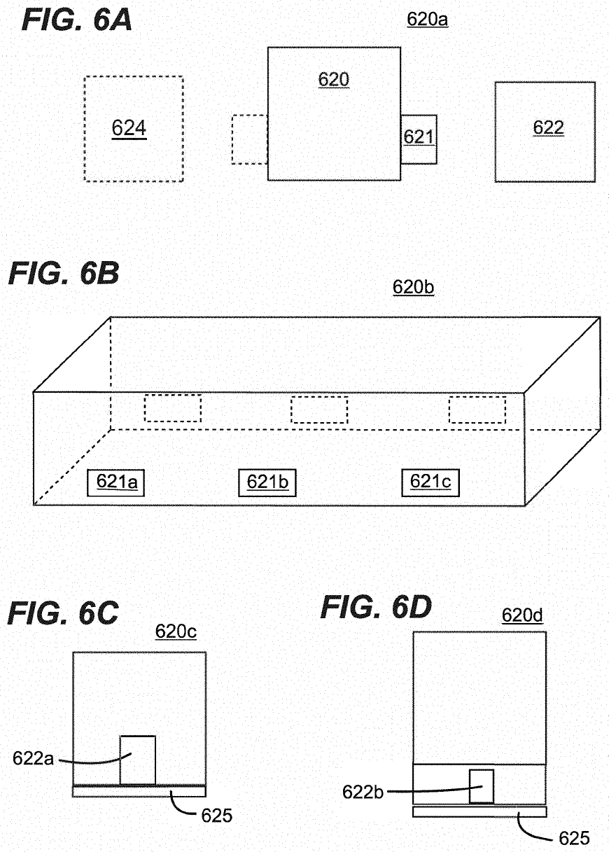

FIG. 6A illustrates an aspect of the seventh embodiment, which relates to a reservoir system 620a comprised of a reservoir 620 and an ECR 621 (e.g., a side-mounted ECR). One may appreciate that a submersible ECR may likewise be used in the reservoir system 620a. The reservoir may further comprise a liquid medium comprising water and at least one redox active reagent. Alternatively, the reservoir may further comprise a liquid agent medium comprising water and at least one redox-produced agent. FIG. 2D illustrates the operation of a side-mounted ECR upon application of an electrical current of from about 1 A to about 100 A, and all values in between, as stated herein). Ingress of liquid medium into the bottom vent 202b results in the contact of liquid medium with electrodes 203 having a current of from 1 A to about 100 A (and all values in between, as stated herein), which results in the formation of a liquid agent medium 206 comprising bubbles 207. One may appreciate that an attractive feature of the ECR (e.g., BGR) is that the release of bubbles into the reservoir facilitates mixing of the reservoir liquid, thereby creating a homogenously mixed solution, and thus, minimizing and/or eliminating the need for an external stirring device.

Referring back to FIG. 6A, which depicts a reservoir system comprising a reservoir 620 and a side-mounted ECR 621, it may be seen that the system may further comprise a supply reservoir 622, which may comprise a liquid medium concentrate comprised of water and a Group I metal halide or of water and a Group I or Group II metal carbonate. The tank volume may be, for example, from about 4 L to about 38 L (e.g., from about 1 to about 10 gallons) and all volume amounts in between, e.g., about 13.2 L (about 3.5 gal) or about 19 L (about 5 gal). Optionally, the reservoir system may comprise a second BGR (see left side of reservoir 620), and may further comprise a reservoir 624 that comprises an adjuvant liquid comprising water and at least one of an acid and/or a surfactant. An attractive feature of the BGR is that the release of bubbles into the reservoir serves to create a homogenously mixed solution thereby minimizing and/or eliminating the need for an external stirring device. The escaping bubbles from the top (or upper) vent creates a current whereby liquid medium enters through the bottom (or lower) vent.

Not shown in FIG. 6A are one or more implements that may facilitate introduction of water, e.g., from a municipal water supply; one or more water purification systems, one or more valves (e.g., a ball-valve or a solenoid valve) to facilitate delivery of the liquid agent medium to the end user, optionally, associated with at least one ion-exchange membrane for the removal of unwanted electrolytes; one or more valves (e.g., a pressure release valve) to vent generated gas, in the event the reservoir is sealed; a water-level measuring sensor (e.g., an embedded capacitor); a pH-monitoring device; and the like.

FIG. 6B shows an alternative reservoir system that comprises a reservoir and one or more side-mounted ECRs (viz., 621a, 621b, 621c, . . . ). It may be appreciated that one may utilize a submersible ECR instead of a side-mounted ECR. One may appreciate that the reservoir system may comprise a fluid medium reservoir having a volume capacity of about 500 mL to about 2300 L, and all values in between. An alternative system may have a volume capacity of, for example, from about 38 L to about 3800 L (e.g., from about 10 gal to about 1000 gal) and all volume amounts in between, e.g., about 76 L (≈20 gal), about 190 L (≈50 gal), about 380 L (≈100 gal), or about 2300 L (≈600 gal). The volume capacity depends on the application. For example, the alternative system may be used to clean and/or disinfect an object, such as, an egg filler flat, a hatchling tray, a meat tray, a vegetable bin, and the like. In practice, the alternative system may comprise a suitable amount of a liquid medium comprising water, and at least one redox active reagent (e.g., a Group I metal halide), and optionally, an adjuvant selected from an acid, a surfactant, or a combination thereof. Next, an operator activates the one or more BGRs by applying a suitable amount of electricity (e.g., 30 A from about 10 min to about 180 min, including, for example, about 20 min to about 120 min) thereby generating a liquid agent medium comprised of water and a redox-produced agent. The operator then submerges the object (e.g., an egg filler flat, a hatchling tray, a meat tray, a vegetable bin, and the like) in the liquid agent medium for a suitable time to clean, sanitize, and/or disinfect said object.

Alternative configurations may be realized other than that shown in FIG. 6B. For example, the reservoir may include a plate situated approximately at the tank side midline, where said plate comprising a plurality of apertures, thereby creating an upper reservoir and a lower reservoir. In this configuration, the at least one BGR may be situated below the plane of the plate thereby being in contact with the lower reservoir. One will appreciate that a plate comprising a plurality of apertures would allow the liquid medium and/or liquid agent medium to freely transfer from the lower and upper reservoirs. Further, a plate comprising a plurality of apertures would allow any generated bubbles to escape from the lower reservoir to the upper reservoir, and the open atmosphere. However, the plate comprising a plurality of apertures may prevent or minimize the introduction of detritus, if present, into the lower reservoir.

Inspection of FIGS. 6C-6D shows alternative systems (620c and 620d) that include one or more submersible ECRs (622a and 622b) therein. Although these drawings depict only one ECR in each system, this is not meant to limit the number of submersible (or submerged) ECRs in a given system. For instance, a system may comprise two ECRs, 3 ECRs, 4 ECRs, 5 ECRs, 6 ECRs, and the like depending on the reservoir size and the cleaning/sanitizing/disinfecting need.

In system 620c, the submerged ECR 622a is situated on the bottom of the reservoir. The submerged ECR 622a may be free or may be fastened to the bottom of the reservoir.

System 620d comprises an upper and lower reservoir separated by a plate comprising a plurality of apertures. In this configuration, the submerged BGR is situated on the bottom floor of the lower reservoir. The submerged BGR may be free or may be fastened to the bottom of the lower reservoir. One will appreciate that a plate comprising a plurality of apertures would allow the liquid medium and/or liquid agent medium to transfer freely from the lower and upper reservoirs. However, the plate comprising a plurality of apertures would prevent or minimize the introduction of detritus, if present, into the lower reservoir. It is contemplated that electrodes in the submerged BGR may be electrically energized by an electrical contact or by an inductively coupled charger 625 (e.g., by resonant inductive coupling). The systems 620c and 620d may comprise a sealable hatch that permits removal of the submersible BGRs. Not shown in FIGS. 6C-D are one or more implements that may facilitate introduction of water, e.g., from a municipal water supply; one or more valves (e.g., a ball-valve or a solenoid valve) to facilitate delivery of the liquid agent medium to the end user, optionally, associated with at least one ion-exchange membrane for the removal of unwanted electrolytes; one or more valves (e.g., a pressure release valve) to vent generated gas, in the event the reservoir is sealed; a water-level measuring sensor (e.g., an embedded capacitor); a pH-monitoring device, and the like.

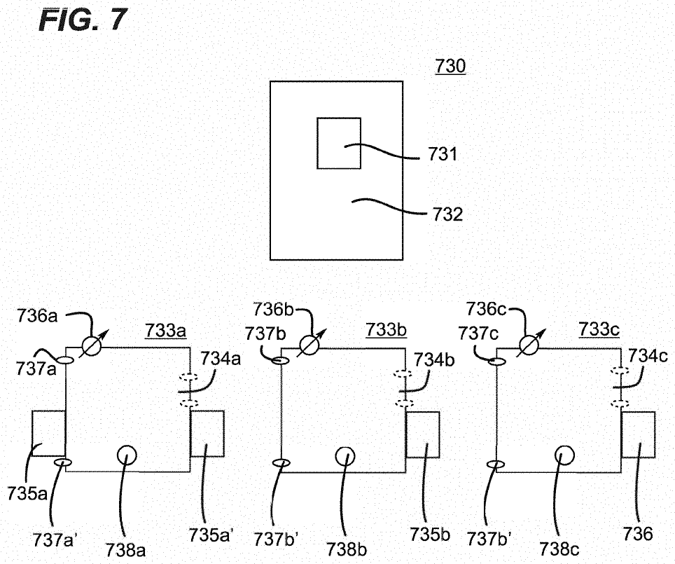

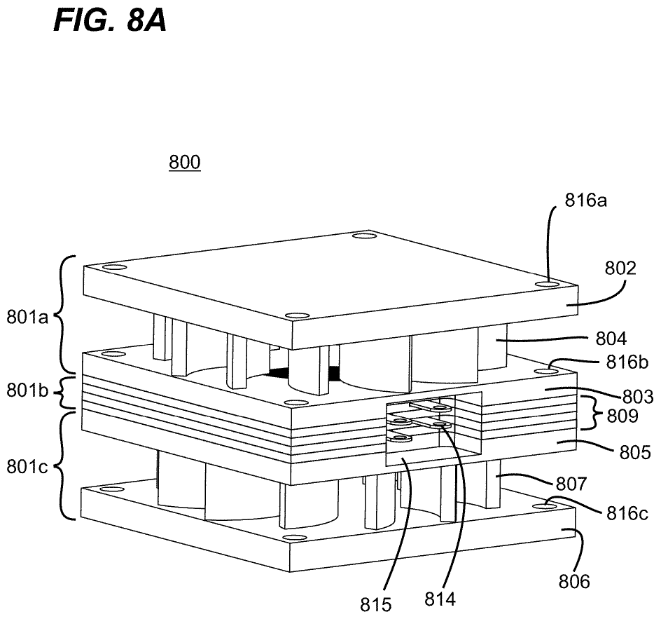

One aspect of the seventh embodiment relates generally to a system 730 comprised of any one of the reservoir systems depicted in FIG. 7 (e.g., a first reservoir system, a second reservoir system, a third reservoir system, a first and second reservoir system, a first and third reservoir system, or a first, second, and third reservoir system).

An aspect of the seventh embodiment relates to a system comprising: an operating system; and a reservoir system selected from a first reservoir system, a second reservoir system, a third reservoir system, or a combination thereof; (1) the first reservoir system comprising a first reservoir optionally comprising a first liquid medium, at least one first reservoir system ECR, a first liquid supply reservoir comprising a first liquid medium concentrate; and optionally an adjuvant liquid supply reservoir comprising an adjuvant liquid medium; (2) optionally the second reservoir system comprising a second reservoir optionally comprising a second liquid medium, at least one second reservoir system ECR, a second liquid supply reservoir comprising a second liquid medium concentrate; (3) optionally the third reservoir optionally comprising a third liquid medium, at least one third reservoir system ECR, and a third liquid supply reservoir comprising a third liquid medium concentrate; and wherein each of the ECRs is coupled to or submerged within each of the reservoirs optionally comprising the liquid medium.

It will be understood that a system of the seventh embodiment may comprise any one of the ECRs disclosed herein (e.g., a BGR, a VGR, an NER, an ISR, or a combination thereof).

Aspects of an aspect of the seventh may be appreciated by reviewing the system 730 depicted in FIG. 7. In this drawing, the system 730 comprises an operating system 732, a first reservoir 733a, a second reservoir 733b, and a third reservoir 733c. It will be understood that the system may include one reservoir, two reservoirs, or three reservoirs as described herein. It also will be understood that the placement of certain elements may depart from that which is depicted in the drawing without departing from the intended function of the system and its components.

The operating system 732 comprises a housing that is mountable to a wall, rack, or other substrate. The housing comprises human machine interface (HMI) 731, a programmable logic controller (PLC), a power supply, an AC to DC transformer, a timer/switch, a voltage/amperage meter, a conductivity meter, an oxidation-reduction potential (ORP) meter, a temperature probe, pH measurement probe and/or device, a water supply line associated with a solenoid valve (e.g., two-way or three-way solenoid valve), and a communication device.

The first reservoir system 733a comprises a first reservoir 734a, a first ECR 735a, a second ECR 735a′, optionally, a pressure-release valve 736a, an upper water level detector 737a, a lower water level detector 737a′, and a valve 738a (e.g., a manual or solenoid valve). As shown, the ECRs are side-mounted, but one may appreciate that the ECR may be submersible and that generally operation of the reservoir system would be the same.

In one aspect, the second 733b and third 733c reservoir systems may be identical (or different) to the first reservoir system with the exception that each reservoir system comprises only one ECR (viz., ECR 735b for system 733b and ECR 735c for system 733c. One may appreciate that the second 733b and third 733c reservoir systems may be identical to the first reservoir system insofar that the second 733b and third 733c reservoir systems may comprise two ECR (or BGRs).

Not shown for the system 730 depicted in FIG. 7 are electrical connectors, electrical conduits (e.g., wires), a pH measuring device, one or more liquid supply reservoirs, and, optionally, associated with a valve (e.g., 738a) at least one ion-exchange membrane for the removal of unwanted electrolytes. The one or more liquid supply reservoirs comprising a liquid medium concentrate. The liquid medium concentrates for each of the reservoir systems are not the same.

Initially, an end-user via the HMI (e.g., 731) initiates a command to introduce a liquid medium comprising water and at least one redox active reagent, in each of the reservoir systems depicted in FIG. 7. The activated PLC initiates a water filling command for each of the reservoirs, thereby introducing into the respective reservoir a suitable amount of the liquid medium concentrate. The ECR (e.g., 735a′, 735b, or 735c) may be activated for a predetermined time period, depending on the application, to produce a liquid agent medium comprised of water and a redox-produced agent. The bubbles generated during said activation time period creates turbulence that serves to mix the medium in the reservoir. Additionally, the ECR vents serve to produce a current such that liquid medium is introduced into the cavity of the ECR. It will be understood that one may optionally include an external stirring device, if desired. Produced gas may be dissolved in the liquid and may reside in the headspace above the liquid in the reservoir. A pressure release valve (e.g., 736a) opens to vent excess gas produced during the ECR-mediated process. The system may optionally be equipped with a vent hose to release said gas into the atmosphere or a separate collection unit.

One will appreciate that the liquid medium will contain initially at least one redox active reagent, which will be consumed to generate a redox-produced agent. Thus, the liquid of the reservoir will contain both at least one redox active reagent and a redox-produced agent. As the ECR continues to operate the amount of the at least one redox active reagent will decrease to a concentration such that the production of a redox-produced agent becomes minimal. The PLC may be programmable to include a preset time for ECR operation. Optionally, an adjuvant liquid medium concentrate may be introduced into the reservoir from the adjuvant liquid supply reservoir. As stated above, the adjuvant liquid medium concentrate comprises (i) water and (ii) an acid, a surfactant, or a combination thereof, as described herein.

The resultant liquid agent medium comprised of water, a redox-produced agent, and optionally an adjuvant, may be dispensed via a valve (e.g., 738a) into a suitable container, e.g., a bucket, a bottle, a spray dispenser, a storage tank, and the like.

As shown in FIG. 7, each reservoir system comprises two or more sensors (e.g., 737a (a high-level sensor), 737a′ (a low-level sensor), and one or more intermediate sensors (see dashed-line ovals). In one example, each reservoir system comprises four sensors that detect the level of the liquid medium in the reservoir. Once the liquid agent medium is dispensed, a first sensor (e.g., 737a′ (or low-level sensor)) generates a first signal that will activate a valve (not shown) that introduces water into the reservoir system, which concurrently results in the introduction of a suitable amount of liquid medium concentrate. A second sensor (e.g., 737a) generates a second signal that will deactivate a valve once the reservoir maximum fill volume has been achieved. It will be appreciated that an intermediate sensor (situated above the ECR) sends a signal indicating that no maintenance generating current may be applied to the ECR at least because application of a current to the ECR in the absence of a liquid medium may result in irreversible damage to the BGR electrodes. In practice, a generating current may be applied only when the reservoir is full.

Tests have shown that a redox-produced agent produced from a Group I metal halide results in the production of at least one of ozone, hydrogen peroxide, chlorine, hypochlorous acid, and chlorine dioxide (also referred to herein as “mixed oxidants”). Tests also have shown that any one of the mixed oxidants will react with an indicator (e.g., N—N-diethylparaphenylenediamine) that measures the solution concentration of the mixed oxidants, such as, for example a concentration of total chlorine. Tests further have shown that treatment of a liquid medium comprising water and a Group I metal halide with an ECR by applying 30 A for about 1 minute to about 6 hours (and all times in between, such as, for example, about 2 min, about 5 min, about 10 min, about 20 min, about 30 min, and the like) produces a liquid agent medium comprised of water and a mixed oxidant concentration that exceeds about 2000 ppm. However, deactivation of the ECR (e.g., turning the ECR off) shows that the half-life of the mixed oxidant(s) may be from about 30 min to about 45 min.

Initial production of the liquid agent medium may be followed by a maintenance production. For example, it may be useful to store the generated liquid agent medium (comprising mixed oxidants) for a time period. For example, in the event that an end-user does not dispense the liquid agent medium after the ECR activation period has terminated, it may be necessary for the ECR to undergo activation N-times (N=1, 2, 3, . . . ) so to maintain the level of redox-produced agent. It is contemplated that the maintenance production may be automatic. If necessary, a pre-set volume of liquid medium concentrate may be introduced into the reservoir. The repeated cycling (or pulsing) may be accomplished using a second ECR (e.g., 735a) by applying current (e.g., about 1-3 A) for about 30 to 60 seconds. Thus, the system described herein may be programmed to determine the time after initial ECR activation and whether any water dispensing has occurred. The programmed feature may be based on empirical data developed for the system.

The liquid agent mediums depend on the desired outcome for the end-user. For instance, the end-user may desire to sanitize, disinfect, clean, or a combination thereof. For sanitizing and disinfecting, the end-user may use the system comprising the first reservoir system. For cleaning, the end-user may use the system comprising the second or the third reservoir. For any one of sanitizing, disinfecting, or cleaning, the end user may use the system comprising the first reservoir, as well as the second, and/or third reservoir.

An aspect of the seventh embodiment relates generally to a system 850 comprised of the reservoir system depicted in FIGS. 8I-8J. For instance, an aspect of the seventh embodiment relates to system capable of generating a disinfecting solution, a sanitizing solution, and/or a cleaning solution, comprising: an operating system; and at least one reservoir system comprising a reservoir optionally comprising a liquid medium, at least one ECR (e.g., BGR, VGR, and/or ICR) described herein, a liquid supply reservoir comprising a liquid medium concentrate; and optionally an adjuvant liquid supply reservoir comprising an adjuvant liquid medium; wherein each of the VGRs is coupled to the reservoir, and optionally submersible in the liquid medium.

It will be understood that the system may comprise an ECR (e.g., a BGR, a VGR, an NER, and an ISR). FIG. 8I contemplates a reservoir 824 that includes a group of submersible VGRs 800 positioned within said reservoir by way of a fastening arrangement. In one aspect, the reservoir 824 may have a volume of about 5 gal. to about 90 gal. and all values in between, e.g., 10 gal., 15 gal., 20 gal., 25 gal., 30 gal., 35 gal., 40 gal., 45 gal., 50 gal., 55 gal., 60 gal, 65 gal., 70 gal, 75 gal, 80 gal., and 85 gal. In another aspect, the reservoir 824 may be an intermediate bulk container (“IBC”) of varying sizes. One may appreciate that IBCs have a variety of volumes that range, for example from about 100 gallons to about 550 gallons and all values in between, such as, for example 100 gallons, 180 gallons, 275 gallons, and 330 gallons. A common IBC outer dimension may be 48″×40″×46″, making the IBC ideal for shipping on a pallet 825 arrangement. IBCs may be housed in a metallic cage (not shown) and may be stored on the floor on a suitable table arrangement.

Aspects of the reservoir system may be appreciated by reviewing the generating system 850 depicted in FIG. 8J. In this drawing, the system 850 comprises an operating system 852 and a reservoir 824. It will be understood that the placement of certain elements may depart from that which is depicted in the drawing without departing from the intended function of the system and its components. It also will be understood that the system 850 may include one, two, or three reservoirs.

The operating system 852 comprises a housing that is mountable to a wall, rack, or other substrate. The housing comprises a human machine interface (HMI) 851, a programmable logic controller (PLC), a power supply, an AC to DC transformer, a timer/switch, a voltage/amperage meter, a conductivity meter, an oxidation-reduction potential (ORP) meter, a temperature probe, a water supply line associated with a solenoid valve (e.g., two-way or three-way solenoid valve), one or more flow sensors, one or more liquid level sensors, and a communication device capable of transmitting and receiving data via a direct-connect internet cable, a wireless (e.g., WiFi, Bluetooth, and the like).

The reservoir system 824 comprises at least one ECR system (e.g., VGR) 800, optionally a pressure-release valve 853, an upper liquid level sensor 854a, a lower liquid level sensor 854b, optionally two or more additional liquid level sensors 854′, a valve 855 (e.g., a manual or solenoid valve), a water inlet 856, and at least one liquid medium concentrate inlet 857. The reservoir system 824 may further comprise one or more sensors capable of detecting a signal selected from among optical, resistance, ultrasonic, or a combination thereof.

Not shown for the system 850 depicted in FIG. 8J are electrical connectors, electrical conduits (e.g., wires), a pH measuring device, one or more liquid supply reservoirs, and, optionally, associated with a valve (e.g., 855) at least one ion-exchange membrane for the removal of unwanted electrolytes. The at least one liquid medium concentrate inlet 857 may be fluidly connected to a liquid supply reservoir comprising a first, second, or third liquid medium concentrate, or optionally an adjuvant liquid medium concentrate.

Initially, an end-user via the HMI 851 initiates a command to introduce the liquid medium concentrate by way of inlet 857. The activated PLC initiates a water filling command for the reservoir, thereby introducing into the reservoir 824 a suitable amount of water by way of inlet 856. The at least one ECR system (e.g., VGR) 800 is activated for a predetermined time period, depending on the application, to produce a liquid agent medium comprised of water and a redox-produced agent. The vortex and bubbles generated during said activation time period creates turbulence that serves to mix the medium in the reservoir. Additionally, the VGR vents serve to produce a current such that liquid medium is introduced into the cavity of the VGR. It will be understood that one may optionally include an external stirring device, if desired. Produced gas may be dissolved in the liquid and may reside in the headspace above the liquid in the reservoir. If present, a pressure release valve (e.g., 853) opens to vent excess gas produced during the at least one electrochemical reactor (e.g., VGR) mediated process. The system may optionally be equipped with a vent hose to release said gas into the atmosphere or a separate collection unit.

One will appreciate that the liquid medium comprises at least one redox active reagent, which may be consumed to generate a redox-produced agent. Thus, the liquid of the reservoir will contain both at least one redox active reagent and at least one redox-produced agent. As the at least one electrochemical reactor (e.g., VGR) continues to operate the amount of the at least one redox active reagent will decrease to a concentration such that the production of a redox-produced agent becomes minimal. The PLC may be programmable to include a preset time for at least one electrochemical reactor (e.g., VGR) operation.

The resultant liquid agent medium comprised of water, a redox-produced agent, organic acid, and optionally a surfactant, may be dispensed via a valve (e.g., 855) into a suitable container, e.g., a bucket, a bottle, a spray dispenser, a storage tank, and the like.

Once the liquid agent medium is dispensed, a first sensor (e.g., 854b) generates a first signal that will activate a valve (not shown) that introduces water into the reservoir system, which results in the introduction of a suitable amount of liquid medium concentrate. A second sensor (e.g., 854a) generates a second signal that will deactivate a valve once the reservoir maximum fill volume has been achieved.

Again, tests have shown that a redox-produced agent produced from a Group I metal halide results in the production of at least one of ozone, hydrogen peroxide, chlorine, hypochlorous acid, and chlorine dioxide. Tests also have shown that any one of the mixed oxidants will react with an indicator (e.g., N—N-diethylparaphenylenediamine) that measures the solution concentration of the mixed oxidants, such as, for example a concentration of total chlorine. Tests further have shown that treatment of a liquid medium comprising water and a Group I metal halide with a VGR by applying from about 10 A to about 100 A (e.g., 30 A) for about 1 minute to about 6 hours (and all times in between, such as, for example, about 2 min, about 5 min, about 10 min, about 20 min, about 30 min, and the like) produces a liquid agent medium comprised of water and a mixed oxidant concentration that ranges from about 200 ppm to about 2000 ppm (or higher, e.g., about 3000 ppm). However, deactivation of the VGR (e.g., turning the VGR off) shows that the half-life of the mixed oxidant(s) may be from about 30 min to about 45 min. In one example, the mixed oxidant concentration may be from about 500 ppm to about 550 ppm, which may be suitably used for a hand sanitizer having a pH of about 5.5 to about 6.8.

Initial production of the liquid agent medium may be followed by a maintenance production. For example, it may be useful to store the generated liquid agent medium (comprising mixed oxidants) for a time period. In the event that an end-user does not dispense the liquid agent medium after the VGR activation period has terminated, it may be necessary for the VGR to undergo activation N-times (N=1, 2, 3, . . . ) so to maintain the level of redox-produced agent. It is contemplated that the maintenance production may be automatic. If necessary, a pre-set volume of liquid medium concentrate may be introduced into the reservoir. The repeated cycling (or pulsing) may be accomplished using one or more VGRs (e.g., 800) by applying current (e.g., about 1-3 A) for about 30 to 60 seconds. Thus, the system described herein may be programmed to determine the time after initial VGR activation and whether any water dispensing has occurred.

The liquid medium may be any one of the liquid media obtained from any one of liquid media concentrates, each described herein. The liquid agent media depend on the desired outcome for the end-user. For instance, the end-user may desire to sanitize, disinfect, clean, or a combination thereof. For sanitizing and disinfecting, the end-user may use a system 850 comprising the first liquid medium concentrate. For cleaning, the end-user may use a system 850 comprising the second liquid medium concentrate or the third liquid medium concentrate. For any one of sanitizing, disinfecting, or cleaning, the end user may use at least one system 850 comprising the first liquid medium concentrate, as well as the second liquid medium concentrate, and/or third reservoir liquid medium concentrate. To obtain the liquid medium, the liquid medium concentrate may be diluted by a factor of about 20 to about 50 and all values in between, as explained herein. For example, about 3.3 fl. oz. (about 97 mL) of liquid concentrate may be combined with about 115.5 fl. oz. (about 3,416 mL) to about 149 fl. oz. (4,406 mL) of water, e.g., tap water, soft water, or deionized water, to obtain the liquid medium.

Another aspect relates to a tabletop reservoir system capable of generating a disinfecting solution, a sanitizing solution, and/or a cleaning solution, comprising: a first assembly comprising a display case comprising a human machine interface (HMI) display, a fluid medium reservoir comprising at least one ECR (e.g., a BGR, a VGR, an NER, and an ISR, or a combination thereof), and a fluid dispenser. In one aspect, the tabletop reservoir further comprises a second assembly comprising one or more of a liquid medium, a liquid medium concentrate, a adjuvant liquid medium concentrate, or a combination thereof, where the second assembly may be in fluid contact (e.g., via suitable plumbing) with the first assembly. In another aspect, the tabletop reservoir further comprises an electrical source; a programmable logic controller (PLC); at least one power supply; one or more fluid conduits, at least one sensor; and an external water supply.

FIGS. 10A-10O illustrate certain aspects of the tabletop reservoir system. With reference to FIGS. 10A-10D, a tabletop reservoir system 1000 capable of generating a disinfecting solution, a sanitizing solution, and/or a cleaning solution, comprises a) a first assembly 1001 comprising a display case 1001a comprising a human machine interface (HMI) display 1001c, a fluid medium reservoir 1001b comprising at least one BGR, at least one VGR, at least one NE reactor, at least one IS reactor, or a combination thereof, a fluid dispenser 1003a, b) a second assembly 1002 comprising a second assembly cover 1002a and a second assembly reservoir 1002b, a liquid medium holding reservoir 1009, a liquid medium concentrate reservoir 1010 or a combination thereof; c) an electrical source 1004; d) a programmable logic controller (PLC) 1005; e) at least one power supply 1006; f) a fluid conduit 1007; and g) an external water supply 1008.

FIGS. 10A-10D show features of a tabletop reservoir system 1000. In practice of the tabletop reservoir system 1000, a fluid medium (e.g., a first liquid medium) may be converted to a liquid agent medium (e.g., a disinfecting solution, a sanitizing solution, and/or a cleaning solution) by contacting a liquid medium comprising water and at least one redox active reagent with an electrochemical reactor running a constant current of from about 1 A to about 100 A for a period of from about 5 min to about 360 min.

As seen from FIGS. 10A-10D, the system capable of generating a disinfecting solution, a sanitizing solution, and/or a cleaning solution, comprises a tabletop reservoir system 1000. The tabletop reservoir system 1000 comprises a first assembly 1001 and a second assembly 1002.

The first assembly 1001 comprises a display case 1001a comprising a human machine interface (HMI) display 1001c, such as, an Android® tablet, that communicates with a programmable logic controller PLC 1005. The first assembly 1001 also comprises a fluid medium reservoir 1001b comprising at least one reactor described herein, and a fluid dispenser 1003a. As shown in FIGS. 10C-10D, an ECR (e.g., an NE reactor) 900 may be positioned in a lower portion of the fluid medium reservoir 1001b. In practice, the ECR (e.g., NE reactor) 900 may be fastened to the fluid medium reservoir 1001b by an opening having substantially the same area of the sealing member 905. A fastener may include a nut-tightened all thread rod, a nut-tightened hex bolt, a nut-tightened machine screw, and the like. FIG. 10C shows a contemplated position of the ECR (e.g., NE reactor) 900 fastened to the fluid medium reservoir 1001b, where the fasteners and electrode connectors are not shown.

As shown in FIG. 10C, a programmable logic controller (PLC) 1005 and a power supply 1006 may be situated in the display case 1001a. Generally, the power supply 1006 comprises an AC to DC transformer capable of converting an electrical source 1004 (e.g., 120 V AC) to a direct current electrical source capable of delivering to each electrode of the reactor (e.g., 900) an amperage delivered that ranges from about 1 A to about 100 A (and all values in between, as explained herein).

As shown in FIGS. 10A-10D, the tabletop reservoir system 1000 comprises a second assembly 1002 comprising a second assembly cover 1002a and a second assembly reservoir 1002b. As shown in FIGS. 10C-10D, the second assembly reservoir 1002b comprises a liquid medium holding reservoir 1009 configured to retain a liquid medium or alternatively a container (see FIG. 10C′) that comprises a liquid medium. The second assembly may also comprise a liquid medium concentrate reservoir 1010. An external water supply (not shown) may be connected to the liquid medium holding reservoir 1009 and the liquid medium concentrate reservoir 1010 may be fluidly connected (e.g., tubing) to the liquid medium holding reservoir 1009. In practice, a signal from the PLC actuates a valve (not shown) to introduce a certain amount of water to the liquid medium holding reservoir 1009 and a certain amount of a liquid medium concentrate from the liquid medium concentrate reservoir 1010, where the amount of the liquid medium concentrate may be diluted by water by a factor of about 20 to about 50 and all values in between, as explained above. As shown in FIGS. 10C-10D, the liquid medium concentrate may be stored in a container (e.g., a liquid stand up bag/pouch) having a volume that ranges from about 20 fl. oz. to about 256 fl. oz. and all values in between. The volume amount of liquid medium concentrate may be variable or it may fixed (e.g., 128 fl. oz.). The system may be programmed to enter the volume amount of liquid medium concentrate for an initial state (no dispensing). The system may monitor the amount of liquid medium concentrate dispensed during each cycle (as explained herein), and an alert signal may be transmitted to the end user (or an operator) when it is time to replace the liquid medium concentrate container. In one aspect, the liquid medium concentrate container may comprise an RFID chip comprising an identification number capable of being monitored to an on-site or remote operator. The second assembly, illustrated in FIGS. 10C-10D, contemplates a liquid medium concentrate reservoir 1010 adjacent to the liquid medium holding reservoir 1009. In one aspect, the liquid medium concentrate may be stored within a second assembly cover 1002a (above the liquid medium holding reservoir 1009). In an alternative aspect, the liquid medium concentrate may be stored externally to the second assembly 1002 and fluidly connected (e.g., tubing) to the liquid medium holding reservoir 1009. In yet another aspect, the liquid medium concentrate may be stored externally (e.g., on a shelf, rack, or suitable storage unit) to the first assembly and fluidly connected (e.g., tubing) to the first medium reservoir 1001b.

The system 1000 may further comprise a timer/switch, a voltage/amperage meter, one or more valves (e.g., a solenoid valve, viz., a two-way or three-way solenoid valve), a liquid medium level sensor for a fluid medium reservoir 1001b (e.g., situated at the top of the reservoir and situated in close proximity to the NE reactor 900), a liquid medium level sensor for the second assembly reservoir (e.g., upper and lower sensors), and a communication device that may transmit system information to an end-user or an operator.

In practice, an end-user (e.g., by way of the HMI) initiates the system 1000 from the HMI display 1001c. Alternatively, an end-user may remotely initiate the system 1000 by a device- or computer-based application.

As seen from FIGS. 10E-10I, another aspect of the seventh embodiment relates to a tabletop reservoir system 1020 capable of generating a disinfecting solution, a sanitizing solution, and/or a cleaning solution, comprising: a) a first assembly 1021 comprising a display case 1021a comprising a human machine interface (HMI) display 1021c, a fluid medium reservoir 1031 comprising at least one ECR (e.g., a BGR, a VGR, an NER, an ISR, or a combination thereof), a first fluid conduit (e.g., a fluid dispenser (e.g., 1023a, which may be situated in an alternative location, e.g., 1023b), a second fluid conduit (e.g., a valve e.g., 1023a and tubing) that permits an end-user to dispense a liquid active medium from the fluid medium reservoir 1031; b) a second assembly comprising a container comprising a liquid medium concentrate, c) a programmable logic controller (PLC, e.g., 1038); d) at least one power supply (e.g., 1039); and e) one or more additional fluid conduits (e.g., 1025, 1026, 1027).

FIG. 10 show features of a tabletop reservoir system 1020 (including either a second assembly compartment 1051 (see, e.g., FIG. 10K) or a second assembly 1002 (see, e.g., FIG. 10B). In practice of the tabletop reservoir system 1020, a fluid medium (e.g., a first liquid medium) may be converted to a liquid agent medium (e.g., a disinfecting solution, a sanitizing solution, and/or a cleaning solution).

As seen from FIGS. 10E-10I, the system capable of generating a disinfecting solution, a sanitizing solution, and/or a cleaning solution, comprises a tabletop reservoir system 1020. The tabletop reservoir system 1020 comprises a first assembly 1021 and a second assembly 1050 (or 1002).

The first assembly 1020 comprises a display case 1021a comprising a human machine interface (HMI) display 1021c, such as, an Android® tablet, that communicates with a programmable logic controller (“PLC”) 1038. The display case 1021a may further comprise a collection of components 1030 that comprises one or more power supply units (e.g., 1036, 1037, 1039), a PLC 1038, one or more flow sensors (e.g., 1034, 1035).

The first assembly 1021 also comprises a fluid medium reservoir 1031 comprising at least one ECR (e.g., an ISR 910) described herein, and a fluid dispenser (e.g., 1023b, which may be alternatively positioned (e.g., 1023b)). As shown in FIGS. 10I-10J, an ECR disclosed herein (e.g., an ISR 910) may be positioned in a lower portion of the fluid medium reservoir 1031 having a volume, e.g., about 4 gal (or about 1.5×10⁷ mm³) In practice, the ECR (e.g., ISR 910) may rest on the floor of the fluid medium reservoir 1031 coupled to a protective casing 1029 that comprises an electrode connector (e.g., 914) making contact with one or more electrical leads (e.g., 914′ and 914″) attached to an electrode connector 914 and the PLC/power supply (1038/1039). One may appreciate that the protective casing 1029 may be comprised of a chemically resistant material described herein, including, e.g., Teflon, ABS, PEEK, PVC, titanium, and the like. The protective casing 1029 insulates the connection of the one or more electrical leads and the electrode connector with the medium (e.g., liquid medium or liquid agent medium).

As explained herein, the ECR has a total surface area (TSA), which may depend on the total number of electrodes. In one aspect, the ECR (e.g., ISR) may have a TSA of about 47,000 mm². One may appreciate that a fluid medium reservoir (e.g., 1031) may comprise a volume of liquid (VL, e.g., liquid medium) of about 3 gal (about 1.1×10⁷ mm³) to about 4 gal (about 1.5×10⁷ mm³). In view of the values of TSA and VL, one may estimate a VL-to-TSA ratio for a given system. For instance, an ECR (e.g., ISR 910) in a fluid medium reservoir (e.g., 1031) having a VL of about 3 gal (about 1.1×10⁷ mm³) to about 4 gal (about 1.5×10⁷ mm³), provides for a reservoir system having a VL-to-TSA ratio of about 230 mm to about 320 mm. As explained herein, the VL-to-TSA ratio may range from about 100 mm to about 3000 mm and all values in between. Accordingly, one may envision a suitable reactor system based on the VL-to-TSA ratio. For instance, placement of four ISRs (each having a TSA of about 47,000 mm²) in a fluid medium reservoir having a volume of liquid (VL) of about 100 gal (about 3.8×10⁸ mm³) provides for a reservoir system having a VL-to-TSA ratio of about 2020 mm.

As seen in FIG. 10I, the one or more electrical leads (e.g., 914′ and 914″) may be in electrical communication with at least one power supply 1039 capable of generating a constant current of about 1 A to about 100 A, and all values in between, as explained herein. One may appreciate that a controller board (or PLC) 1038 may be used to control one or more of a current output, a pulse-width modulator, switching an electrode polarity (e.g., to remove unwanted electrochemical deposits) as explained herein.

As shown in FIGS. 10E-10G, a programmable logic controller (PLC) 1038 and a power supply 1039 (among other things) may be situated in the display case 1021a. Generally, the power supply 1039 comprises an AC to DC transformer capable of converting an electrical source (e.g., 120 V AC) to a direct current electrical source capable of delivering to each electrode of the ECR (e.g., 910) an amperage delivered that ranges from about 1 A to about 100 A, and all values in between.

As shown in FIGS. 10K-10O, the tabletop reservoir system 1020 may comprise a second assembly 1050 comprising a second assembly compartment 1051 and a second assembly compartment drawer 1052 comprising at least one liquid medium concentrate holding reservoir (e.g., 1053 and/or 1054). As seen in FIG. 10O, a container 1053 comprising a liquid medium concentrate may be situated in a delivery holder 1058 that comprises a transfer port (e.g., a cannula (not shown)) whereby liquid medium concentrate may be delivered from the container 1053 to the fluid medium reservoir 1031 by away of a fluid conduit (e.g., 1058, 1056, 1027) and a pump 1057 (e.g., a peristaltic pump or an equivalent thereof). In one aspect, the liquid medium concentrate container 1053 may comprise an RFID chip comprising an identification number capable of being monitored to an on-site or remote operator. As shown in FIG. 100, the second assembly may comprise additional containers 1054 comprising a liquid medium concentrate. The second assembly may be in the form of an alternative storage unit (e.g., a shelf, rack, and the like) comprising a container comprising a liquid medium concentrate and a fluid conduit system (e.g., tubing, pump, and the like) whereby liquid medium concentrate may be delivered from the container to the fluid medium reservoir 1031.

An external water supply (not shown) may be connected to the liquid medium reservoir (e.g., 1031) and the liquid medium concentrate container (e.g., 1053) may be fluidly connected (e.g., via tubing and, optionally, a pump) to the liquid medium reservoir 1031. In practice, a signal from the PLC actuates a valve (e.g., 1032b) to introduce a certain amount of water to the liquid medium reservoir 1031. Separately, the PLC actuates transference of a liquid medium concentrate from the liquid medium concentrate container (e.g., 1053), where the amount of the liquid medium concentrate may be diluted by water by a factor of about 20 to about 50 and all values in between, as explained above.

The system 1020 may further comprise a timer/switch, a voltage/amperage meter, one or more valves (e.g., a solenoid valve, viz., a two-way or three-way solenoid valve), a liquid medium level sensor for fluid medium reservoir 1031 (e.g., situated at multiple locations within the reservoir, an inline flow sensor (e.g., 1040, e.g., an ultrasonic flow sensor), and a communication device that may transmit system information to an end-user or an operator.

In practice, an end-user initiates the system 1020 from the HMI display 1021c. Alternatively, an end-user may remotely initiate the system 1020 by a device- or computer-based application.

When the liquid agent medium held in the fluid medium reservoir (e.g., 1031) has been depleted, the PLC initiates a replenishing cycle, which may comprise (i) preventing further liquid agent medium dispensing, (ii) filling the fluid medium reservoir (e.g., 1001b or 1031) with water and a suitable volume of a liquid medium concentrate (e.g., 1009 or 1053) with a dilution factor as explained herein, (iii) applying a suitable current to the ECR (e.g., the BGR, VGR, NER, ICR, or a combination thereof) to produce the liquid agent medium in the fluid medium reservoir (e.g., 1001b or 1031) and (iv) allowing further liquid agent medium dispensing from a fluid dispenser (e.g., 1003a or 1023b) As stated above, the system may be programmed to enter the volume amount of liquid medium concentrate for an initial state (no dispensing). The system may monitor the amount of liquid medium concentrate dispensed during each cycle (as explained herein, e.g., using the known container volume, flow rate, and dispensing time), and an alert signal may be transmitted to the end user (or an operator) when it is time to replace the liquid medium concentrate container.

An aspect of the seventh embodiment relates to a factory-in-a-box (“FIAB,” e.g., 1200) capable of generating a liquid active medium (e.g., a mixed oxidant solution) in a desired location (e.g., a remote location).

As seen from FIGS. 12A-12B, the mixed oxidant solutions system 1200 comprises a box container 1261 (e.g., a conex container having exterior dimensions of about 8′ (width), 8′6″ (or 9′6″) (height), and about 20′ to about 40′ (length)). In one aspect the box container 1261 is climate controlled.

The FIAB 1200 further comprises a reactor tank 1233, an activator tank 1235 (e.g., for containing a suitable volume of liquid active medium concentrate), a water system 1236 optionally comprising one or more of a reverse osmosis filtration system 1236A, a deionized (“DI”) water system 1236B, and a DI water tank 1236C, a filling station 1237, a controller system 1231 with an associated human-machine interface 1232, and an optional storage system 1238. The FIAB 1200 may comprise one or more reactor tanks 1233. For instance, FIG. 12A shows three reactor tanks, while FIG. 12B shows four or more reactor tanks. The number of tanks may depend on the requirements for the mixed oxidant solutions production.

It may be appreciated that the reactor tank 1233 may be any suitable reservoir system described herein (e.g., 620a, 620b, 620c, 620d, 730, 850 1000, 1020, and the like). It also may be appreciated that the reactor tank 1233 may comprise any one of the ECRs described herein (e.g., BGR, VGR, NER, ISR, and the like).

With reference to FIG. 12B, one may appreciate that the system 1200 may be connected to a city water source 1270, said city water being purified by a reverse osmosis (“RO”) filtration system 1236A. The RO water may be deionized using a deionized (“DI”) water system 1236B, wherein said DI water may be held in a DI water tank 1236C. A DI water transfer pump 1250a may be employed to transfer DI water to the reactor tank 1233.

The system 1200 may comprise suitable plumbing, plumbing fixtures, and suitable valves (e.g., a check valve 1239, a powered valve (e.g., 1240, 1241a, 1241b, 1241c, and 1241d (e.g., a powered solenoid valve), a sensor 1242 (e.g., a flow sensor), as well as a suitable power supply 1260 (e.g., of about 460 VAC (30 A)). Using the ECRs and principles described herein, the FIAB may produce a suitable amount of liquid agent medium that ranges from about 50 L to about 100 L per day.

E. Practical Uses of a Liquid Agent Medium

As explained herein, a process disclosed herein provides for a liquid agent medium having a pH of from about 5.5 to about 6.8 comprising an oxidant concentration of (i) about 800 to about 880 ppm, (ii) about 670 ppm to about 750 ppm, (iii) about 670 to about 750 ppm, (iv) about 300 to about 350 ppm, (v) about 500 to about 550 ppm, (vi) about 670 to about 750 ppm, (vii) about 1200 to about 1400 ppm, and (viii) about 2200 to about 2400 ppm, wherein the liquid medium comprises a Group 1 metal halide, optionally an organic acid, and optionally a surfactant. Said liquid agent medium may be useful in a method for killing a pathogen and/or reducing fomite spread on an object, which comprises applying an effective amount of said liquid agent medium to the object.

In view of the foregoing, an eighth embodiment relates to a method for sanitizing or disinfecting an object, which comprises: applying an effective amount of the liquid agent medium comprising water and a redox-produced agent to the object, wherein said liquid agent medium is prepared by contacting a liquid medium comprising water and at least one redox active reagent and any one the ECRs (e.g., BGR, VGR, NER, ISR) described herein having a current of from 1 A to about 100 A (and all values in between, as explained herein) for a period of, for example, from about 5 min to about 360 min and all values in between (e.g., about 30 min, about 40 min, about 50 min, . . . about 220 min, about 230 min, about 240 min,...about 340 min, about 350 min).

In one aspect, the liquid agent medium may be prepared using any one of the processes described herein.

In another aspect, the redox-produced agent comprises at least one of ozone, hydrogen peroxide, chlorine, hypochlorous acid, and chlorine dioxide. In yet another aspect, the redox-produced agent comprises chlorine, hypochlorous acid, or a combination thereof.

Test results show that treatment of an object with a liquid agent medium, as described herein, results in killing of Clostridium difficile (“C. difficile”), as well as other pathogens.

For example, a prepared culture of C. difficile (ATCC: 43958) was brought to 5% soil load via addition of Fetal Bovine Serum. A stainless steel (SS) sheet (prewashed, sanitized, rinsed, and dried) was divided into approximately 10 cm×10 cm squares.

A liquid medium comprising tap water and sodium chloride was contacted with an ECR to obtain a liquid agent medium, as described herein. An adjuvant (≈20 mL acetic acid) was added to liquid agent medium, which when titrated for chlorine showed a chlorine content of about 2400 ppm. The liquid agent medium (or disinfectant) was introduced into a container comprised of towelette wipes, thereby providing sanitizer wipes. See, e.g., US 2019/0231151 A1 and US 2019/0343345 A1 for examples of wipe dispensers.

A liquid medium comprising tap water and potassium carbonate was contacted with a BGR to obtain a liquid agent, as described herein. The liquid agent medium (or cleaner) was introduced into a container comprised of towelette wipes, thereby providing cleaning wipes.

Ten SS squares were inoculated with 200 μL of the bacterial suspension, spread roughly in a circle with an approximate diameter of about 6 cm and allowed to dry for about 60 min. At the conclusion of the 60 min drying period, the cleaning procedure began. Starting at the bottom, left-hand corner of a test square, the area was cleaned with the assigned cleaner wipe in an up-down-up-down motion, angled so that the motion concluded with the cleaner wipe resting at the bottom right hand corner of the square. From there, without switching the wipe, the motion was repeated in a left-right-left-right motion, angled so that the motion concluded with the cleaner wipe resting at the upper right-hand corner of the square. The wipe was then disposed.

For the squares receiving two treatments, the cleaner wipe was applied first, and the sanitizer wipe applied second. Two squares remained untreated to serve as positive controls.

Following conclusion of the treatment step, one square of each set (Exposure Time) was allowed to rest for about 2 min, and the other for about 5 min, prior to their surfaces being sampled with an EnviroSwab, which was immediately placed in a sampling tube containing 5mL Neutralizing Broth, and homogenized. Following clearance of eight wiping squares, the two remaining squares received 8 sprays of sanitizer at a distance of about 12″ from a sprayer containing set to a fine mist setting, allowed to rest for about 2 min and about 5 min prior to identical neutralization and treatment. Positive controls were diluted 1/1000 in phosphate buffered water (PBW). All samples were plated in duplicates of 0.1 and 1.0mL on 5% Blood TSA, sealed in anaerobic chambers with EZ GasPak pouches, and incubated for 9 days.

The following table summarizes the results related to the Wipe System Reduction Efficacy of C. difficile (ATCC: 43958) on Stainless Steel Surface.

| | | | | | Recovery | |
|---|---|---|---|---|---|---|
| | | | | | from treated | Average |
| Treatment | ET | Device(s) | BCS | | surface | Percent |
| System | (min) | Used | Identifier(s) | Control | (CFU/square) | Reduction |
| Cleaner | 2 | BGR and | 1805262 | 7.3 × 10⁴ | 44545.5 | 39.0% |
| Wipes | 5 | textured | | | 9772.7 | 86.6% |
| Only | | wipes | | | | |
| Sanitizer | 2 | BGR and | NA | | 10900 | 85.1% |
| Wipes | 5 | Compatible | | | 2625 | 96.4% |
| Only | | Wipes | | | | |
| Cleaner | 2 | Same as | 1805262 | | 90.9 | 99.9% |
| Wipes | 5 | above | | | <0.23 | >99.9997% |
| Followed | | | | | | |
| By | | | | | | |
| Sanitizer | | | | | | |
| Wipes | | | | | | |
| Spray | 2 | BGR and | NA | | <0.23 | >99.9997% |
| | 5 | spray device | | | <0.23 | >99.9997% |

ET: Exposure Time
Control: Average recovery from untreated surface (Average of two square analysis; CFU/square)

The data plainly shows that spraying the liquid agent medium to the stainless steel surface after treatment of C. difficile (ATCC: 43958) (for 2 min or 5 min) showed an average percent reduction of C. difficile to be >99.9997%. The same efficacy was observed for the use of cleaning wipes followed by sanitizer wipes after a treatment time of 5 min. This should be contrasted to using cleaner wipes only where the maximum average percent of C. difficile to be about 86.6%.

Similar testing was performed on viral pathogens (e.g., Bacteriophage Norovirus, Canine Parvovirus, Enterovirus Type 69, Feline Calicivirus, Hepatitis B, Hepatitis C, HIV, Human Herpesvirus 1 (HSV), Influenza A (H1N1), Murine Norovirus (MNV-1), Poliovirus, and Duck Hepatitis B) and non-viral pathogens (e.g., C. Diff, E. coli 0157:H7, Legionella, Listeria Monocytogenes, Mycobacterium Terrea, Pseudomonas Aeruginosa, Salmonella Enterica, Staphylococcus Aureus (MRSA), and T Interdigital (Athlete's Foot)). The following table identifies the tested pathogen, the mixed oxidant concentration (in ppm), the observed log-kill and kill times (in seconds).

| | | Log | Kill Time |
|---|---|---|---|
| Pathogen | ppm | Kill | (secs) |
| Bacteriophage Norovirus | 350 | 5.4 | 30 |
| Canine Parvovirus | 950-1100 | 3.5 | 60 |
| Enterovirus Type 69 | 530 | 4.4 | 180 |
| Feline Calicivirus | 950-1100 | 5 | 60 |
| Hepatitis B | 1100-1200 | 5 | 60 |
| Hepatitis C | 1264 | 5.6 | 30 |
| HIV | 1268 | 5.6 | 30 |
| Human Herpesvirus 1 | 1268 | 5.1 | 30 |
| (HSV) | | | |
| Influenza A (H1N1) | 950-1100 | 5 | 60 |
| Murine Norovirus (MNV-1) | 1100-1200 | 5 | 30 |
| Poliovirus | 1268 | 5.6 | 30 |
| Duck Hepatitis B | 591 | 5 | 30 |
| C. Diff | 2904 | 6 | 60 |
| E. coli 0157:H7 | 199 | 5.82 | 30 |
| Legionella | 600 | 3 | 30 |
| Listeria Monocytogenes | 199 | 6.31 | 30 |
| Mycobacterium Terrea | 412 | 5.8 | 30 |
| Pseudomonas Aeruginosa | 350 | 5.5 | 30 |
| Salmonella Enterica | 99 | 6.15 | 30 |
| Staphylococcus Aureus | 897 | 6.51 | 30 |
| (MRSA) | | | |
| T. Interdigital | 950-1100 | 4 | 60 |
| (Athlete's Foot) | | | |

The data plainly shows that the liquid agent medium manufactured by an ECR disclosed herein (e.g., BGR, VGR, NE, and IS reactors) are capable of rapidly killing a variety of known pathogens.

As seen from the data presented herein, one may appreciate that an effective amount of the liquid agent medium depends on a number of factors, including, for example, the object (e.g., stainless steel, fabric, countertop, and the like), the liquid agent medium, the application (e.g., sanitizing or disinfecting), and the anticipated pathogen to be killed. The amount of liquid agent medium may range from about 0.1 oz to about 10 oz. (or more). The liquid agent medium (obtained from a liquid medium comprising a Group 1 metal halide, optionally an organic acid, and optionally a surfactant) by a process disclosed herein having a pH of from about 5.5 to about 6.8 may comprise an oxidant concentration of (i) about 800 to about 880 ppm, (ii) about 670 ppm to about 750 ppm, (iii) about 670 to about 750 ppm, (iv) about 300 to about 350 ppm, (v) about 500 to about 550 ppm, (vi) about 670 to about 750 ppm, (vii) about 1200 to about 1400 ppm, and (viii) about 2200 to about 2400 ppm. Using the information disclosed herein, one may determine an effective amount of the liquid agent medium to be used in the methods described herein.

An aspect of the eighth embodiment relates to sanitizing or disinfecting an object, the object is generally a restaurant setting (e.g., a kitchen, a food service counter, a cashier counter, a food dispensing area, a condiment dispensing area, a table, a chair, a floor, a trash disposal area, and the like). In another aspect of the sanitizing method, the object is generally a hotel setting (e.g., a room, an elevator, a floor, a reception area, and the like).

Another aspect of the eighth embodiment relates to disinfecting an object, the object is generally a clinical setting (e.g., an operating table, an examination room, a hospital recovery room, an intensive care unit, an emergency medical services vehicle, a surgical instrument, and the like). In another aspect of the disinfectant method, the object is an educational setting (e.g., a cafeteria, a classroom, an office, an educational clinic, and the like).

A sanitizing/disinfecting solution may be prepared as described herein that comprises a suitable amount of mixed oxidant(s) that is capable of killing a pathogenic organism (e.g., C. difficile, E. coli, S. aureus, S. epidermidis, P. aeruginosa, E. Faecalis, E. Faecium, P. Mirabilis, C. albicans, K. pneumoniae, B. anthracis, C. botulinum, F. tularenis, Y. pestis, Salmonella, Listeria, cryptosporidium, influenza, rubella, cytomegalovirus, and other potential pathogenic organisms) on contact.

A recent report by van Doremalen concerning severe acute respiratory syndrome coronavirus 1 and 2 (viz., SARS-CoV-2 and SARS-CoV-2) shows that virus remain viable on certain surfaces for an extended period of time. For instance, based on results reported therein Van Doremalen concludes that the estimated median half-life of SARS-CoV-2 was approximately 5.6 hours on stainless steel and 6.8 hours on plastic. Rutala and/or Hakim report(s) that the microbicidal/virucidal activity of chlorine is attributed largely to undissociated hypochlorous acid. Hawkins also reports that exposure of proteins to hypochlorous acid results in a wide range of oxidative modifications and the formation of chlorinated products, which alter protein structure and enzyme activity, and impact the function of biological systems. The Park study showed that a nebulized medium comprising 20 to 200 ppm hypochlorous acid resulted in >99.9% (>3 log10) reductions of both infectivity and RNA titers of tested viruses within 10 min of exposure time for both porous (e.g., ceramic tile) and non-porous (e.g., stainless steel) substrates. Accordingly, one may appreciate that the liquid active media (e.g., sanitizing and disinfecting solutions) described herein may be effective for reducing the infectivity of a substrate with respect to SARS-CoV-2. Reducing the infectivity of a substrate with respect to SARS-CoV-2 may result in a reduction of fomite spread of a virus (e.g., SARS-CoV-2).

In this regard, testing was conducted on samples of coronavirus O C43 (also known as beta coronavirus), which is one of four yearly circulating coronaviruses responsible for the common cold. See, e.g., Deming.

Briefly, a coronavirus OC43 (“OC43”) suspension was placed in a medical nebulizer centrally located in a sealed room having approximate dimensions of 7′×24′×8′. The room comprised three SKC BioSampler® (air sampler) units with associated vacuum pumps. Each air sampler had a reservoir that contained a sterile bosphate buffered sailing adjusted to 0.05% sodium thiosulfate. The temperature of the room was maintained at 20±1° C. The OC43 suspension (containing 5% heat inactivated Fetal Bovine Serum).

To establish and measure baseline (pretreatment) concentration of the aerosolized OC43 concentration, the room was sealed and the nebulizer was turned on. Air samples at each respective location were taken at 10 minutes (at sample location 1 for 3 minutes), 20 minutes (at sample location 2 for 3 minutes), and 30 minutes (at sample location 3 for 3 minutes). Nebulization was stopped and the room atmosphere was rapidly evacuated through a UV sterilizer. The sample collection reservoirs from each of the air samplers were recovered and replaced with new sample collection reservoirs. The nebulizer was refilled with the OC43 suspension.

A fresh batch of mixed oxidants solution prepared as described herein was added to a table-top ultrasonic humidifier operating at a maximum rate. The ultrasonic humidifier was placed in the center of the room and a circulating fan (having an airflow of about 310 CFM) was allowed to homogenize room air. The room was humidified for about 1 hour, wherein aerosolized OC43 was introduced to the room air, as described above. Samples were collected as described above.

Recovered samples were analyzed for viable infectious OC43 on the day of the study at undiluted and at ten-fold dilutions in replicates of five. Positive and negative controls were performed along with test subjects to provide quality control and reference data as per laboratory standard accredited ISO17025:2017 methodology. Viable virus was analyzed using HRT-18G cell infectivity assay. Cell monolayers were monitored for cytopathic effect development over a 14-day period. Virus were enumerated as Infectious Units (I.U.) using the Most Probably Number (MPN) analysis of the cell culture results. Analysis was conducted as per method EPA/600/R-95/178 and reported as I.U./Carrier section. The entire study was repeated using 8 hour contact time. The following table summarizes the results of the study for locations numbers 1-3, the sample time (post-virus aerosolization (PVA)), the sample, OC43 count, and percent reduction observed using a mixed oxidant solution prepared as described herein.

| Location | | | | |
|---|---|---|---|---|
| No. | Sample Time | Sample | OC43 Count | % Reduction: |
| 1 | 10 min PVA | Control | 7.9 × 10³ | 95.8 |
| | | | I.U./3 min | |
| | | Treated | 3.3 × 10² | |
| | | | I.U./3 min | |
| 2 | 20 min PVA | Control | 1.7 × 10⁴ | 97.1 |
| | | | I.U./3 min | |
| | | Treated | 4.9 × 102 | |
| | | | I.U./3 Min | |
| 3 | 30-min PVA | Control | 9.2 × 104 | 94.1 |
| | | | I.U./3 min | |
| | | Treated | 5.4 × 103 | |
| | | | I.U./3 Min | |

The data plainly shows a substantial reduction of Coronavirus OC43 when contacted with a mixed oxidant solution (e.g., having a mixed oxidant concentration range of about 2200 ppm to about 2400 ppm) prepared as described herein.

Another aspect of the eighth embodiment relates to a method of reducing fomite spread of a pathogen on an object, which comprises: applying a liquid agent medium comprising water and a redox-produced agent to the object, wherein said liquid agent medium is prepared by contacting a liquid medium comprising water and at least one redox active reagent and any one the reactors (e.g., BGRs, VGR, NE, IS reactors) described herein having a current of from 1 A to about 100 A (and all values in between) for a period of from about 20 min to about 360 min and all values in between (e.g., about 30 min, about 40 min, about 50 min, . . . about 220 min, about 230 min, about 240 min, . . . about 340 min, about 350 min). Aspects of the eighth embodiment are hereby incorporated by reference with respect to the method of reducing fomite spread.

A sanitizing solution may be prepared as described herein that comprises a suitable amount of a mixed oxidant solution that may be capable of sanitizing an object. A sanitizing solution generally contains a mixed oxidant(s) amount of about 200 ppm or less, but not including a mixed oxidant amount of zero. Thus, it is contemplated that a sanitizing solution generated by using a reactor (e.g., BGR, VGR, NE reactor, IS reactor, etc.) described herein produces an amount of mixed oxidant(s) sufficient to kill a pathogen (e.g., viral pathogen, bacterial pathogen, etc.) on contact with the sanitizing solution.

The applying may occur actively or passively. For instance, an end-user may apply actively a mixed oxidant solution to a substrate by way of a wipe or towel. Alternatively, an end-user may apply passively a mixed oxidant solution to a substrate by way of a nebulizing system, such as a self-generating vaporizer, as shown in FIG. 13.

With reference to FIG. 13, a self-generating vaporizer, 1300, comprises a vaporizing tank 1301 that comprises an ultrasonic transducer 1302. The self-generating vaporizer, 1300, further comprises a reservoir system 1303 and a reactor 1304. A mixed oxidant solution manufactured in the reservoir system 1303 may be transferred to the vaporizing tank 1305 by a transfer pump 1305 and suitable plumbing. Power requirements for both the ultrasonic transducer 1302 and the reactor 1301 may be supplied by an electronic pack 1306.

It may be appreciated that the reservoir system 1303 may be any suitable reservoir system described herein (e.g., 620a, 620b, 620c, 620d, 730, 850 1000, 1020, and the like). It also may be appreciated that the reactor 1304 may be any suitable ECR system described herein (e.g., BGR, VGR, NER, ISR, and the like).

A disinfecting solution generally comprises an amount of mixed oxidant(s) greater than about 200 ppm, greater than about 300 ppm, greater than about 400 ppm, greater than about 500 ppm, greater than about 600 ppm, greater than about 700 ppm, greater than about 800 ppm, greater than about 900 ppm, greater than about 1000 ppm, greater than about 1200 ppm, greater than about 1300 ppm, greater than about 1400 ppm, greater than about 1500 ppm, greater than about 1600 ppm, greater than about 1700 ppm, greater than about 1800 ppm, greater than about 1900 ppm, greater than about 2000 ppm, greater than about 2100 ppm, greater than about 2200 ppm, greater than about 2300 ppm, greater than about 2400 ppm, greater than about 2500 ppm, greater than about 2600 ppm, greater than about 2700 ppm, greater than about 2800 ppm, greater than about 2900 ppm, and greater than about 3000 ppm. Ultimately, the mixed oxidant level in the disinfectant solution will depend on the targeted pathogenic organism. For instance, C. difficile may be killed using a mixed oxidant level of about 2200 to about 2500 ppm. Thus, it is contemplated that a disinfecting solution generated by an ECR described herein produces an amount of mixed oxidant sufficient to kill C. difficile (e.g., about 2200-2400 or about 2300-2500 ppm) on contact with the disinfecting solution.

In view of the foregoing, one may appreciate certain aspects of the ECRs disclosed herein.

Clause 1. A process for preparing a liquid agent medium, which comprises: contacting a liquid medium in a liquid medium reservoir comprising water and at least one redox active reagent with an electrochemical reactor running a first constant current of from about 1 A to about 100 A for a period of from about 5 min to about 360 min to obtain the liquid agent medium comprising water and the least one redox-produced agent comprising at least one oxidant having a concentration that ranges from about 200 ppm to about 3600 ppm; wherein the liquid medium has a pH of about 3.6 to about 6.8.

Clause 2. The process of clause 1, wherein the liquid medium comprises water and (i) a Group 1 metal halide, (ii) a Group 1 metal halide and an organic acid, (iii) a Group 1 metal halide, an organic acid, and a surfactant, (iv) a Group 1 metal carbonate, at least one clarifying agent, optionally a surfactant, and optionally a dye, or (v) a Group 2 metal carbonate, at least one clarifying agent, optionally a surfactant, and optionally a dye.

Clause 3. The process of any one of clauses 1-2, wherein the current ranges from about 1 A to about 60 A for the period of about 5 min to about 180 min.

Clause 4. The process of any one of clauses 1-4, further comprising determining a concentration of at least one oxidant, adding to the reservoir a liquid medium concentrate and optionally an adjuvant liquid medium concentrate, and applying a second constant current of from about 1 A to about 100 A for a period of from about 5 min to about 360 min.

Clause 5. The process of any one of clauses 1-4, further comprising determining a concentration of at least one oxidant, adding to the reservoir a liquid medium and optionally an adjuvant liquid medium concentrate, and applying a second constant current of from about 1 A to about 60 A for a period of from about 5 min to about 10 min.

Clause 6. The process of any one of clauses 1-5, wherein the liquid medium reservoir has a volume capacity of about 500 mL to about 3800 L.

Clause 7. The process of any one of clauses 1-6, wherein the pH of the liquid agent medium ranges from about 5.5 to about 6.8.

Clause 8. The process of any one of clauses 1-7, wherein the electrochemical reactor, comprises: an array of at least two electrodes capable of being partially or fully immersed in a liquid medium having a controlled current applied to the at least two electrodes; wherein the array of at least two electrodes comprises an arrangement where a liquid medium flow velocity is generated and maintained through the array by electrochemically formed bubbles in the array of the at least two electrodes; wherein the electrochemical reactor has (i) an adjacent inter-electrode distance that ranges from about 0.5 mm to about 5 mm, (ii) a total surface area for each electrode ranges from about 2,000 mm² to about 350,000 mm², and (iii) a flow path distance that ranges from about 1 mm to about 40 mm; and wherein the liquid medium flow velocity ranges from about 0.5 mm/sec to about 80 mm/sec.

Clause 9. The process of clause 8, wherein the electrochemical reactor comprises two to five electrodes optionally having a plurality of regularly or irregularly separated apertures.

Clause 10. The process of any one of clauses 8-9, wherein the adjacent inter-electrode distance ranges from about 0.5 mm to about 2 mm.

Clause 11. The process of any one of clauses 8-11, wherein each electrode comprises an electrode connector having a length of about 10% to about 50% the length of the electrode.

Clause 12. A liquid agent medium obtained by the process any one of clauses 1-11 having a pH of from about 5.5 to about 6.8 comprising an oxidant concentration of (i) about 800 to about 880 ppm, (ii) about 670 ppm to about 750 ppm, (iii) about 670 to about 750 ppm, (iv) about 300 to about 350 ppm, (v) about 500 to about 550 ppm, (vi) about 670 to about 750 ppm, (vii) about 1200 to about 1400 ppm, and (viii) about 2200 to about 2400 ppm, wherein the liquid medium comprises a Group 1 metal halide, optionally an organic acid, and optionally a surfactant.

Clause 13. A method for killing a pathogen and/or reducing fomite spread on an object, which comprises applying an effective amount of the liquid agent medium of clause 12 to the object.

Clause 14. An electrochemical reactor, comprising: an array of at least two electrodes capable of being partially or fully immersed in a liquid medium having a controlled current applied to the at least two electrodes; wherein the array of at least two electrodes comprises an arrangement where a liquid medium flow velocity may be generated and maintained through the array by electrochemically formed bubbles in the array of the at least two electrodes; wherein the electrochemical reactor comprises: (i) an adjacent inter-electrode distance that ranges from about 0.5 mm to about 5 mm, (ii) a total surface area for each electrode ranges from about 2,000 mm² to about 350,000 mm², and (iii) a flow path distance that ranges from about 1 mm to about 40 mm; and wherein the liquid medium flow velocity ranges from about 0.5 mm/sec to about 80 mm/sec.

Clause 15. The electrochemical reactor of clause 14, wherein the electrochemical reactor comprises two to ten electrodes optionally having a plurality of regularly or irregularly separated apertures.

Clause 16. The electrochemical reactor of any one of clauses 14-15, wherein the electrochemical reactor comprises 2 to 5 electrodes optionally having a plurality of regularly or irregularly separated apertures.

Clause 17. The electrochemical reactor of any one of clauses 14-16, wherein the adjacent inter-electrode distance ranges from about 0.5 mm to about 2 mm.

Clause 18. The electrochemical reactor of any one of clauses 14-17, wherein each electrode comprises an electrode connector having a length of about 10% to about 50% the length of the electrode.

Clause 19. A reservoir system comprising a fluid medium reservoir comprising at least one electrochemical reactor of any one of clauses 14-18, at least one water source, at least one source for a liquid medium concentrate, optionally at least one source for an adjuvant liquid medium concentrate, a human machine interface display, a programmable logic controller, optionally at least one communication device, at least one fluid conduit, at least one power supply, an electrical source, at least one sensor, and at least one valve.

Clause 20. The reservoir system of clause 19, wherein the FMR has a volume capacity of about 500 mL to about 3800 L and wherein a ratio of a volume of liquid in the FMR to a total surface area for the electrodes ranges from about 100 mm to about 3000 mm. Advantages of the ECRs

Advantages of the ECRs disclosed herein should be evident by the information presented. For instance, the ECRs utilize a constant current, as opposed to a constant voltage, which may avoid a system failure, e.g., an electrical short. The constant current system provides for continuous (and relatively maintenance free) production of a liquid active medium (e.g., a hypochlorous acid enriched medium).

Yet another advantage of the ECRs disclosed herein is the ability to produce a liquid active medium without the use of an externally operated pump system that delivers liquid medium to the ECR. Stated another way, the ECRs remain submerged in a liquid medium which provides for the continued production of liquid active medium (an increased dwell time), which also provides for higher oxidant (e.g., hypochlorous acid) levels unobtainable with previous systems. This should be contrasted to previous systems in which an oxidant-containing solution is generated after a single pass through a reactor system, as a single pass, and thus, a limited dwell time.

A further advantage of the ECRs disclosed herein relates to the ability to generate a self-regulated flow, thereby forming a partially or fully homogeneous liquid medium by virtue of the generated bubbles and the fluid velocity generated therefrom. This aspect may be realized in view of a fluid medium reservoir having a VL-to-TSA ratio of from about 100 mm to about 3000 mm.

### Cited Information

Cho et al., Improved outcomes after low-concentration hypochlorous acid nasal irrigation in pediatric chronic sinusitis, Laryngoscope (2016) 126(4): 791-795 (“Cho”).

Dean, J. A. Lange's Handbook of Chemistry, 14th ed., J. A. Dean; McGraw-Hill, Inc.: New York, 1992 (see Section 8.2) (“Lange's Handbook”),

Deming et al., COVID-19 and Lessons to be learned from Prior Coronavirus Outbreaks, AnnalsATS (2020) 17(7): 790-794 (“Deming”).

Douglas et al. Concepts and Models of Inorganic Chemistry, 2^{nd} ed. Wiley, N.Y., 1983 (“Douglas”).

Hakim et al., Aerosol Disinfection Capacity of Slightly Acidic Hypochlorous Acid Water Towards Newcastle Disease Virus in the Air: An In Vivo Experiment, Avian Diseases (2015) 59(4): 486-491 (“Hakim”).

Hawkins, C. L., Hypochlorous acid-mediated modification of proteins and its consequences, Essays Biochem. (2020) 64 (1): 75-86 (“Hawkins”).

Howes, L., Rise in quats observed during coronavirus crisis, Chem. Eng. News (2020) 98(35): 7 (“Howes”).

Hrubec et al., Quaternary ammonium disinfectants cause subfertility in mice by targeting both male and female reproductive processes, Reprod. Toxicol. (2016) 59: 159-166 (“Hrubec”).

Lim, X. Z., Do we know enough about the safety of quat disinfectants, Chem. Eng. News (2020) 98(30): 28-33 (“Lim”).

Park et al., Evaluation of Liquid-and Fog-Based Application of Sterilox Hypochlorous Acid Solution for Surface Inactivation of Human Norovirus, Appl. Environ. Microbiol. (2007) 73(14): 4463-4468 (“Park”).

van Doremalen et al., Aerosol and Surface Stability of SARS-CoV-2 as Compared with SARS-CoV-1, N. Engl. J. Med. (2020), 382(16): 1564-1567 (“van Doremalen”).

Rutala et al., Guideline for Disinfection and Sterilization in Healthcare Facilities, 2008 (Update: May 2019), last accessed at www.cdc.gov/infectioncontrol/guidelines/disinfection/on May 25, 2020 (“Rutala”).

Zheng et al., Increased Indoor Exposure to Commonly used Disinfectants during the COVID-19 Pandemic, Environ. Sci. Technol. Lett. (published online on Aug. 20, 2020 at pubs.acs.org/doi/10.1021/acs.estlett.0c00587 (“Zheng”).

All documents disclosed herein are hereby incorporated by reference in their entirety. Specifically, the subject matter disclosed in U.S. Provisional Patent Application No. 62/908,003, filed on Sep. 30, 2019, is hereby incorporated by reference. The definitions and/or meanings of subject matter described herein controls in the event that incorporated subject matter conflicts with subject matter described herein.

1. A process for preparing a liquid agent medium, which comprises:
contacting a liquid medium in a liquid medium reservoir comprising water and at least one redox active reagent with an electrochemical reactor running a first constant current of from about 1 A to about 100 A for a period of from about 5 min to about 360 min to obtain the liquid agent medium comprising water and the least one redox-produced agent comprising at least one oxidant having a concentration that ranges from about 200 ppm to about 3600 ppm;
wherein the liquid medium has a pH of about 3.6 to about 6.8.

2. The process of claim 1, wherein the liquid medium comprises water and (i) a Group 1 metal halide, (ii) a Group 1 metal halide and an organic acid, (iii) a Group 1 metal halide, an organic acid, and a surfactant, (iv) a Group 1 metal carbonate, at least one clarifying agent, optionally a surfactant, and optionally a dye, or (v) a Group 2 metal carbonate, at least one clarifying agent, optionally a surfactant, and optionally a dye.

3. The process of claim 1, wherein the current ranges from about 1 A to about 60 A for the period of about 5 min to about 180 min.

4. The process of claim 1, further comprising determining a concentration of at least one oxidant, adding to the reservoir a liquid medium concentrate and optionally an adjuvant liquid medium concentrate, and applying a second constant current of from about 1 A to about 100 A for a period of from about 5 min to about 360 min.

5. The process of claim 1, further comprising determining a concentration of at least one oxidant, adding to the reservoir a liquid medium and optionally an adjuvant liquid medium concentrate, and applying a second constant current of from about 1 A to about 60 A for a period of from about 5 min to about 10 min.

6. The process of claim 1, wherein the liquid medium reservoir has a volume capacity of about 500 mL to about 3800 L.

7. The process of claim 1, wherein the pH of the liquid agent medium ranges from about 5.5 to about 6.8.

8. The process of claim 1, wherein the electrochemical reactor, comprises:
an array of at least two electrodes capable of being partially or fully immersed in a liquid medium having a controlled current applied to the at least two electrodes;
wherein the array of at least two electrodes comprises an arrangement where a liquid medium flow velocity is generated and maintained through the array by electrochemically formed bubbles in the array of the at least two electrodes;
wherein the reactor system comprises:
(i) an adjacent inter-electrode distance that ranges from about 0.5 mm to about 5 mm,
(ii) a total surface area for each electrode ranges from about 2,000 mm² to about 350,000 mm², and
(iii) a flow path distance that ranges from about 1 mm to about 40 mm;
and wherein the liquid medium flow velocity ranges from about 0.5 mm/sec to about 80 mm/sec.

9. The process of claim 8, wherein the electrochemical reactor comprises two to five electrodes optionally having a plurality of regularly or irregularly separated apertures.

10. The process of claim 8, wherein the adjacent inter-electrode distance ranges from about 0.5 mm to about 2 mm.

11. The process of claim 8, wherein each electrode comprises an electrode connector having a length of about 10% to about 50% the length of the electrode.

12. A liquid agent medium obtained by the process of claim 1 having a pH of from about 5.5 to about 6.8 comprising an oxidant concentration of (i) about 800 to about 880 ppm, (ii) about 670 ppm to about 750 ppm, (iii) about 670 to about 750 ppm, (iv) about 300 to about 350 ppm, (v) about 500 to about 550 ppm, (vi) about 670 to about 750 ppm, (vii) about 1200 to about 1400 ppm, and (viii) about 2200 to about 2400 ppm, wherein the liquid medium comprises a Group 1 metal halide, optionally an organic acid, and optionally a surfactant.

13. A method for killing a pathogen and/or reducing fomite spread on an object, which comprises applying an effective amount of the liquid agent medium of claim 10 to the object.

14. An electrochemical reactor, comprising:
an array of at least two electrodes capable of being partially or fully immersed in a liquid medium having a controlled current applied to the at least two electrodes;
wherein the array of at least two electrodes comprises an arrangement where a liquid medium flow velocity may be generated and maintained through the array by electrochemically formed bubbles in the array of the at least two electrodes;
wherein the electrochemical reactor has:
(iv) an adjacent inter-electrode distance that ranges from about 0.5 mm to about 5 mm,
(v) a total surface area for each electrode ranges from about 2,000 mm² to about 350,000 mm², and
(vi) a flow path distance that ranges from about 1 mm to about 40 mm;
and wherein the liquid medium flow velocity ranges from about 0.5 mm/sec to about 80 mm/sec.

15. The electrochemical reactor of claim 14, wherein the electrochemical reactor comprises two to ten electrodes optionally having a plurality of regularly or irregularly separated apertures.

16. The electrochemical reactor of claim 14, wherein the electrochemical reactor comprises two to 5 electrodes optionally having a plurality of regularly or irregularly separated apertures.

17. The electrochemical reactor of claim 14, wherein the adjacent inter-electrode distance ranges from about 0.5 mm to about 2 mm.

18. The electrochemical reactor of claim 14, wherein each electrode comprises an electrode connector having a length of about 10% to about 50% the length of the electrode.

19. A reservoir system comprising
a fluid medium reservoir (FMR) comprising at least one electrochemical reactor of claim 14, optionally a fluid level sensor, and optionally the liquid medium, a liquid agent medium, or a combination thereof;
a fluid dispenser (FD) fluidly connected to the FMR, said FD comprising a dispenser, a FD fluid conduit, a FD valve, and optionally an FD flow sensor;
said reservoir system further comprising
a water source;
an electrical source;
a controlled current supply;
at least one sensor;
at least one valve;
a human machine interface display;
a programmable logic controller comprising a processor, a power supply, and an input-output controller;
optionally at least one communication device;
optionally, a drain;
optionally a liquid medium reservoir (LMR) fluidly connected to the FMR, said LMR comprising an LMR fluid conduit, an LMR pump, and optionally an LMR flow sensor and an LMR valve;
optionally at least one liquid medium concentrate (LMC) reservoir system comprising an LMC reservoir, an LMC fluid conduit, an LMC pump, and optionally an LMC flow sensor and an LMC valve, wherein the LMC reservoir is fluidly connected to the FMR or to the LMR; and
optionally an adjuvant liquid medium concentrate (ALMC) reservoir comprising an ALMC reservoir, an ALMC fluid conduit, and an ALMC pump, wherein the ALMC reservoir is fluidly connected to the FMR or to the LM.

20. The reservoir system of claim 19, wherein the FMR has a volume capacity of about 500 mL to about 3800 L and wherein a ratio of a volume of liquid in the FMR to a total surface area for the electrodes ranges from about 100 mm to about 3000 mm.
